(19) United States
(12) Patent Application Publication
(10) Pub. No.: US 2003/0007464 A1
(43) Pub. Date: Jan. 9, 2003

(54) Method and device for effecting venue specific wireless communication

(76) Inventor: Ram Jethanand Balani, Amawalk, NY (US)

Correspondence Address: BRUCE E. LILLING, LILLING & LILLING P.C., P.O. BOX 560, GOLDEN BRIDGE, NY, 10526, US

(21) Appl. No.: 10/179,056

(22) Filed: Jun. 25, 2002

Related U.S. Application Data
(60) Provisional application No. 60/300,793, filed on Jun. 25, 2001.

(51) Int. Cl. G06F 17/60; H04B 7/00; G06F 15/16

(52) U.S. Cl. 370/310; 705/26; 709/203

(57) ABSTRACT

A method and system for wireless communication in a virtual community, whereby users can obtain access to venue specific information, applications and services on a host server on their wireless, portable communication devices. The system is unique in that users at a venue, after indicating the venue location from a drop-down list or deduced some other way, will automatically be served only that venue location's and nearby surrounding content information coupled with other location specific services including a wireless and portable location-based Messenger, Chat, Match etc. Users can access the entire suite of these services from PDAs (Personal Digital Assistant), laptop or Internet enabled phones. The unique aspect of the invention is the capability for users to participate in a location specific virtual community with either known friends and associates or strangers at the venue for social or business purposes. The invention takes into account the plurality of venues and subsequent hosting of physical wireless local area network (WLAN) enabled sites with Internet backbone connectivity also known as “hotspots”, is capable of storing the server software locally at the venue location or hosted remotely via the Internet and provides enhanced user to system and user to user wireless interaction with its multi-modal data input and reception technologies.

### FIELD OF THE INVENTION

The invention relates to the communications industry and, in particular, to a method and device for effecting wireless communication between a wireless, portable communication device at a specific venue and an Internet based server for accessing venue or location specific information, applications and services.

### BACKGROUND OF THE INVENTION

Wireless communication is not new. Cellular phones and laptops with wireless modems, among many other available devices, currently permit many types of wireless communication, such as phone calls, web surfing, sending and receiving E-mail, etc. Further, many establishments, such as airports, athletic arenas, and convention centers, have stationary information kiosks that can provide a user with information that is stored in a local or host server to which the kiosk is hard wired.

Advances in computers and telecommunication technologies are changing the manner in which we all live, work and play. Cellular phones and PDAs, among other devices, have become must-have electronic tools that we demand for day-to-day business and social interactions. The convergence of these advanced end-user devices with wireless access to the Internet as the ultimate computer network with its vast storehouse of information will accelerate lifestyle and work trends even more.

Wireless local area networks (WLAN) have become affordable and easy to install. Wireless networks are being deployed at corporate enterprises, public places, such as hotels, airports, city tourist attraction areas, trade shows, etc., by using 802.11B wireless Ethernet protocol or variants thereof. Progress is also being made in the realm of telephone wide area networks (WAN) and Personal Area Networks (PAN).

Location based technologies and services are another realm of technology expanding rapidly. Information and services required by business or consumer travelers often revolve around their particular location at any point of time and they increasingly demand easy to use, anytime, anywhere access to rich multi-media enabled WEB-like information in addition to being personalized to their preferences.

There have been attempts at addressing these requirements with mixed results. WAP (Wireless Application Protocol) enabled phones failed to provide useful service due to the difficulties of navigating and lack of device screen space. PDAs have alleviated some of the problems with more advanced microprocessors and multimedia handling, but for the most part access to the existing Internet has been problematic due to lack of communication bandwidth and the fact that the majority of WEB pages were built for optimized viewing on desktop and laptop screens.

A problem with the Internet is that there is too much information, so that users often have to spend time to filter what is relevant to their needs at any particular time and place. Although WLANs at homes, places of business or public places known also as ‘HotSpots’ have alleviated communication bandwidth problems, they have not done much for the information glut.

One area of communication that has not been developed is venue or location-specific wireless communication. By this is meant not just standard two wire wireless phone conversation and sending and receiving E-mail, but a system to allow a mobile user to interact with other mobile users at the venue and also to be able to access an archive of information about the venue, in addition to the standard existing services.

### SUMMARY OF THE INVENTION

Therefore, it is an object of the invention to provide a wireless communication for use at a specific venue, which allows not only standard telecommunications functions, but also intercommunication with other users at the venue and accessing of venue-specific information from an internet based server.

The instant invention addresses these problems with its unique deployment of Internet hosted, location specific wireless networks and end-user devices. Most location-based technologies often focus on either finding a location or how to get there. This invention is highly concentrated on what to do when you get there.

Apart from serving location filtered content or information regarding the venue, this invention recognizes that an easy to use, point and click multimedia enabled user interface is mandatory. Accessing emails and surfing the WEB were seen as only part of the value addition that could be delivered to users at any specific single venue.

Humans are inherently shy, yet have an insatiable appetite to connect with others that might share the same experience and have similar or complementary business or social needs as they do. For instance, in a trade show, it is easy to meet exhibitors and transact business with them, but it is difficult for one to meet attendees at the show floors with some common joint interest as you or who might want to buy your products or services. The instant invention, however, provides an intelligent way to network at a specific local venue.

Thus, an object of the present invention is to provide an easy to use, point & click, one-stop system that delivers filtered information, communication, entertainment and transaction services—all specific to a public or private location or venue using commercially available portable wireless devices, such as PDAs, Phones, and laptops.

There are 4 aspects to the system design of the invention:

Invention [symbol] Internet [symbol] Wireless Lan at the Venue [symbol] User Device

The client-server system and application software resides at a remote server accessed by any customer user at any enabled venue via a wireless LAN connected to the Internet. In addition, the majority of the location-specific content also resides at the same server and is pulled via the Internet into the wireless LAN and ultimately any users' PDA or laptop device. Internet enabled phones will access the same identical server utilizing not a WLAN at the venue, but, instead, a telecommunications company's 2 G wide area network such as CDMA or GSM or 2.5 G networks, such as CDMA 1×RTT, AT&T's GPRS, etc. This invention supports any TCP/IP based network and works identically whether accessed from a WLAN (PDA) or WAN (Cellular phone).

The wireless client server design solves a number of technology issues and optimizes scalability of the venues that ultimately become enabled with the invention This invention will operate as a WASP—Wireless Application Service Provider. Inherent in the definition of a WASP is that the system and application software need not be installed at the local venue although this certainly is an option if mandatory to a specific location or venue.

In most venues that are interested, wireless LANs are likely to be present at the local premises. The vendor that signs up is therefore smartly leveraging their wireless network investment with remotely hosted applications and services obtainable with the instant invention. End user hardware devices at the venue may be rented to the public, but ultimately end users will access the venue services wireless via their own laptops, PDAs or Internet enabled phones.

A potential re-seller or partner visits the web site of the server to evaluate the software services that is offered at their wireless enabled venue. A temporary venue site directory is established that segregates each venue's content, chat rooms, online an offline user directories, etc. The contents of any specific venue may be as simple as their current Web Site or a custom built site optimized for small wireless device form factor access.

At the end of the trial period, a permanent vendor profile is created if there is desire to continue. Venue partners and WLAN operators will opt for lump sum payment or for fee subscription plus revenue share with the instant invention by the day, week, month or year. In other words, the invention service may be rented for one day, at say a recruiting fair in a university campus, or indefinitely at a tourist attraction area, such as South Street Seaport/Pier 17 in Lower Manhattan, New York City.

Since most wireless portable devices are limited with memory and lack disk storage, it would be impractical to store software code and applications, not to mention content and information, on the PDA or phones. This model would severely limit the capabilities and functionality of the invention. Instead, all software programs and system utilities are stored on the remote server and the end user device “talks” to the remote server.

The invention is a system and method for wireless client-server access to location-based (venue) information, communication, entertainment and transactions. The system is unique in that users at a venue, after indicating the venue location from a drop-down list or deduced some other way, will automatically be served only that venue location's and nearby surrounding content information, coupled with other location specific services, including a wireless and portable location-based Messenger, Chat, Match etc. Users can access the entire suite of these services from PDAs (Personal Digital Assistant), laptop or Internet enabled phones. An unique aspect of the invention is the capability for users to participate in a location specific virtual community with either known friends and associates or strangers at the venue for social or business purposes. The invention takes into account the plurality of venues and subsequent hosting of physical wireless local area network (WLAN) enabled sites with Internet backbone connectivity also known as “hotspots.” It is capable of storing the server software locally at the venue location or hosted remotely via the Internet and provides enhanced user to system and user-to-user wireless interaction with its multi-modal data input and reception technologies.

The present invention relates to a system for delivering content and applications either hosted locally or remotely via a wireless local area network connected to the Internet that are location specific to any one user in real time using their PDA (Personal Digital Assistants) or laptops or cellular Internet enabled phones. A virtual location specific community is created, whereby users can exchange information, communicate, entertain or conduct shopping transactions at the local venue through the wireless system established.

### BRIEF DESCRIPTION OF THE DRAWINGS

FIG. 1a is a block diagram showing the hierarchy of the invention.

FIG. 1b is a diagram illustrating the users and servers of the invention.

FIG. 1c is block diagram showing the messaging protocol of the invention.

FIG. 1d is a block diagram showing a sample wireless LAN enabled Public Hotspot/Venue-Site wherein the user using portable communication device can access the information, application and services of the invention.

FIG. 2a is a diagram showing some of the information, applications and services of the invention that can be accessed by a user at a specific venue.

FIG. 2b is a flow chart showing the Sign-Up/Rental of a portable communication device process to access the invention.

FIG. 2c is a flow chart showing the Login process of the invention.

FIGS. 3a-3k are diagrams showing some of the content of the information, applications and services of the invention that can be accessed by a user.

FIGS. 4a-4g are flow charts showing the methodology applied by the user to create and/or edit a user profile.

FIGS. 5a-5c are flow charts showing the methodology of two users at a venue communicating with each other.

FIGS. 6a-6b are flow charts showing the methodology of sending messages to users.

FIG. 7 is a flow chart showing the methodology of a user obtaining venue-specific information.

FIGS. 8a-8b are flow charts showing the methodology of a user navigating in the venue.

FIGS. 9a-9c are flow charts showing the methodology of a user searching to identify other users.

FIGS. 10a-10d are flow charts showing the methodology of sending and receiving E-mail.

FIGS. 11a-11c are flow charts showing the methodology of a calendar that is venue specific.

FIG. 12 is a flow chart showing the methodology of a user accessing venue commerce.

FIG. 13 is a block diagram showing some of the venue-specific auction features.

FIG. 14 is a flow chart showing the methodology of a user sending and receiving announcements.

FIG. 15 is a flow chart showing the methodology of the user accessing the currency converter.

FIG. 16 is a flow chart showing the methodology of the user accessing the world clock.

FIG. 17 is a block diagram showing the functionality of a user being able to change/view the personal information and other module settings.

FIG. 18 is a block diagram showing how a user can access venue-specific live streaming video.

FIG. 19 is a flow chart showing the methodology of a user accessing portable communication device settings.

FIG. 20 is a block diagram showing the overview of the venue-specific feedback.

FIGS. 21a-21b area block diagram and a flow chart showing the methodology of creating/modifying Venue-Site information and personalizing settings for other modules.

FIG. 22 is a block diagram showing the System Server methodology.

FIG. 23 is a block diagram showing the methodology of a user downloading the invention into a portable communication device.

FIGS. 24a-24v are the screens of the invention.

### DETAILED DESCRIPTION OF THE INVENTION

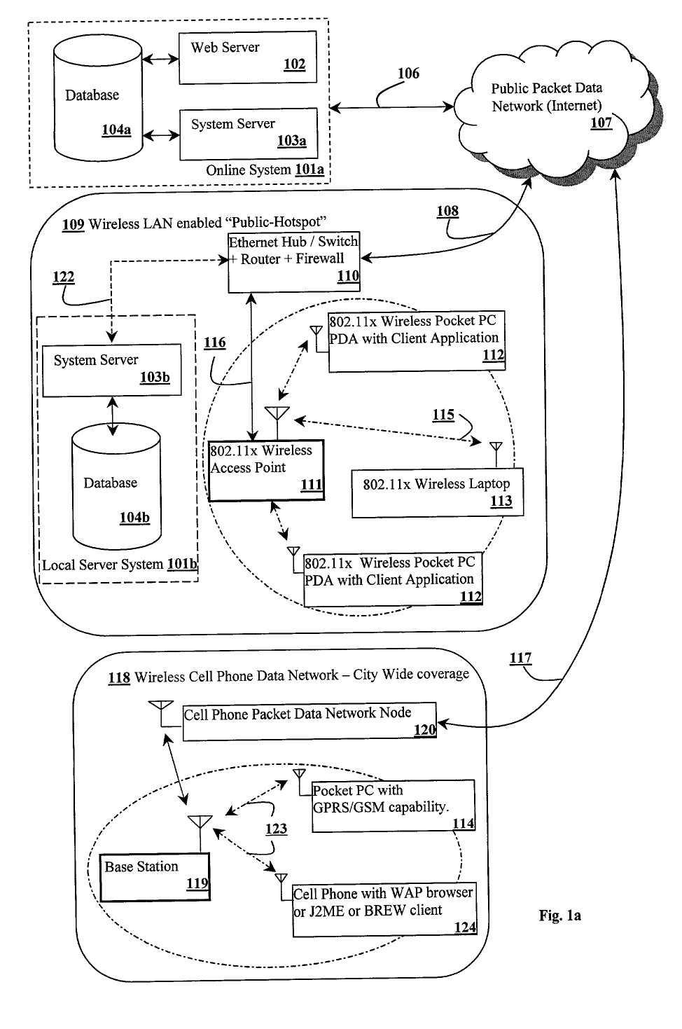

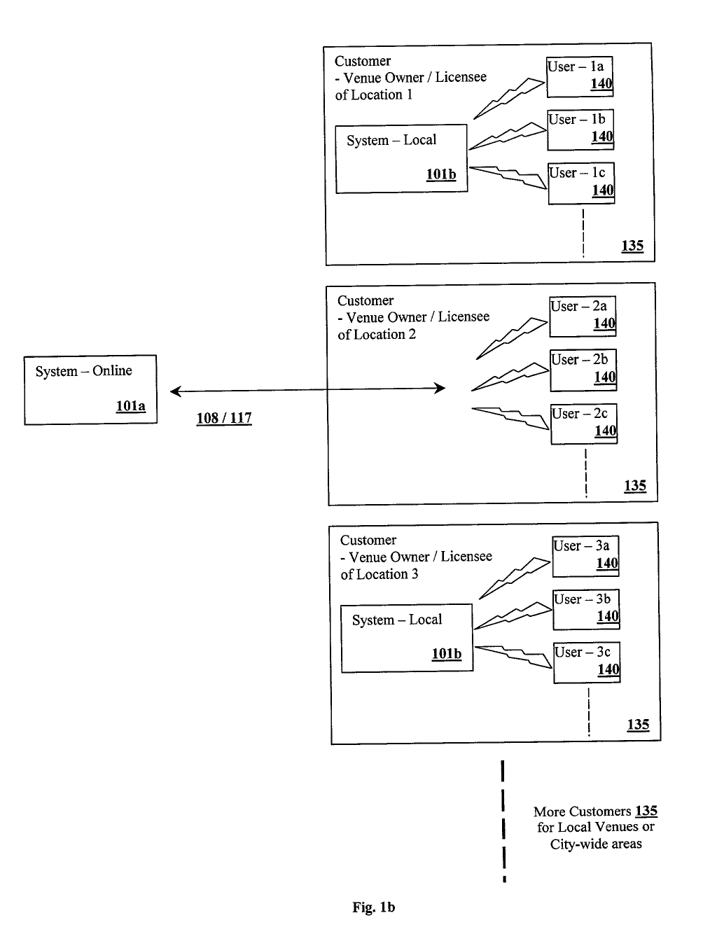

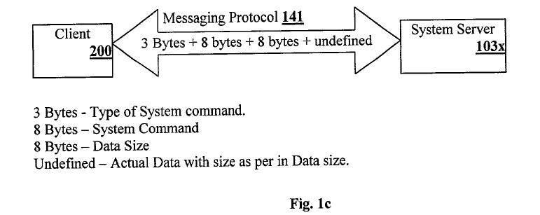

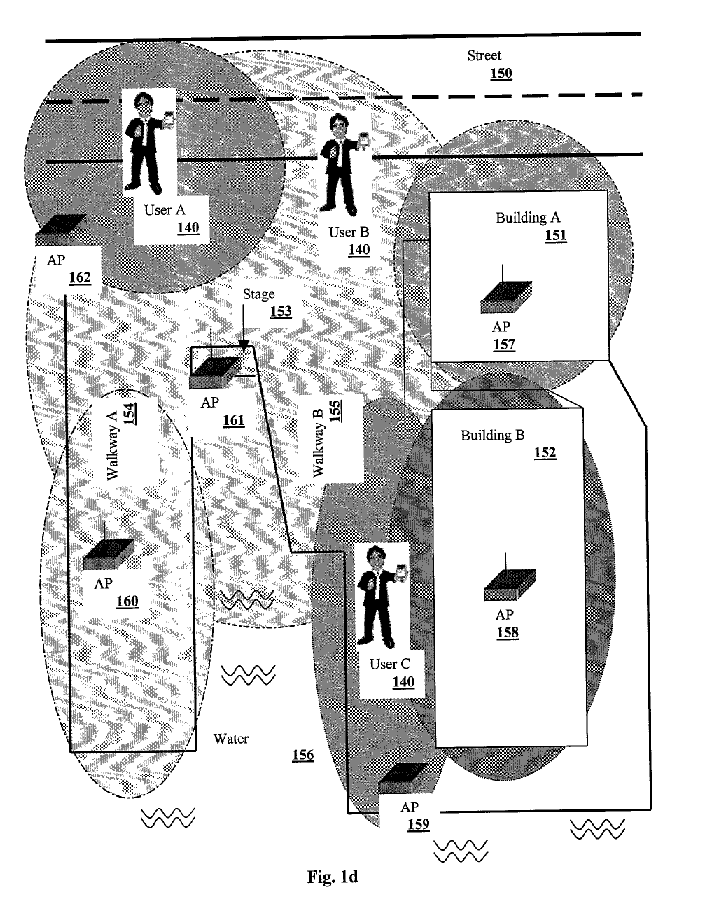

Referring to the drawings, FIG. 1a illustrates one embodiment of the present invention. The venue, which can be a convention or meeting center, public or government center, or other place of interest for tourists, travelers, attendees, guests, etc., can be a Wireless LAN enabled Site 109 or a data capable cellular telephone network 118. The venue 109 may also be a private or semi-private site such as a corporate or university campus, enterprise office, a residential complex, private for-members clubs, etc. The venue 109 is best defined as a place where there is people or activity traffic and the need for location specific information or communication and other location based services exist. Client 200 is defined as that part of the invention, which resides on the end user wireless portable communication device, which was previously downloaded from the server system. The client software needs to be downloaded only one time per device except when new versions replace the current implementation with more or better features. Client, in this invention, therefore refers to the requesting node of a “client-server” system as classically defined in the information technology industry. It is this piece of software that renders the device (PDA, laptop or phone) with the intelligence to wirelessly inter-act with the remote or local server via a communication network which can either be a WLAN with Internet connectivity or through a telephone network such as CDMA 1×RTT or GPRS. In the instant invention descriptions, Client 200 may be referred to synonymously as one of the following: a User with their own PDA, a Customer that rents a device from a venue “hotspot” operator, User 140, Client package, or Client.

In all cases the User 140, i.e. the user using the client application 200, is connected to the Internet links 108, 117. The User 140 has a choice of wireless, portable communication devices to use, i.e. a Wireless-LAN enabled Pocket PC 112 or a Wireless-LAN enabled Laptop 113 or Pocket PC with GPRS/GSM capability 114 or a WAP, J2ME or BREW enabled Phone or Hand-Held 124, as the end-device. The user software is available for download from the server and needs to be installed on the wireless, portable communication device, which the user intends to use. The user is served device-specific, venue-site specific information, applications and services.

The wireless LAN 115 enabled public hotspot (the venue) 109 can have a local system 121 (with a local System Server 103b and a local database 104b) or the venue owner can choose to be part of the online server which is an Application Service Provider (ASP), wherein, along with many other venues already existing in the system, the venue can also be listed.

When the venue is part of the online server system, the user can choose that venue from a list of venues to view. The user automatically gets access to location specific information, applications and services in a single-click. The System Server 103 and the Client application use TCP/IP socket based technology.

Wireless Internet links 108, 117 are high-speed Internet links like DSL, Lease Line, ADSL, ATM, Frame Relay, or VSAT depending upon the bandwidth requirement. Even when a particular venue has a local system, there may still be Internet connectivity if the user wants the capability to send and receive E-mail and to have the advantage of information, applications and services on the online system 101.

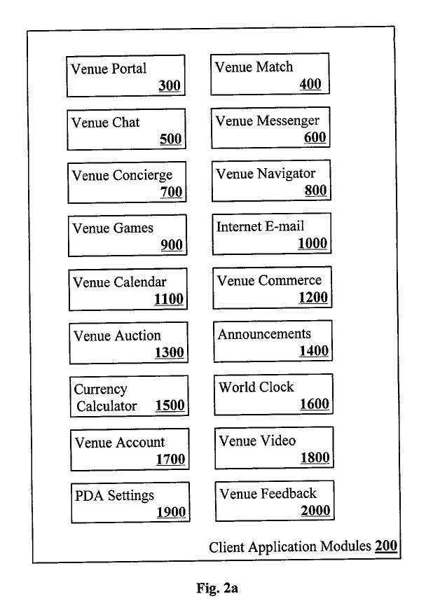

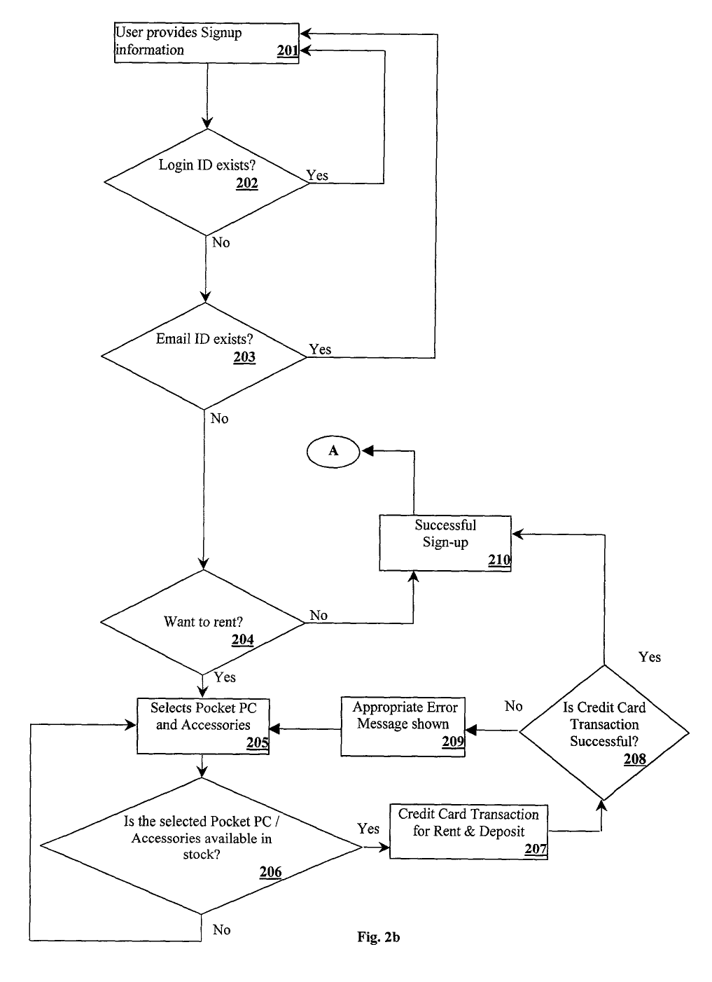

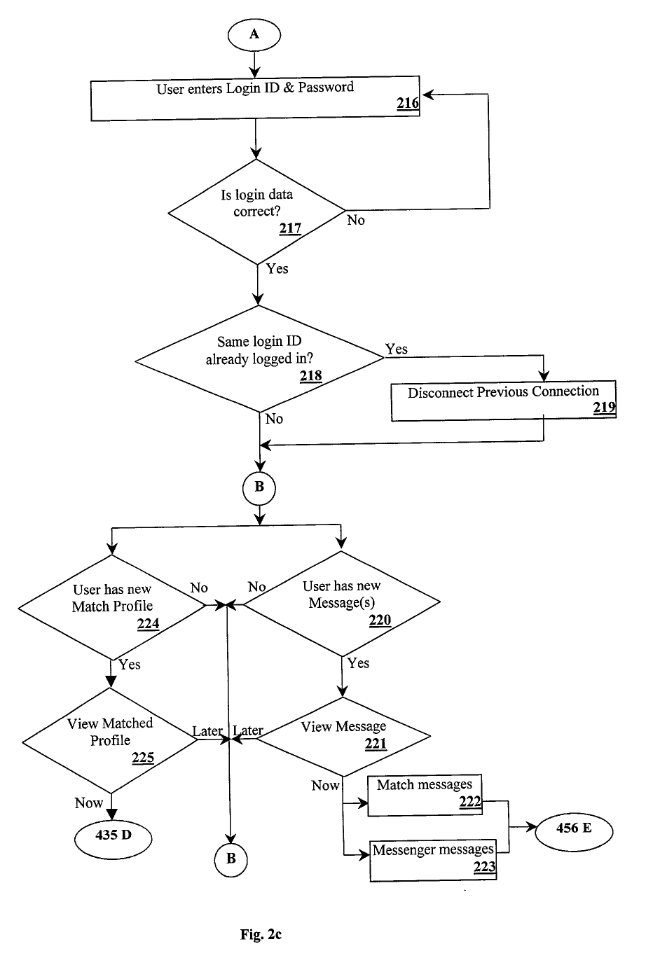

The venue-specific information, applications and services are available as Client application modules 200 on the wireless, portable communication device. (see FIG. 2.)

At the venue 109 or wireless LAN enabled “Public” hotspot, the wireless access points 111 have a wired connection 116 with the central hub or switch 110, which in turn may be connected to a Router which may be having a Firewall. The Switch/Router 110 is connected with a high-speed connection 108 to the Internet 107 or to the local server 101b through wired connection 122.

If there is city-wide venue 118, a network service provider 120 needs to provide the city-wide coverage 123 of the wireless technologies like 2.5 G/3 G, so that users can use the network's Base Stations 119 to communicate with the online system 101 using GPRS, GSM, WAP, J2ME or BREW enabled hand-held devices.

FIG. 1b illustrates the different entities within the system and different schematics of the system architecture. The System can either be Online 101a or Local 101b. Either way the System 101, as already described in FIG. 1a, consists of System Server 103, Database 104 and a Web Server 102. Customer 135 is the owner of the venue or is an authorized entity that has licensed the use of the system for a particular venue. User 140 is a person having one or more of the wireless, portable communication devices, like a Wireless-LAN enabled Pocket PC 112 or a Wireless-LAN enabled Laptop 113 or Pocket PC with GPRS/GSM capability 114 or a WAP, J2ME or BREW enabled Phone or Hand-Held 124, and has installed the Client application 200 onto the communication device and has also Signed-up for the use of the system. The Sign-up process can be Global, i.e. the User 140 can use his/her device at any of the System Hotspots, or it is Localized, i.e. the System use is only applicable for that particular venue in consideration.

There can be different scenarios possible, as shown in FIG. 1b, where a Customer 135 has licensed only for a Local System 101b or only for the Online System 101a, which is the ASP model, or having license for both, i.e. Online System 101a and Local System 101b, as the User's 140 can be roaming, i.e. moving from one System enabled Hotspots 109 or City Wide network 118 to another and hence requires the Local and Online system to be synchronized and replicated. The reason of having Local System 101b is in cases where there is lack of Internet bandwidth or there is no continuous link 108, 177 to the Internet 107.

FIG. 1c demonstrates the messaging protocol between the Client and System Server 103x (103x represents both the Online Server 103a and Local Server 103b). Messaging Protocol 141 consisting of three parts i.e. message header, message size and message data. The first part of Messaging Protocol 141 is a message header that is 11 bytes long. In turn the header consists of two parts, the first part is 3 bytes long, which specify the type of command and the remaining 8 bytes is the command itself. The second part of the Messaging Protocol 141 is the message size and is 8 bytes long, which specify the size of the message data to be transferred. The third part of Messaging Protocol 141 is the message data, which is the actual data to be transferred and its length depends upon the size of data.

FIG. 1d illustrates an example of a wireless LAN enabled Venue-Site, wherein a portable communication device can communicate with the System Server using one or more different communication arrangements.

An enabled venue-site Wireless LAN is shown in FIG. 1d, as well as the coverage area of a data capable wireless mobile network. Currently major cellular companies provide data capable wireless mobile network using CDMA Technologies. The illustrated example shows a wireless LAN enabled Venue-Site, wherein a portable communication device can communicate with the System Server using one or more different communication arrangements. For the purposes of understanding and appreciating the present invention, wireless LAN base stations 157-162, such as Access Point and/or Wireless Bridges (manufactured by Cisco, Lucent/Orinoco or any other manufacturer) or any similar device, are placed at the Venue-Site. As contemplated by the present invention, portable communication device could be a laptop, PDA, such as Compaq iPAQ Pocket PC, or any such similar device.

User 140 using Client 200 on a portable communication device communicates with System Server 103a/Web Server 102 (shown in FIG. 1a) by the signal generated from the wireless LAN base station 162 via the internet shown generally at 107. User 140 is outdoors on a walkway 154, and signals to and from the Client 200 on his portable communication device are transmitted and received via wireless link to a wireless LAN base station 161, which in turn is connected to the Internet. The user 140 may be moving towards the door and in turn go indoors to a building 151 where the communication between Client 200 on his portable communication device will transition to another wireless LAN base station 157 without logging out User 140 out of the application package 200. Other users 140A, C could be moving through out the venue site including walkway 154, 155, near stage 153 or in building 152 and still can communicate with each other using the invention.

Referring now to FIG. 2, system applications and features areshown. As said, this invention allows a user wireless, portable access to information, applications and services on an Internet based host. All of the information, applications and services are venue specific. The particular information, applications and services are almost unlimited and literally can be anything that can be stored in the Internet based server. It consists of many sub-modules, which provide venue specific information, communication, entertainment and transaction services. This client application can be downloaded on to the portable communication device from the Online System 101 using either a wireless link from the wireless LAN base station connected to the Internet or CDMA/GPRS/GSM base station, an infrared terminal or synchronizing it using the cradle. The application on getting downloaded on to the device installs itself automatically requiring minimal user interaction.

System applications and features available include a venue portal 300, venue match 400, venue chat 500, venue messenger 660, venue concierge 700, venue navigator 800, venue games 900, Internet E-mail 1000, venue calendar 1100, venue commerce 1200, venue auction 1300, Announcements 1400, currency calculator 1500, world clock 1600, venue account 1700, venue video 1800, PDA settings 1900 and venue feedback 2000—all of which will be hereinafter described. Of course, many other types of information, applications and services can be offered instead of or in addition to the ones shown.

The venue portal 300 can provide venue specific information, such as maps, amenities, shop locations, restaurants, event and entertainment information, etc. Venue match 400 is a profile based matching service to allow a user to identify other users at the same venue according to a user defined criteria. Venue chat 400 would allow interactive communication between two users at the same venue. The venue messenger 600 is a wireless messaging service. Just like a hotel concierge, venue concierge 700 will provide relevant venue specific information. By means of venue navigator 800 a user can see venue maps and locate places within the venue and get directions. Venue games 300 allows multiple users to play interactive wireless games. The system has a function 1000 for sending and receiving E-mail. A venue calendar 110 includes a calendar of venue activities, and can incorporate the user's personal calendar. Electronic commercial transactions can be effected between the user and venue merchant via venue commerce 1200. Venue auction 1300 allows the server (or the venue itself) to conduct electronic auctions among the users at that venue. Announcements 1400 permits the server (or the venue itself) to make simultaneous broadcast announcements to all users at that venue. Currency calculator 1500 permits users to easily determine exchange rates and calculate specific amounts of currency in other currencies. By means of the world clock 1600, the time anywhere in the world can be determined. Venue account 1700 and PDA settings 1900 allow a user to check and edit user settings and account status and information. Venue video 1800 permits the user to access venue-specific streaming audio and video. Venue feedback 2000 is a means for users to convey to the venue owner the user's comments about activities at the venue at that point in time.

FIG. 2b illustrates the new user registration Sign-up process for the System 101x (101x refers to Online Server 101a and Local Server 101b) by the User 140. User 140 needs to provide the required sign-up information 201, like ‘First Name’, ‘Last Name’, ‘Sex’, ‘Email ID’, ‘Login ID’, ‘Password’, ‘Confirm Password’, ‘Hint Question’ and ‘Hint Answer’. After User 140 submits the appropriate personal information, the User 140 submits ‘SYSSIGNUP’ command along with this information to System Server 103x (System Server 103x refers to Online System Server 103a and Local System Server 103b). System Server 103x validates the information with the database. Login ID 202 and Email ID 203 needs to be unique. The User 140 would need to provide this information again if it is not different from some other user, who already has taken that particular name provided for Login ID or has used the same email address as provided by the User 140 in question.

An optional step after the sign up process is the rental of devices and related accessories. User 140 can opt to rent a wireless portable communication device, such as a Pocket PC device with built-in or a separate accessory for Wireless LAN card/PDA expansion jacket 204. On the occasion that User 140 might possess his own device that is Wireless LAN compatible, the rental process would be skipped. At this point the sign-up process is complete and he is successfully registered with the System 101x. In case, the User 140 wants to rent only Pocket PC or only Wireless LAN card with PDA expansion Jacket or a combination of both, then he would have to select from the listed devices/accessories required 205. After the User submits his selection, the System Server 103x checks the availability of the selected devices/accessories. Availability is checked again just before submission of the final request, just in case another user has already submitted the rent request by the time the User 140 in question submits his request. If by chance any of the requested devices/accessories by the User 140 is not available, then the User 140 would have to choose some other alternative devices/accessories selection 206.

After submitting the request for rent of device/accessory, User 140 needs to provide his Credit Card information 207 for payment-. The Credit Card information is sent using ‘SYSSIGNCRDT’ to System Server 103x. System Server 103x makes a Secured Socket Connection (SSL) to the Payment Gateway to send this sensitive or confidential information for validation and the transaction is carried out. Once the transaction status 208 is successful, the User 140 is successfully registered 210, otherwise an appropriate error message 209 is displayed to the user.

FIG. 2c demonstrates the Venue Login process. Client 200 accepts the login ID and Password from the User 140 and sends command ‘SYSLOGIN’ with login data 216 to the System Server 103x for authentication using Messaging Protocol 141. System Server 103x, authenticates the User 140, by calling a SQL stored procedure ‘Login Proc’ 217, which checks the validity of login data with the database 104. If login data is incorrect, System Server 103x sends command ‘SYSLOGIN’ indicating login failure to the Client 200 through the Messaging Protocol 141. Client 200 appropriately requests the User 140 for correct login data. If login data is validated, the system checks for existence of other users with the same login data 218 who are online. If System Server 103x findsa duplicate, it disconnects the previous user 219. System Server 103x checks if the User 140 has received any new message and/or has found any new match, and then sends all this data with Login Successfully message using ‘SYSLOGIN’ command to the Client 200. After successful login, User 140 has an option to view Match(s) 224, if any, as indicated by Client 200, ‘Now’ or ‘Later’ as the User would decide. If the User 140 wishes to see the match(s) ‘Now’, then Client 140 submits a command through Messaging Protocol 141 ‘SYSMYMATCH’ and will receive a command ‘VMSEARCH’ with the list of new match(s) found by the System Server 103x as well as the old existing match(s). If there is a new Message(s) 220, Client 200 will send command ‘SYSMSGLIST’ using Messaging Protocol 141 to System Server 103x and receives command ‘VMSEARCH’ with the list of message(s) and then the option View Message 221 is shown to Client 200 where User 140 can opt for Match messages 222 and/or Messenger messages 223. If there is a new match 224, the user can then view the Matched Profile 225.

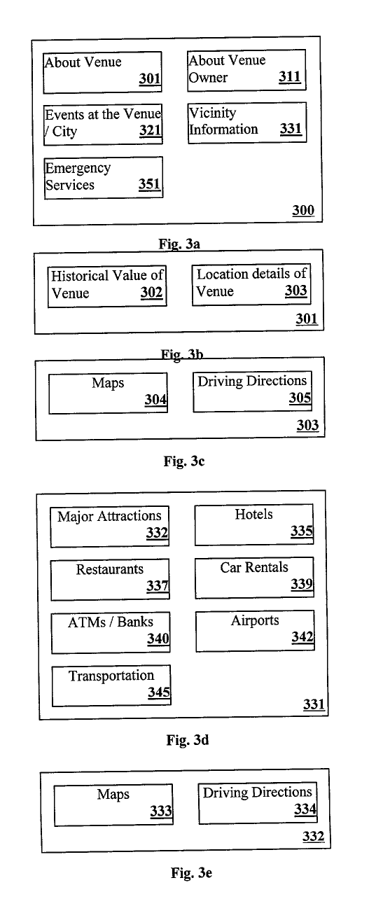

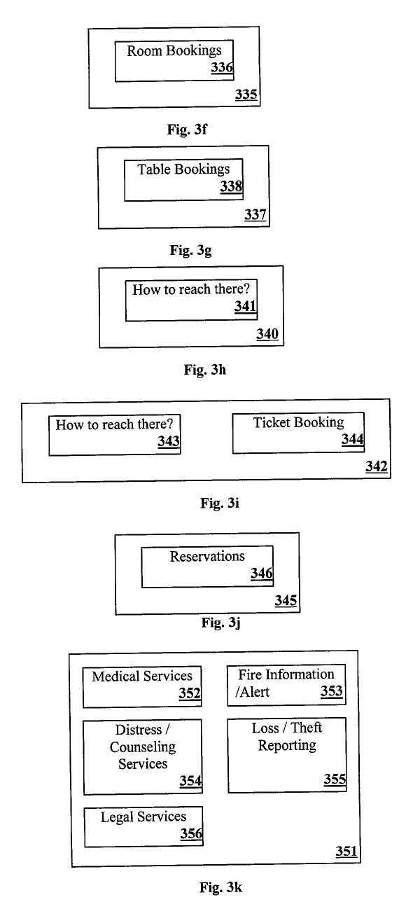

The Venue Portal 300 can provide venue specific information, such as maps, amenities, shop locations, restaurants, event and entertainment information, etc. The information is structured depending upon the actual venue, i.e. Convention center, athletic arena, Hotel, Tourist area, Resort, Campus, or a city. The general structure of Venue Portal 300 is illustrated in FIGS. 3a-3k. FIG. 3a demonstrates the top-level links for the Portal. About Venue 301 consists of historical information 302 about the venue and Location details 303 of the venue, which consists of Maps 304 and Driving Directions 305 that can be generic or specific to the user's current location.

About Venue Owner 311 is the complete information of the venue operator using the system for providing the services for its venue. Events at the Venue/City 321 is a list of scheduled venue events. The list also contains an option to add the events to the Venue Calendar 1100 for future reference and also for automated reminders as set by the user. Vicinity Information 331 consists of Major Attractions 332, Hotels 335, Restaurants 337, Car Rentals 339, ATMs/Banks 340, Airports 342, Transportation 345 or any other information in vicinity of the venue deemed important by the Customer.

In times of medical or other emergencies, a Emergency Services button 351 can be invoked and real-time alerts are sent to the appropriate authorities. For medical services 352, fire 353, counseling 354, theft 355 or legal services 356, any other types of appropriate services can be listed.

FIGS. 3f-3j are appropriate for any service that can be reserved, such as hotel room bookings 336, restaurant bookings 338, directions 341 to ATMs/Banks, airplane reservations 344 airport directions 343 and other transportation reservations 346. Any type of services can be listed with greater or less specificity, as required by the particular venue.

Major Attractions 332 would list all the relevant places of tourist/visitor interest in the vicinity of the venue or the city and provides complete detailed information including Maps 333 and Driving Directions 334 from landmarks of interest. It is possible to get Driving Directions 334 even from the User's 140 current location by detecting triangulation information if the User owns 3 G/GPRS enabled device and if the geo-coded database of the location is available.

The Hotels 335 link provides the User 140 with complete Hotel 335 information. Users 140 accessing the Online System do advance Room Bookings 336. Similarly, Users 140 can do Table Bookings 338 for a particular Restaurant 337 or sitting in their Hotel 335 room they can view the Menu and order food. Users can also check nearest ATM or a Bank 340. Other services include driving directions 341 to a particular ATM or a Bank 340. A similar analogy can be applied to Airports 342 and Users 140 can access all information including directions 343 or even Book their Ticket 344 for their next flight. The same is applicable for other means of Transportation 345 like Bus Stands, Railway or Rent a Car services and the User can also do Reservations 346 online. Emergency services 351 is the most important piece of information which provides information on Medical Services 352, Fire Information/Alerts 353, Distress/Counseling Services 354, Loss/Theft Reporting 355, Legal Services 356 or any other service which the authorities of the venue provide.

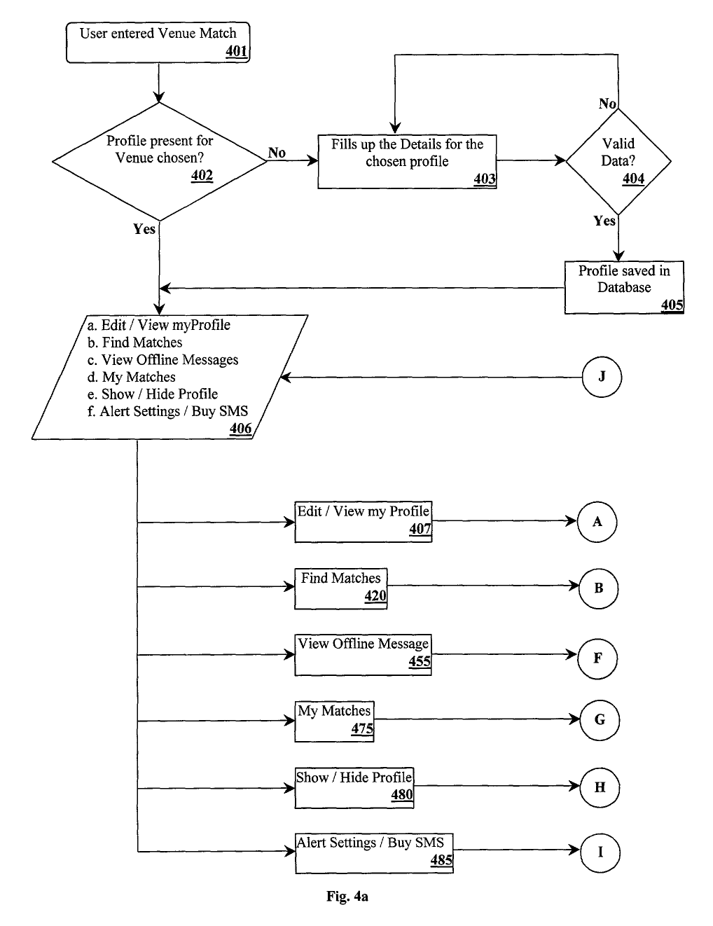

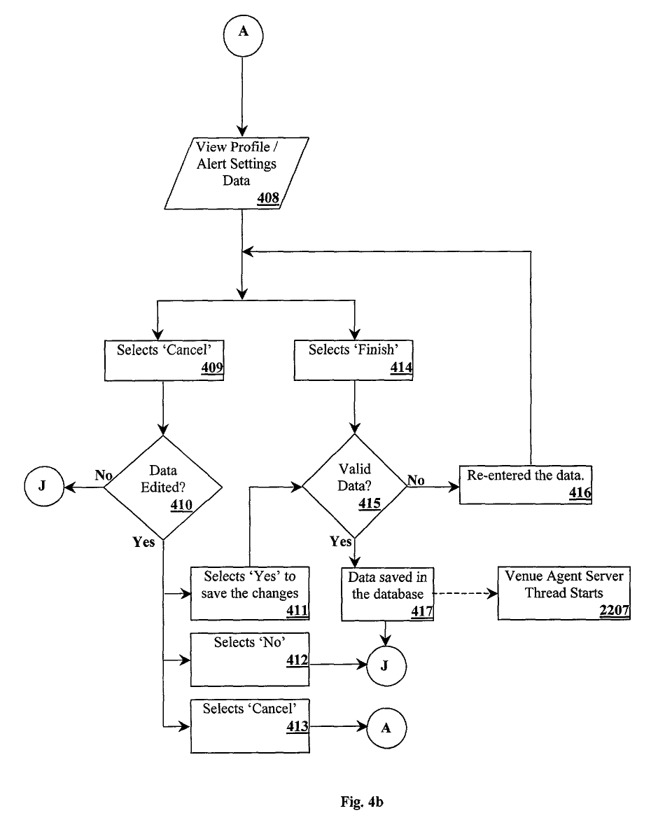

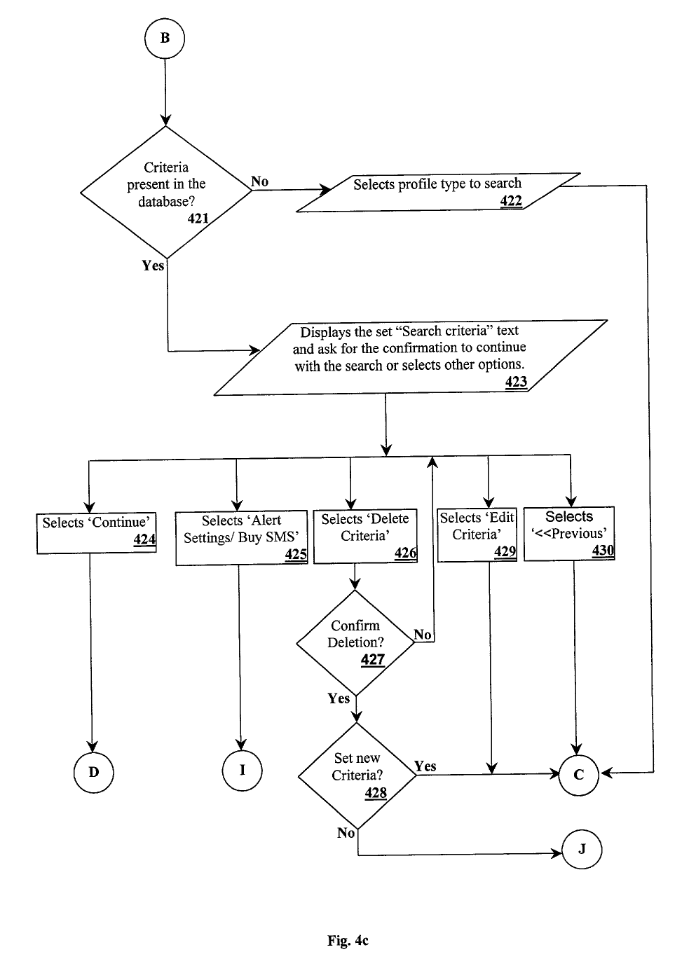

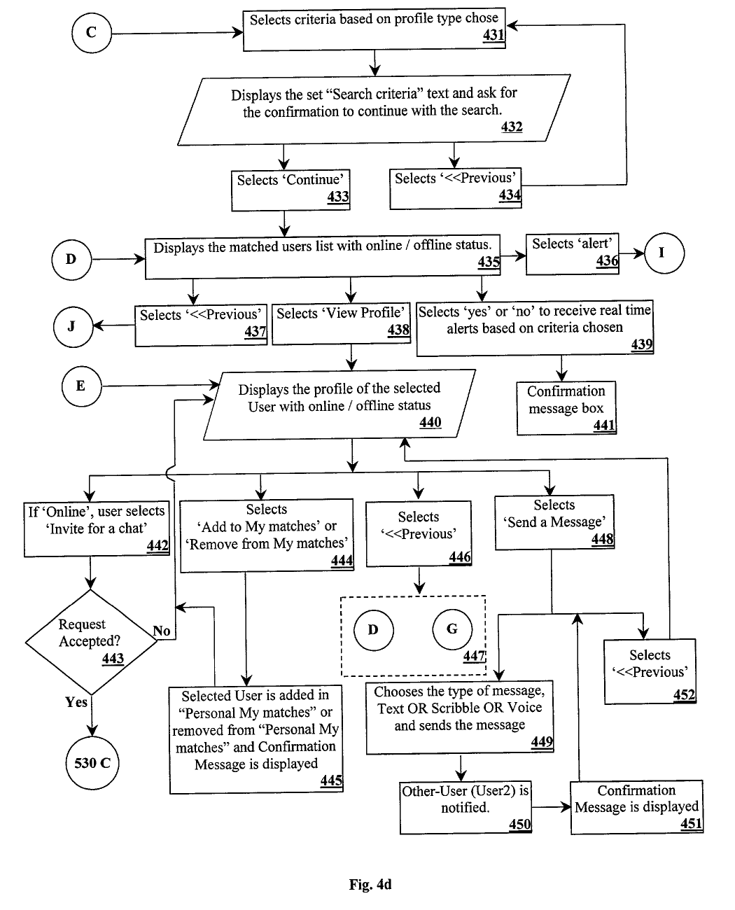

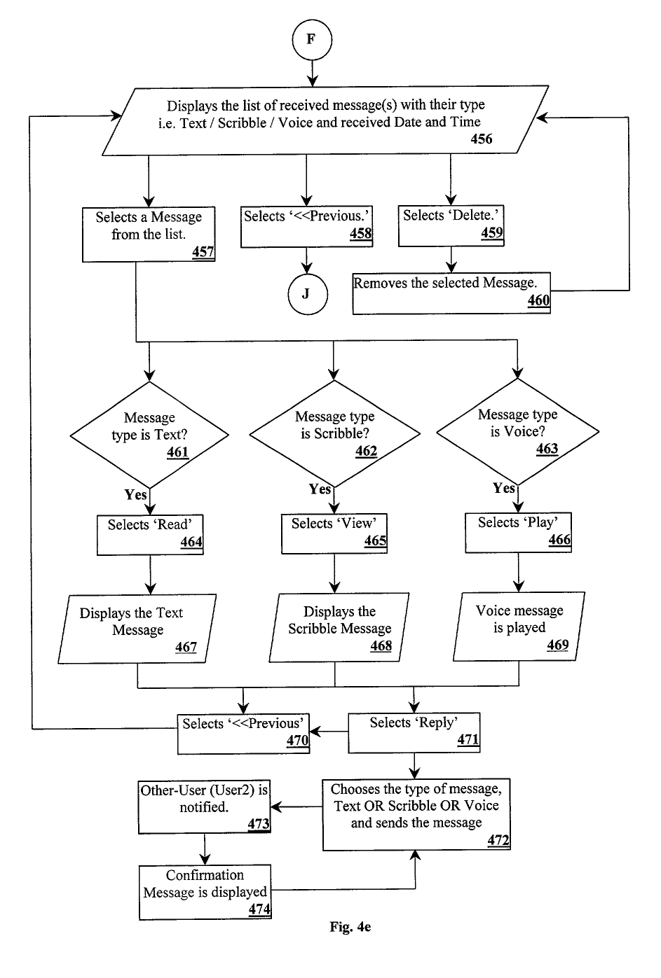

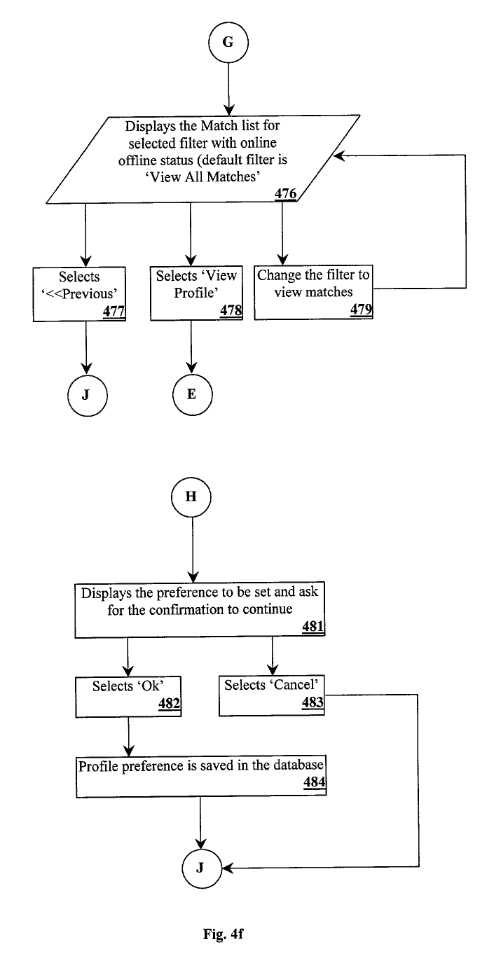

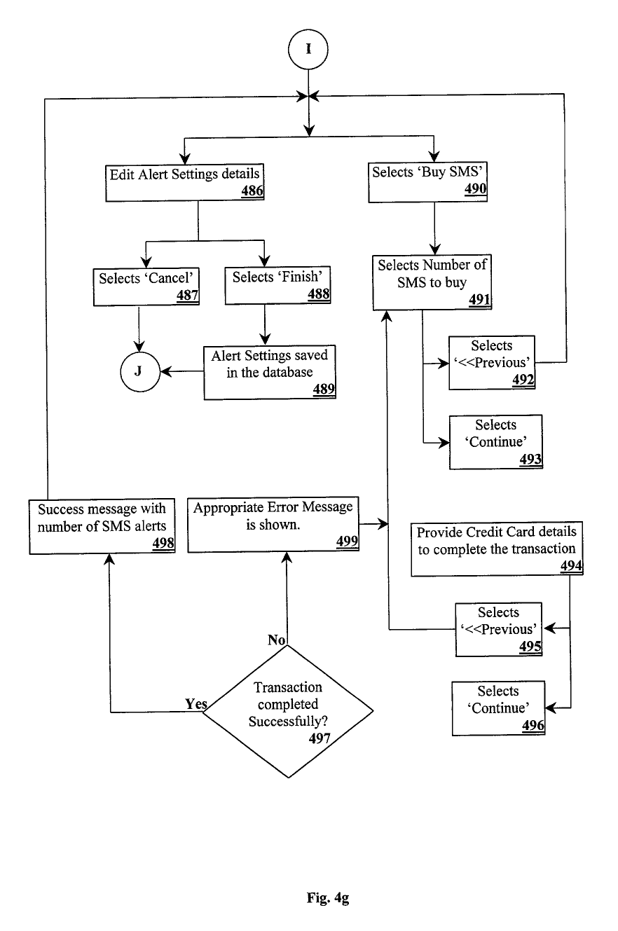

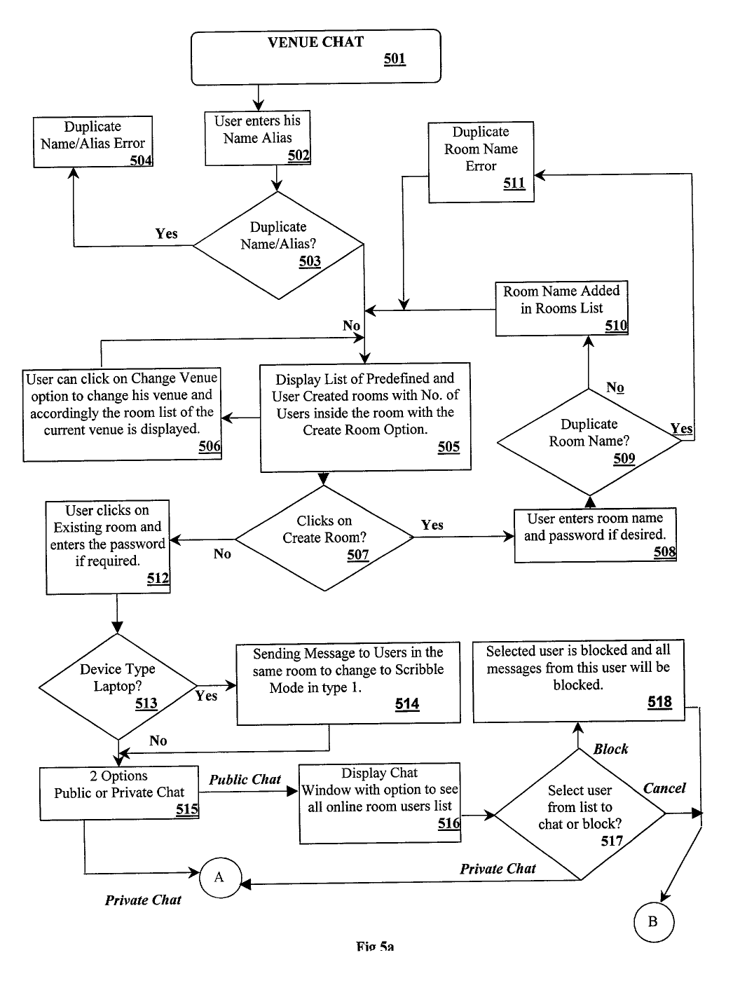

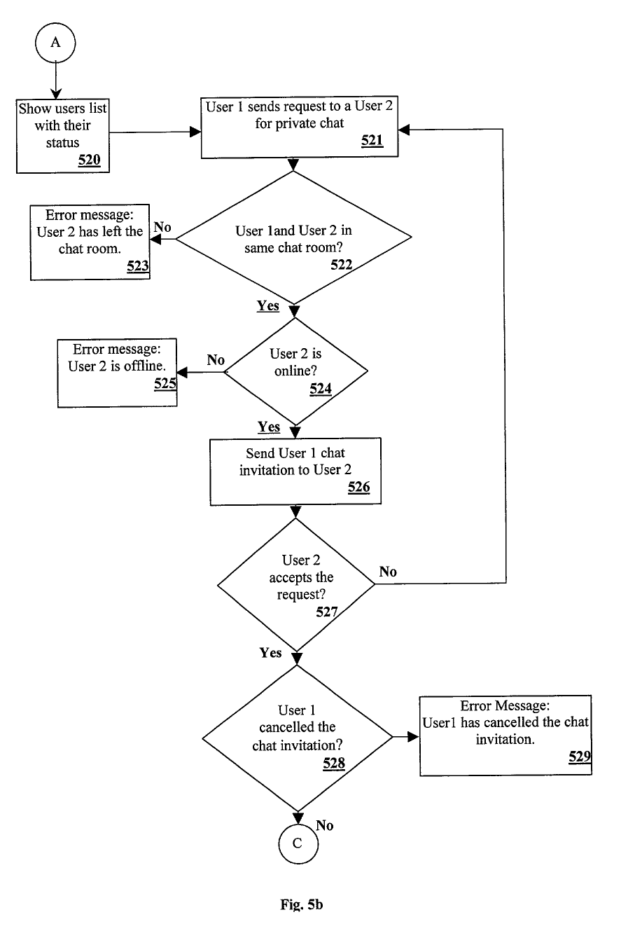

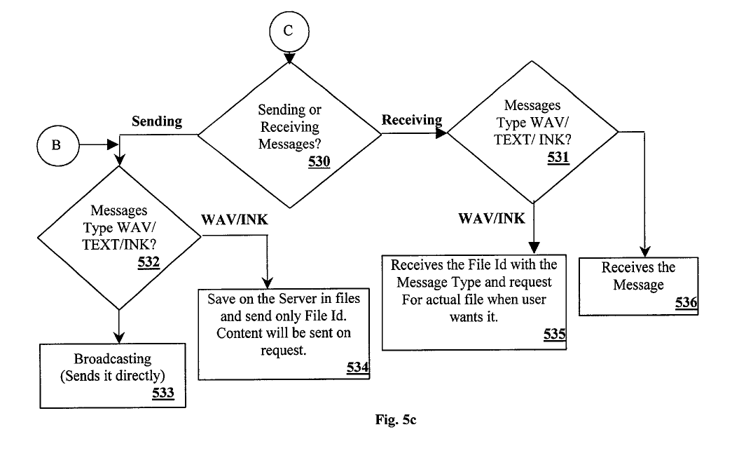

Details on how to identify other users at the same venue, according to a stated criteria, are best illustrated in FIGS. 4a-4g. When a User 140 taps on Venue Match 401, it sends command ‘SYSMATCH’ through the Messaging Protocol 141 to the System Server 103x. The System Server passes a request data to the SQL stored procedure “HandleMatchProc” which in turn checks that the User 140 has a profile for the selected Venue 402. System Server 103x sends the result of SQL stored procedure “HandleMatchProc” to the client 200 by “SYSMATCH” command through the Messaging Protocol 141.

If return result is that the User has no existing profile, then the User 140 is asked to fill up the profile details 403.This validates the User 140 profile detail 404.If the User 140 profile data is valid 404, the command “SYSVMINSERT” is sent to the System Server 103x through the Messaging Protocol 141 to insert the profile data 405 into the database 104x.

If a valid profile exists for User 140, the last saved searched criteria is shown. The. The User is shown the Venue Match Menu 406 comprising of Edit/View my Profile option 407, Find Matches 420, View Offline Message 455, My Matches 475, Show/Hide Profile 480 and Alert Settings/Buy SMS 485. SMS are Short Message Service texts sent to the Client 200 from the Venue Match engine within the Server to distribute match notifications based on the criteria entered by a user.

The Edit/View my Profile process is illustrated in FIG. 4b. When the User 140 taps on Edit/View my Profile option, the command “SYSVMPRO” is sent through the Messaging Protocol 141 to the System Server 103x In response, System Server 103x, calls the SQL stored procedure “EditProfileProc”, which returns profile data along with the Alert Setting data of User 140 and System Server 103x sends this information to the Client 200 by sending the command “SYSVMPRO” through the Messaging Protocol 141.

If User 140 has edited the existing profile or alert settings 408 and taps on Finish 414, then Client 200 validates the entered data 415. If User 140 taps on Cancel 409, then Client 200 checks if the data is edited 410 or not. If data is not edited, then Client 200 redirects the User 140 to Venue Match Menu 406 and, if data is edited, then Client 200 shows a confirmation message box with three options. Yes 411 saves the data in the Database 104x(Database 104x refers to Online Database 104a and Local Database 104b) after validating the data 415, No 412 redirects the User 140 to Match Menu 406 without saving the changes in the Database 104x and Cancel 413 cancels the User's 140 previous request of Cancel 409. If the edited data 410 is valid, then Client 200 sends the command “SYSVMINSERT” to the System Server 103x through the Messaging Protocol 141 to insert the edited profile data 417 into the database 104x and System Server 103x starts the Venue Match Engine thread 2207. If the validity 415 of the data could not be confirmed, then User is asked to re-enter the data 416.

The Find Matches process is illustrated in FIG. 4c and FIG. 4d. When the User 140 taps on Find Matches option, Client 200 checks (421) that User 140 has search criteria already saved in the Database 104x. If User 140 does not have search criteria saved in the Database 104x, then Client 200 displays User 140 options of profile type 422, which User 140 wishes to search in the Database 104x. If User 140 has search criteria already saved in the Database 104x, then Client 200 displays the current User 140 search criteria 423 along with Continue option to Find Matches 424, Alert/But SMS option 425, Delete criteria option 426, Edit Criteria option 429 and Previous option 430.

When User 140 taps on ‘Continue option 424’, then Client 200 sends a command ‘SYSVMSEARCH’ through the Messaging Protocol 141 to the System Server 103x. System Server 103x calls the SQL stored procedure “VenueMatchProc” that returns the result consisting of Matched Profile according to the User 140 search criteria. System Server 103x returns the SQL procedure result to the Client 200 by sending the command ‘SYSVMSEARCH’ through the Messaging Protocol 141. As an action to the System server 103x, the Client 200 shows the matched users list with Online/Offline status 435 with Alert Settings/Buy SMS option 436, Previous Option 437, View Profile option 438 and receives real time alert option 439. User 140 can toggle the real-time alerts option ON or OFF for matches found by Venue Match Agent Thread 2207 based on the saved search criteria. User taps on ‘Yes’ or ‘No’ 439 option, Client 200 confirms the action 441 and sends the selected option ‘Yes’ or ‘No’ to System Server 103x and the preference to receive real timer alerts is saved in the Database 104x by the System Server 103x against the User 140.

When User 140 taps on Previous option 437, then client 200 redirects User 140 to Venue Match Menu 406. When User 140 another user from the User list and taps on View profile option 438, Client 200 sends a command ‘SYSVMSELECT’ through the Messaging Protocol 141 to the System Server 103x. System Server 103x calls SQL procedure “ViewProfileProc” that returns the profile data of selected users and System Server 103x sends the SQL procedure's result back to the client 200. This is done when System Server 103x sends the command “SYSVMSELECT” through the Messaging Protocol 141 to the Client 200. In response to the System Server 103x reply, the Client 200 shows the following options: selected user's profile along with Online/Offline status 440, Invite for Chat option 442, Add/Remove to/from My matches option 444, Previous option 446 and Send Message option 448. When User 140a taps on Invite for Chat Option 442 and User 140b accepts the request 443 then both the users enter a Private Chat. Private Chat is explained later in FIG. 5b and FIG. 5c description.

When User 140 taps on Previous option 446, then Client 200 displays 447 the User 140 to the match's user list 435. Client 200 redirects the User 140 to the user Match list 476 for viewing matches based on selected criteria rather than all matches. When User 140 taps on Add/Remove to My match option 444, Client 200 sends command ‘SYSADD/RMVMATCH’ command through the Messaging Protocol 141 to the System Server 103x. System Server calls the SQL stored procedure “Add/RemoveMatchProc” to add/remove the selected user from My Match list and confirmation 445 of the action sent is to the client 200 by sending command “SYSERROR” through the Messaging Protocol 141. User 140 taps on Send Message option 448. Client 200 shows the Multi-Modal Message 449 screen to User 140 with a Previous option 452. From this screen User 140 can choose to send a Text or Scribble or Voice message. When User 140 taps on Text message option, Client 200 redirects User 140 to text message composition. User composes the message and taps on send message option using command “MSTXT” to System Server 103x through the Messaging Protocol 141. System Server 103x now calls the SQL stored procedure “FileIdProc” which stores the message detail to the database 104x and returns the new “file id”. System Server 103x also creates the file on the System Server local hard drive. The sender gets a confirmation of successful transmission and if receipient is online then he receives a new message notification.

When User taps on Delete Criteria option 426, Client 200 prompts User 140 for deletion confirmation 427 of search criteria. If the User 140 taps the No option Client 200 redirects User 140 to the Main menu 423. If User 140 taps the Yes option 428 then User 140 existing search criteria is deleted from database 104x and client 200 asks the User 140 whether User 140 wishes to have new search criteria. If the User 140 taps no then Client 200 redirects the User 140 to Match Menu 406. If the User 140 taps on Yes then Client 200 redirects the user 140 to select criteria screen 431 based on the profile. When the User 140 chooses the criteria from the search criteria screen and clicks on Continue Client 200 displays the set ‘Search Criteria’ text and asks for the confirmation 432. If User 140 taps on Previous 434 then Client 200 takes User 140 back to the search criteria screen 431 to set new search criteria. If User 140 taps on ‘Continue 433’ then Client 200 sends command “SYSVMINSERT” to the System Server 103x through the Messaging Protocol 141. Now System Server 103x saves the search criteria of User 140 to the database 104x and continues to the search the users who match the new criteria. When User 140 taps on Edit Criteria option 429 then Client 200 shows the new search criteria screen with the existing criteria selected. The View Offline Message option is illustrated in FIG. 4e. When User 140 taps on View Offline Message option 455 from Match Menu 406, Client 200 sends command ‘SYSMSVIEW’ to System Server 103x through Messaging Protocol 141. System Server 103x calls SQL stored procedure ‘MessageViewProc’ that returns the list of messages with their type i.e. Text/Scribble/Voice and a time-stamp.time. System Server 103x sends result of SQL procedure using command ‘SYSMSVIEW’ through Messaging Protocol 141 to the client 200. Now the Client shows the list of messages 456 with the following options: Read 464/View 465/Play 466 message, Previous option 458 and delete option 459. User 140 selects a message and taps on Delete option 459 then Client 200 confirms the action and sends the request to System Server 103x to remove the message from the Database 104x. When User 140 selects a message 457 and taps on Read Text Message option 461, or View Scribble Message option 462 or Play Voice Message option 463, Client 200 sends command ‘SYSMSREAD’ to System Server 103x through Messaging Protocol 141 as an action System Server 103x. The system server reads the requested message file from the storage media (local hard drive) and sends the file data in bytes to the Client 200. Now the client 200 displays appropriate screen according to the type of message data received i.e. Text Box 467 for Text Message/Scribble Board for Scribble Message 468/Voice Menu for Voice Message 469 along with the Previous option 470 and Reply option 471 to the user 140. When User 140 taps on Reply Option, Client 200 redirects the User 140 to the multi-modal screen 471, User 140 can choose either Text, Scribble and Voice option 472 to compose the message and sends command ‘MSTXT/MSINK/MSWAV’ to the System Server 103x through Messaging Protocol 141. As a result System Server 103x calls SQL stored procedure ‘FileidProc’ that returns the new file id, stores the message data into the database 104x and creates a file in the storage media (local hard drive). Further, System Server 103x checks if identified user is online or offline. If he is online, then System Server 103x sends command ‘SYSOFFLINEM’ to the opposite user for online message pop-up notification 473 and message delivery confirmation 474 sent to the recipient User 140.

The My Matches option is illustrated in FIG. 4f. When User 140 taps on My Matches option from Match Menu option 406, Client 200 sends command ‘SYSMYMATCH’ to System Server 103x through Messaging Protocol 141. System Server 103x calls SQL stored procedure ‘ViewMyMatchProc’ that returns matched user lists. After that System Server 103x sends command ‘SYSVMSEARCH’ to Client 200 through Messaging Protocol 141, Client 200 displays the matched user list 476 with following options: Previous Option 477, View Profile option 478 and Change filter option 479. When User 140 taps on Previous option 477, Client 200 redirects the User 140 to Match Menu 406. When User 140 taps on View Profile option 478 the profile of that user is seen. The View Profile option is explained later in FIG. 4d. When User 140 taps on Change Filter option 479, Client 200 sends command SYSMYMATCH’ with mode either ‘P’ which indicated that match list generated by User 140 or ‘V’ which indicates that match list generated by Match Engine to System Server 103x. System Server 103x calls SQL stored procedure ‘ViewMyMatchProc’ that returns the matched profile list of User 140 based on mode i.e. ‘P’ or ‘V’. Now System Server 103x sends command ‘SYSVMSEARCH’ to Client 200 and Client 200 displays the match list 476.

The Show/Hide Profile option is illustrated in FIG. 4g. When User 140 taps on Show/Hide Profile option 480 from Match Menu 406, Client 200 redirects the User 140 to preference screen 481 with OK option 482, Cancel option 483. When User 140 taps on Ok option 482, Client 200 sends command ‘SYSVMINSERT’ to System Server 103x. System Server 103x executes the SQL query into the database 104x sent by Client 200 to set preference i.e. Show/Hide profile 484 in the Database 104x. Now the Client 200 redirects the User 140 to Venue Match Menu 406. If User 140 taps on Cancel option 483, Client 200 redirects User 14O to Venue Match Menu Screen 406.

The Alert Settings/Buy SMS option is illustrated in FIG. 4g. When User 140 taps on Alert Settings/Buy SMS option 485 from Venue Match Match Menu 406, Client redirects the User 140 to the preference screen that has the following options: Edit Alert Settings option 486, Buy SMS option 490. When User 140 taps on Edit Alert Settings option 486, Client 200 sends command ‘SYSALERT’ through Messaging protocol 141 to System Server 103x. System Server 103x executes the SQL query to select the User's 140 alert settings from the database 104x. System Server 103x sends this information to the Client 200 by command ‘SYSALERT’ through Messaging protocol 141. Now Client 200 displays the existing alert settings so User 140. User 140 has the following options: User can change any existing values and decided to tap on the cancel Option 487 or Finish option 488. When User 140 taps on cancel option 487, Client 200 redirects the User 140 to Venue Match Menu 406. When User 140 taps on Finish option 488 Client 200 sends command ‘SYSVMINSERT’ to System Server 103x. System Server 103x saves the new Alert settings 489 of User 140 into the database 104x. Now Client 200 redirects the User 140 to Match Menu 406.

When User 140 taps on Buy SMS option 490, Client 200 displays the option screen to User 140 for selecting the number of SMS to purchase with Previous option 492 and Continue option 493. When User 140 taps on previous option, Client 200 redirects the User 140 to Alert Settings/Buy SMS option 485. When User 140 taps on continue option 493, Client 200 displays the credit card form 494 to User 140 with previous option 495 and Ok option 496. When User 140 taps on previous option 495, Client 200 redirects the User 140 to Buy SMS Screen 491 with Previous option 492 and Continue option 493 displayed. If the User 140 confirms with a tap on the ‘Ok option 496’, Client 200 sends the command ‘SYSCREDIT’ to System Server 103x through Messaging protocol 141. As a result, System Server 103x creates SSL (Secure Socket Layer) connection with the Payment Gateways to authenticate the credit card transaction 497 of User 140. If the credit card transaction succeeds, System Server 103x saves the transaction information into the database 104x and sends the result of transaction to the Client 200. If the credit card transaction fails, the appropriate error message is dispatched by command ‘SYSCREDIT” through Messaging protocol 141. With a successful transaction, Client 200 is issued a pop-up displaying the success message 498 and redirects the User 140 to Alert Settings/Buy SMS Screen 485 otherwise Client 200 gets the appropriate error message 499 and redirects the User 140 to credit card form 494.

The Venue Chat process is shown in FIGS. 5a-5c. A User taps on ‘Venue Chat’ 501 icon and provides his name alias 502 through the Client 200. The System Server 103 checks for duplicate Name/Alias 503 by determining whether another user has already taken selected name by querying from the database 104. If the Name/Alias has already been registered then System Server 103 sends duplicate name alias error message 504 to the User in response otherwise it sends a complete chat room list 505 of at the venue with the number of users in each room at that particular time. User can switch to other venues using the Change Venue option 506.

Any user can create a new chat room using the Create Room option 507. The User enters the new chat room to be created and password which is optional (508). System Server 103 will then check if the selected room name already exists, by querying from the database 104 (509). System Server 103 sends duplicate room name error message 511 to the client in response, or the server sends the complete room user list to the Client with the newly created room 510 shown.

Any user can enter any existing room 512 by selecting the chat room name from the room list 505. The server first checks if the selected room name is password protected or not. If it is, the system prompts for the password. When the password is entered, the Client 200 checks that the password entered is accurate. If the password entered is incorrect, the system display an error message and again request for the password. The Client dispatches a request supplying the selected chat room name along with the device type to the Server 103. Server 103 checks that selected room name is valid or not. If selected room is valid, then the Systems Server 103 checks the device type 513. If device type is a Laptop, System Server 103 sends a message to all the clients in the same room so that their scribble mode changes from RichInkControl to customized scribble control 514. This is downgrade in rich ink control is done to accommodate as many participating in the same venue.

The user can then select either of the two chat types namely, Public or Private Chat 515. If the user selects Public Chat, Server 103 broadcasts the “user entered” message to all the users in the same chat room and sends the complete user list to all online users with the chat status and the chat window displayed 516. On the other hand, one can initiate a Private Chat instead of a Public one. A specific user can block any other user by selecting from the user list option, which shows the online users in that room 517.

Referring now to FIG. 5b, a user (inviter) invites another user (invitee) for a private chat (521). The server checks (520) to determine if the selected current status of the user being invited is not busy. System Server 103 checks that Inviter and Invitee both are in the same room 522 by querying the database 104. If both users are not found to be in the same room, then Server 103 sends the message to the Inviter that Invitee has left the room 523. If they are in the same room at a particular point in time, then Server 103 checks that Invitee is Online 524. If the Invitee is not online, then Server 103 sends the message to the Inviter that the Invitee is currently offline 525. If the Invitee is online, then Server 103 sends the Inviter's chat invitation message to the Invitee 526. When Invitee accepts the Inviter's chat invitation 527, Server 103 checks whether Inviter is dynamically still available and has not cancelled the chat invitation 528. If both parties are still available, the system then proceeds with setting up the chat session. In the event that Invitee rejects the invitation, then Server 103 sends error message 529 to the Invitee that the Inviter has cancelled the private chat invitation.

Referring now to FIG. 5c, and to continue with a chat session, Server 103 starts the chat session by sending a welcome message to both Inviter and Invitee and changes their status to ‘Busy’ in the database 104. Chat messages can be composed in one of three basic modes i.e. Text, Scribble or Voice 532 and maybe switched from one mode to the other for each message composition. In the case of a ‘Text’ message from any one user during a Public chat session, Server 103 broadcasts the message 533 to all other users in that public chat room. In the case of a Scribble or Voice message 534 during a Public chat, Server 103 creates the message File but only broadcasts a ‘File Id’, which is generated and stored in Database 104 and sent to all users in the chat room. In case of Scribble/Voice message in Public/Private Chat, the user views or listens to the message by sending the ‘File Id’ 535 to the Server 103. In response, the Server 103 sends the actual message data to the requesting user.

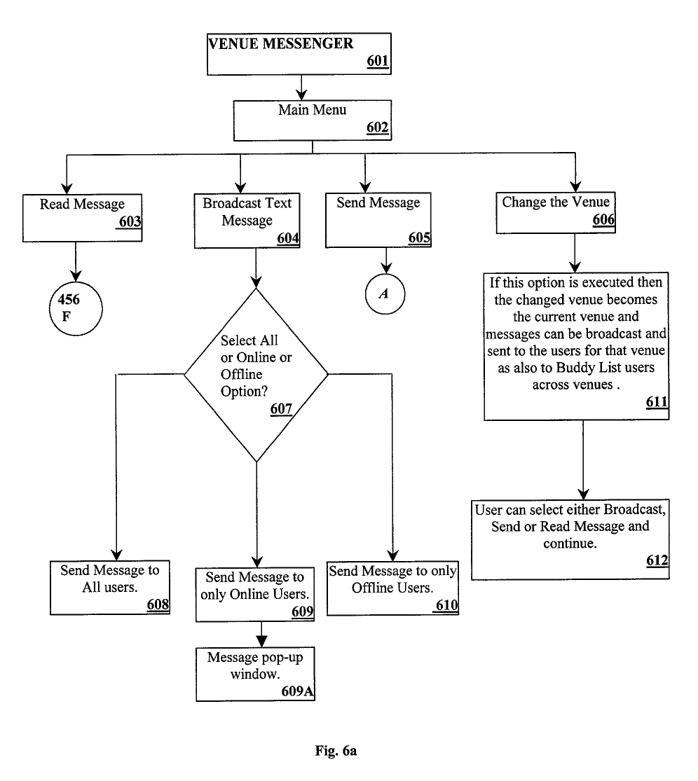

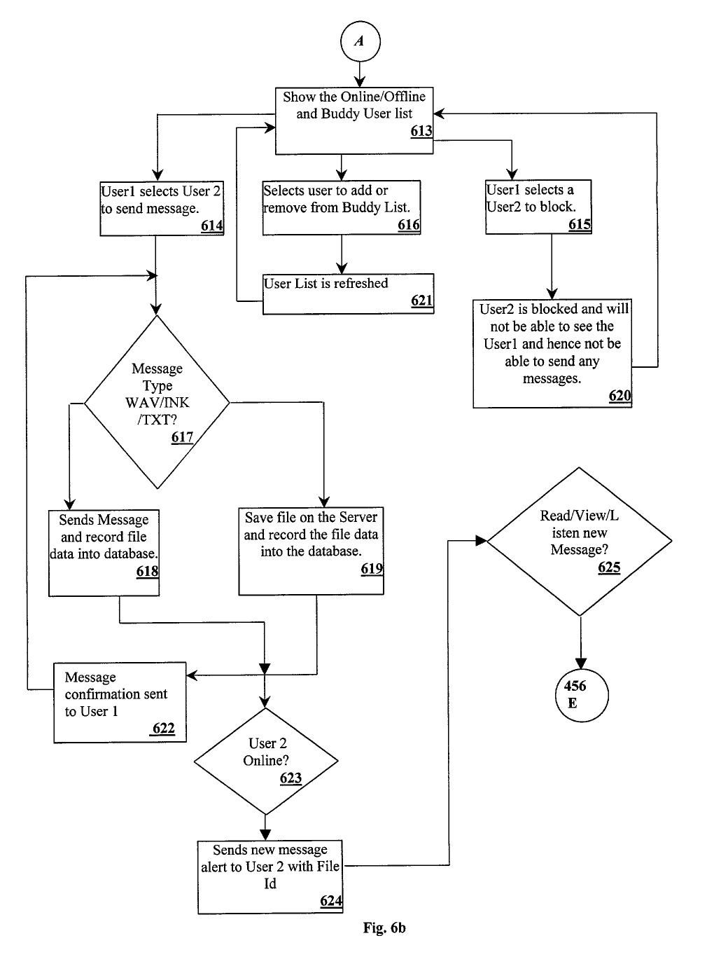

Illustrated in FIGS. 6a-6b is the venue messenger feature. When a User clicks on Venue Messenger 601, the main menu 602 is displayed. This menu consist of choices that consist of Read Message option 603, Broadcast Text Message option 604, Send Message 605, and Change Venue option 606. When a user clicks on Read Message option 603, there appears a list of received message(s) with their specific message type displayed with a small graphical icon along with the received date and time.

The broadcast message feature is explained next. User 140 chooses to broadcast a message 604. Client 200 sends a command ‘SYSSENDALL’ along with the data to the System Server 103x through Messaging Protocol 141. System Server 103x extracts several data items such as the sender of the message, the mode (‘Online, Offline or All’) 607 and the actual message. System Server 103x then checks whether the Sender is ‘Admin’ privileged or a normal User 140. If the Sender is ‘Admin’ privileged, then the Server 103x can broadcast the message to Online Users or Only Offline Users or ALL Users depending on the mode chosen regardless of OTHER user set preference to receive or not to receive such broadcast messages. If the sender User 140 is a normal one (not privileged), then OTHER user set preference is checked and complied with and can not be bypassed. Broadcast messages sent to OFFLINE users are stored in the Database 104x and are presented to users next time they become online.

FIG. 6b demonstrates the Venue Messenger Sending/Viewing and Buddy List feature. User 140 taps on Send Message 605, Client 200 sends the request to System Server 103x, which gets the ‘User List’ of the current venue with their respective status of either online or offline while also displaying the ‘Buddy List’. Options to Send Message 614, ‘Add/Remove User from Buddy List’ 616 and ‘Block User’ 615 are shown. A User 140A can send text message to any other User 140B by selecting User 140B from the displayed ‘Users List’ 614. The command ‘MSNSENDT’ is dispatched through the messaging protocol 141 to System Server 103x and Server 103x extracts the relevant message data including sender ‘User id’ of 140A, receiver ‘User id’ of 140B and the actual message data. Then System Server 103x, depending on the message type 617, saves the message either in the Database 104x if message type is TEXT 618 or generates a ‘file id’ from the Database 104x, creates the file with generated file id name 619, saves the message data in the file and stores the file name in the Database 104x. In the event that User 140B,the intended message recipient, is online 623, the System Server 103x sends a message 624 to User 140B with the option of viewing the message ‘Now or Later’ 625 and confirmation message 622 is sent to the User 140a.

Any User 140 can add or remove users from the current venue user list to a ‘Buddy List’ 616. A confirmation to the action ‘Add or Remove’ 616 is sent. System Server 103x then sends a new user list 621.

The concept of blocking is supported. Any User 140A can for instance, block any other user from his ‘User List or Buddy List’ 613. User 140B, once blocked by User140A, cannot see 620 User 140A hence he/she cannot ‘Send Message’ 605 or ‘Broadcast Message’ 604 to User 140A

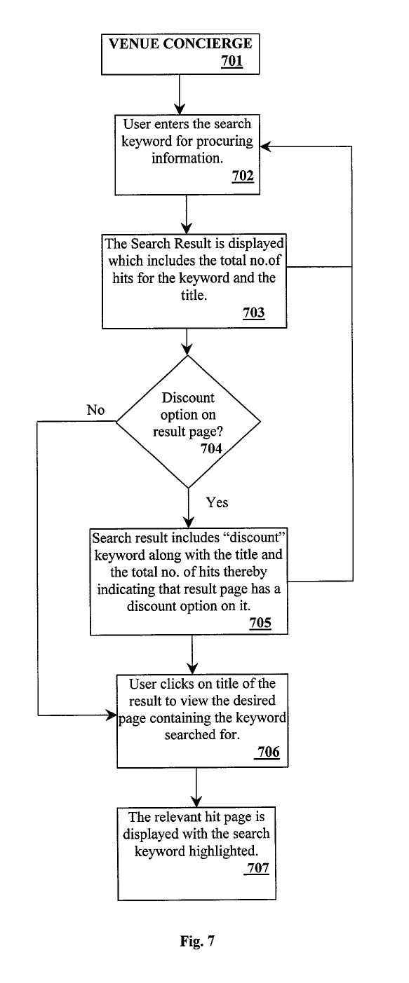

FIG. 7 illustrates how Venue Concierge 700 works. When a user clicks on Venue Concierge 700 button on the application 200, Venue Concierge screen 701 appears on the portable communication device. A user may enter any search criteria keyword 702 to get more information specific to the venue. This works similar to other search engines on the WEB except that the search is confined to the venue and not the entire Internet data repository of WEB pages. If the user has selected a special feature known as the discount option 704 to be triggered with the search, then the user will be able to see hit results 705 with ‘discount’ keyword marker shown along the search hit description. The unique feature of this system is the capability to search for information only that is around the user in a specific location or venue that matches the search keywords given. For example, at a city tourist attraction area, a visitor from out of town may enter the word “lobster”. The system gives the user a list of restaurants that match the criteria—“lobster” and are physically located in or around the tourist or venue area.

The system algorithm is unique to this invention. For each venue a unique index catalog is automatically created inside the Microsoft Index Server. Once the user inputs the keyword and clicks on ‘Submit’ button, the Client 200 sends out relevant information such as the keyword and the venue name to the Web Server 102. Web Server 102 with help of the Server-Side scripting language (.asp or Active Server Pages ) creates a “search object” for the Microsoft Index Server Catalog in memory. This object is available as a COM Component inside the Microsoft Transaction Server. Object sends a request to the index catalog for the unique identifier of relevant files (HTML pages, XML pages) for that venue or location only. The Microsoft Index Server responds to the object with a message 703 that contains unique file identifier, hyperlink to open the relevant hit page inside a mobile browser/desktop browser, title of that HTML page. These titles are then represented as hit result hyperlinks in the users browser screen. User now clicks on the hyperlink 706 to view the page that appeared as a hit. For easier reference the web server not only displays the relevant page to the user but also highlights (changes the font-style, font-size, font-face) 707 the search keyword inside the browser. This allows the easy identification of the relevance of the resultant page.

Additional parameters generated at the index server level include discount tags for that resultant page. The discount tag works as follows: The User enters, for example, the Search Keyword as “steak”. The Search result contains hyperlinks to 6 pages with references to steak. The first 2 hyperlinked pages have a discount icon in front of the hyperlink. In this case, the first 2 HTML pages included the keyword “steak” in the HTML BODY and there was a META TAG or HTML marker in the HTML HEADER with the value “discount”. The rest of the resulting pages in this example, i.e. the remaining 4 pages happened to contain the word “steak” also in the HTML BODY. Hence the search object with the Index Server object co-relates the presence of the Search Keyword “steak” with the Meta-tag name “discount”. As a rule, search hits with Meta Tags appear FIRST to weigh those with discounts and position them up front in the search algorithm. Merchants that the venue or closely surrounding areas will be charged a premium advertising fee to list accordingly.

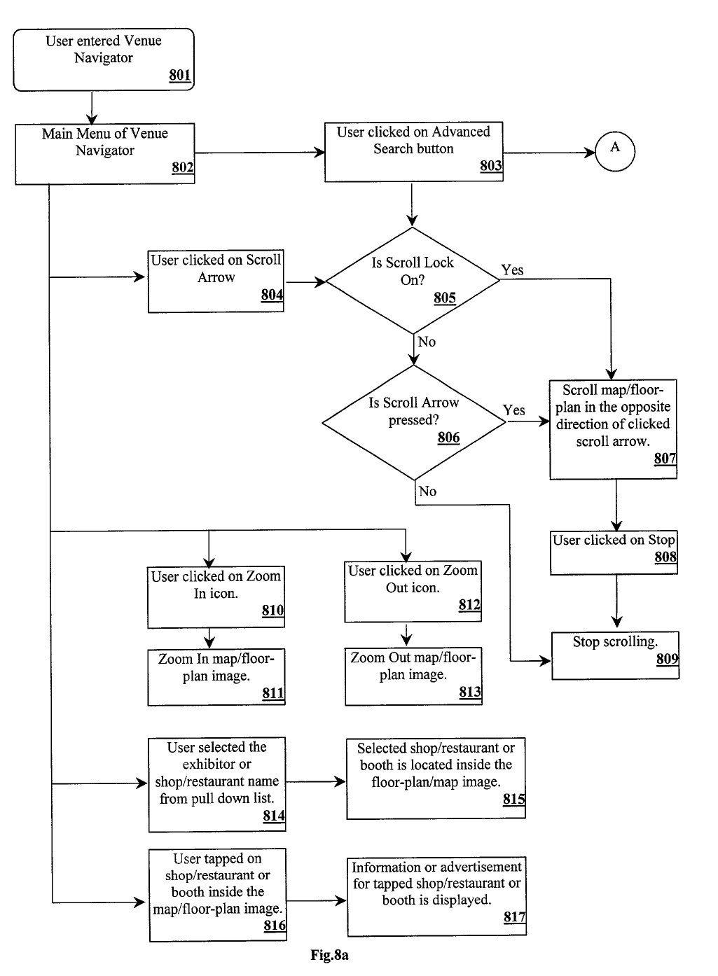

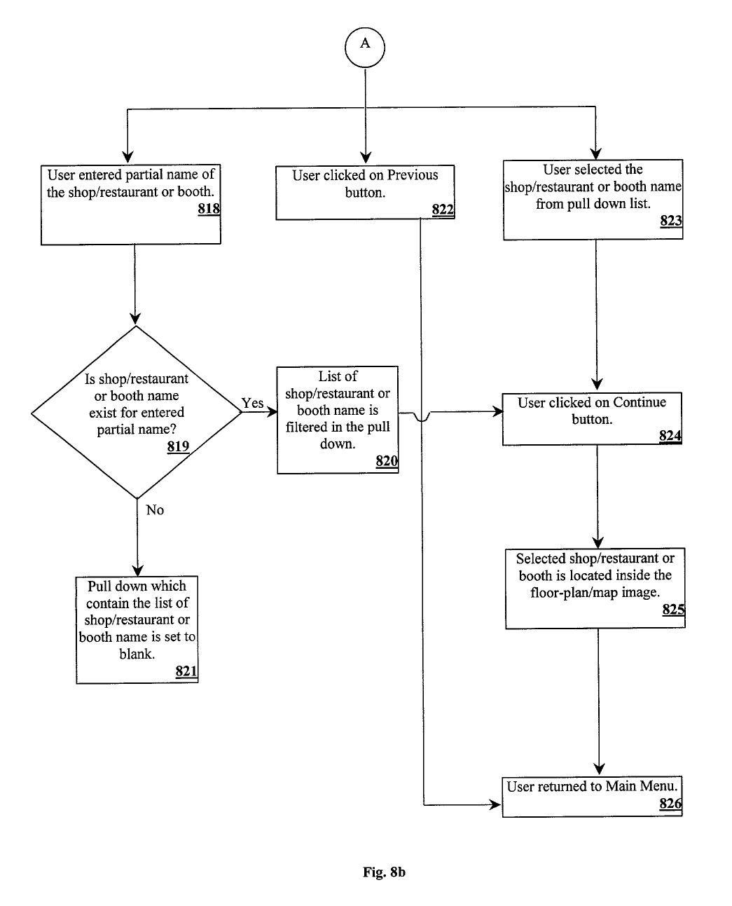

Venue Navigator is a feature which helps users navigate in and around a specific location or venue. For instance, within a trade show conference, exhibitor booths can be located using smart search engines that point out booth locations in a graphical manner. Venue Navigator is illustrated in FIGS. 8a-8b. Once the user taps on the Venue Navigator, a new window is launched (801) and the current window, i.e. the application Main Menu page is hidden. This new window created loads an image file which, actually a map which shows a graphical depiction of the venue physical layout, in this case the Exhibit Show floors. It also loads an XML file which contains detailed information about Exhibitors participating at this trade show. It then shows the Image/Map of the Venue and all the other system options and commands used to navigate and retrieve and drill down information about a certain/particular area in the Image/map such as an Exhibitor booth.

The options and the facility provided for the Venue Navigation is as follows: Advance Search (803), Exit Navigator, Scrolling arrows for moving image/map left, right or up down (804), Scroll lock facility (805), Zoom in Zoom out facility (810, 812), and a Combo box with the list of all the companies (814) participating in the venue. In a device such as a Pocket PC PDA, if a user taps o on any particular area of the map, the information about that area is “exploded” and more details are revealed.

Advance search (803) is an option through which a user can locate a particular area/company of interest by entering complete or partial search keywords. Once a user taps on Advance search button, a window is opened with a text box and a combo box, a continue button and a previous button. Again in a trade show venue example, by default, the search text box is empty and ready to receive search criteria from the user and a combo box is displays all the companies that are participating in the venue which is extracted from the said XML. At this point, the user can also choose the company name of his interest from the present list in the combo box or he can enter a partial company name (first 3 letters of the company or exhibitor name) in the text box (818). The keyed search data is fed to the system, the system Server scans the XML file and picks up all the possible list of companies that match the particular data (819). The more information a user provides, the better the search hit so a shorter the list appears. Once the user picks a company name (823) from the search hit list and presses continue (824), the Venue Navigator window with the image/map layout re-appears and positions the company/area chosen by the user on the left top part of the image map (825). The user has a clear view of the company/area he searched for and can get additional detailed information by clicking on the area itself (814, 815/816, 817). The user can also zoom in zoom out the area for a better or customized view (810, 811/812, 813).

Scrolling arrows (804) allows the user to scroll the image left, right, up and down. If the user taps on the arrow (806), the image moves one line to the left, right, up or down, depending upon the arrow tapped (807). Now, the user can also keep the arrow pressed and this will force continued shifts of the image depending upon the arrow pressed. As soon as scrolling arrow is tapped, depending upon the arrow tapped that hidden part of the image is brought into view. If the image is at the last or first position, than the request is ignored.

The scroll lock facility (805) allows the user to move the image in a particular direction by just tapping once. The scroll lock is a toggle switch; if it is on and any body taps a scrolling arrow, the image will keep on scrolling continuously unless and until somebody stops the scrolling by tapping the same arrow again or by tapping Scroll lock to off. If the user taps some other scrolling arrow, the image will start shifting towards the given direction. If the Scroll lock is on and any body taps on any of the particular arrows, a timer event is created which keeps on moving the image depending upon the arrow tapped. As soon as somebody stops the scrolling of the image, the timer event is stopped as a result and the image stops scrolling.

Zoom in (810) and Zoom out (812) allows the user to enlarge the image for a better view of a particular area or if required can shrink the image for a totality view of the Venue.

A tap on any area of the image map (815) with or without entering search criteria, reveals additional detailed information about the area/company. As soon as an area on the map is tapped, the system scans the XML file for the detailed information about the area that has been tapped and displays the same to the user.

If the user taps on the Exit Navigator button, then the Venue Navigator system shuts itself down and takes the user back to the Main menu page/window where he can choose any option present, he is interested in.

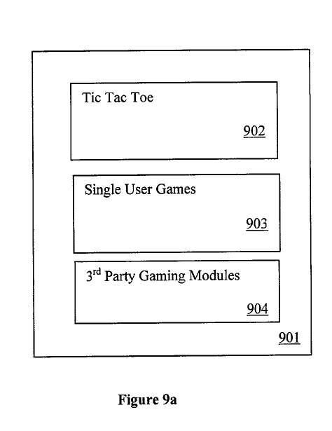

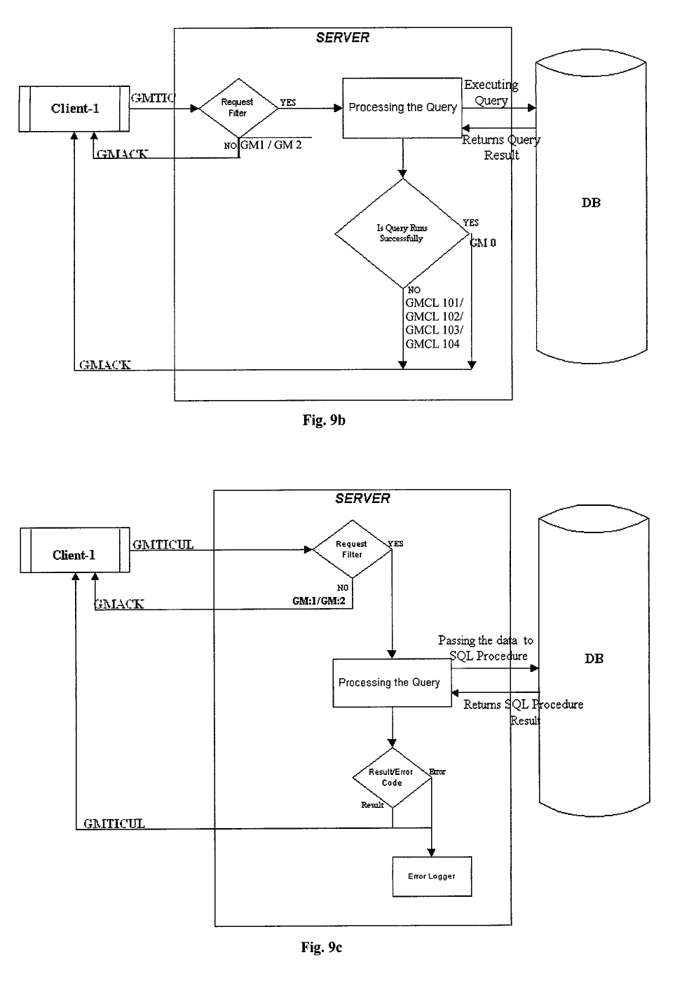

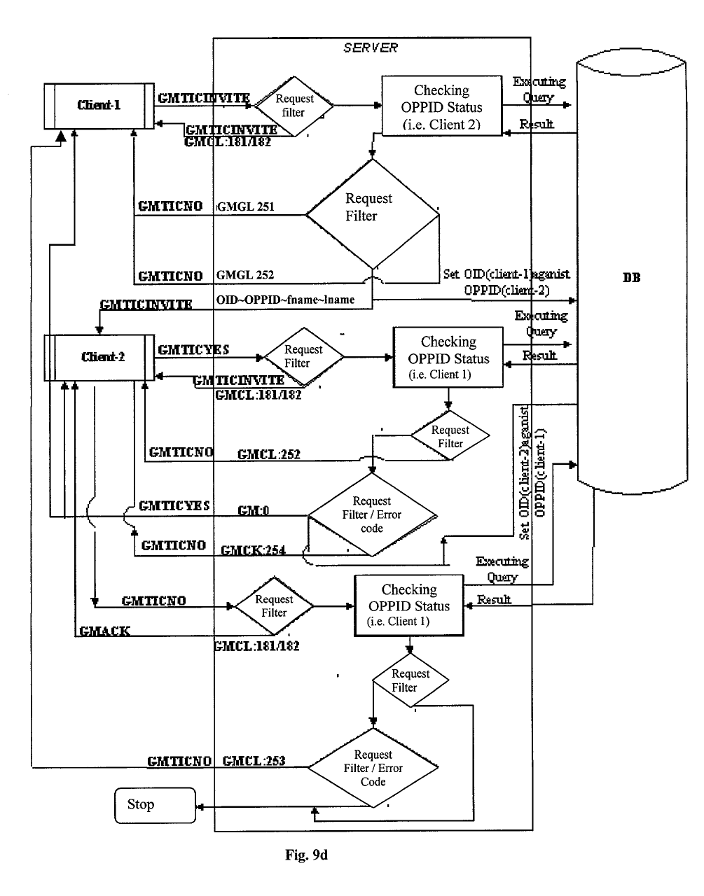

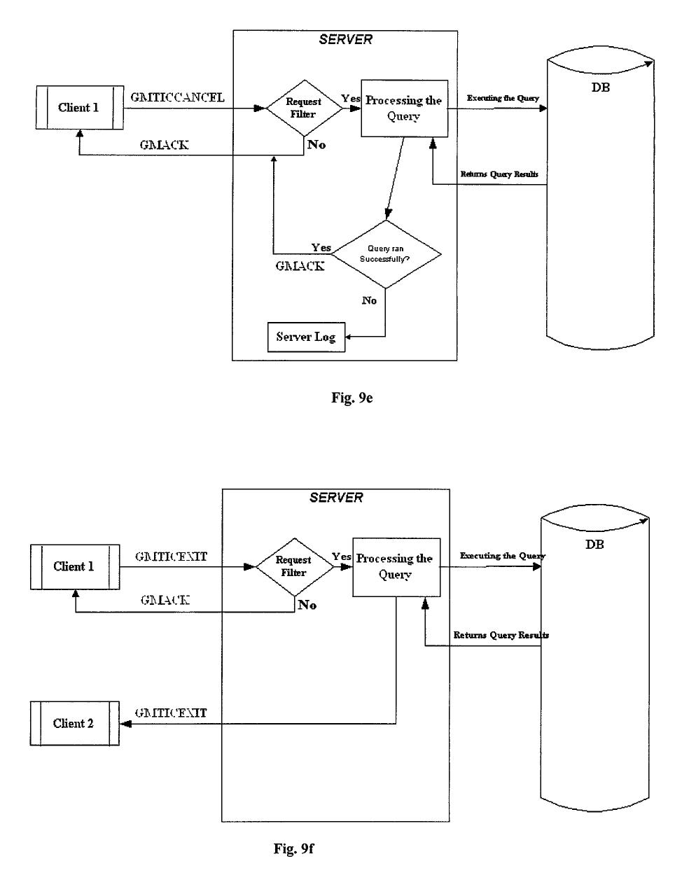

FIG. 9a illustrates the Venue Games 900, 901 feature. At a venue users can play single user games 903 or wireless Multi-User games 904 with known associates or strangers as long as they are at the same venue location. The Multi-User games created as an example is a simple Tic-Tac-Toe 902 game. Plans are to incorporate 3^{rd} Party Games 904 from external strategic partners or companies that wish to use this application as a distribution channel at enabled venue sites. The 3^{rd} Party Game 904 module allows other gaming companies to use the Online Server 101a and Client Application Module 200. Venue Games additionally has a communications module embedded with the games algorithm, that allows user to chat with each other using the multi-modal interface (text, scribble and voice) in between turns of the Tic-Tac-Toe or any other game via exposed APIs(Application Programming Interface).

FIGS. 9b-9f describes the messages and how they are sent between two users (clients) and the Server to play a game of Tic-Tac-Toe. Following is the protocol explanation of messages that are seen in the FIGS. 9b-9f.

Message from client to server is represented by C:S

Message from server to client is represented by S:C

A complete Message protocol between client and server consist of three main parts as follows.

(i) Header—Maximum length is 11 bytes.

(ii) Size—Size of content/data maximum length is 8 bytes

(iii) Content/Data—Actual message

Status Codes:

1. Success Code:—When the client sends any request that is successfully executed on the server as well as on the database, the server will return “GM:0” irrespective of the message/command header.

2. Database Server Crash/Down Code:—When the databases or server are not accessible, the server will return the common code “DB:0” irrespective of the message/command header.

3. Error Codes:—When the client sends any request that fails to be executed on the server or on the database, the server will return ERROR CODES based on the message/command header.

4. Acknowledgement Code: Any request from the client that requires acknowledgement from the server will be done through the “GMACK” command.

In case of Invalid Header, the “GMACK” command will go back in the following format:

| Header | Code |
|---|---|
| GMACK | GM: 1 for Invalid Header |
| | GM: 2 for Invalid Size Flag |

Error Codes:

1. Client Side Errors:—GMCL: error number code according to the message/command header.

These errors indicate unexpected data from the Client.

2. Server Side Errors:—GMSR: error number code according to the message/command header.

These errors indicate unexpected response from the Server.

3. Database Side Errors:—GMDB: error number code according to the message/command header.

These errors indicate error in the database query processing.

4. General Errors:—GMGL: error number code according to the message/command header.

These errors are not specific to Client, Server or the Database but indicate that the Server is unable to process the Client's request.

Each message/command will have 30 UNIQUE error number codes allocated to them with 10 each for the each of the 3 Types of Error codes i.e. first batch of 10 error number codes for Client Side Errors for that particular command, next 10 for Server Side errors for that particular command and final 10 for the Database Side errors for that particular command. All the POP UP messages will be generated by the Client Application based on the Error Codes sent by the Server.

List of the error codes that are coupled with the error header seen in the FIGS. 9b-9f

181—Invalid parameters.

182—Invalid Parameter Type.

251—Opposite User is Busy.

252—Opposite User is Offline.

253—Opposite User has rejected the invitation.

254—Inviter has cancelled the process. The user1 has cancelled the process of invitation to the game and the user2 has accepted the invitation

331 Opposite User has exited the Game.

List of commands/messages that move between the clients and the servers GMTIC (C:S)—Purpose of this command is to store the client's game preferences into the database so that user can get the game invitation from other users. It will be basically a database query that will be generated by client application and get executed on server. This is one way command (i.e. always from C:S)

GMTICUL (C:S S:C)—Client sends this command without any content/data. Server sends this command back to the same client with the list of users whose game preferences are set to ‘YES’. This command is two way (i.e. first from C:S and second S:C) User-List contains user's gender, first name, last name and user id. Sequence: Sex˜frame˜1name˜uid.

GMTICINVITE (C:S S:C)—Client sends this command to invite other user for the game. Server sends this command to opposite user. This commands content/data contains OUID and OPPUID and opposite users first name and last name. Sequence: ouid˜oppuid˜fname˜1name

GNTICCANCEL (C:S)—Client sends this command when user cancels their own issued game invitation to other user. This command's content/data contains OUID and OPPUID. Sequence: ouid˜oppuid

GMTICYES (C:S S:C)—Client sends this command when user accepts GMTICINVITE command. Server sends this to the user who has sent the invitation. This commands content/data contains OUID and OPPUID. Sequence: ouid˜oppuid

GMTICNO (C:S S:C)—Client sends this command when user rejects GMTICINVITE command. Server sends this to the user who has sent the invitation. This commands content/data contains OUID and OPPUID. Sequence: ouid˜oppuid

GMTICMOVE (C:S S:C)—Client sends this command to server indicating users own move. Server sends this command to opposite user to informing about opponents move. This commands content/data contains CellNO, OPPUID and OID. Sequence: CellNo˜OID˜OPPID.

GMTICEXIT (C:S S:C)—Client sends this command when user ends the game session. Server sends this to opposite user informing about opponents exit. This commands content/data contains OUID and OPPUID Sequence: ouid˜oppuid

GMTICEND—Currently not in use but reserved for future.

FIG. 9b explains the flow of the GMTIC command/message, FIG. 9c explains the flow on the GMTICUL command/message and FIG. 9d explains the flow on how Client 1 sends out a GMTICINVITE and depending on the Client 2 choice GMTICYES (accept) or GMTICNO (reject). Also covers the possibility of a GMTICCANCEL.

FIG. 9e explains the flow of the GMTICCANCEL command/message and FIG. 9f explains the flow on the GMTICEXIT command/message.

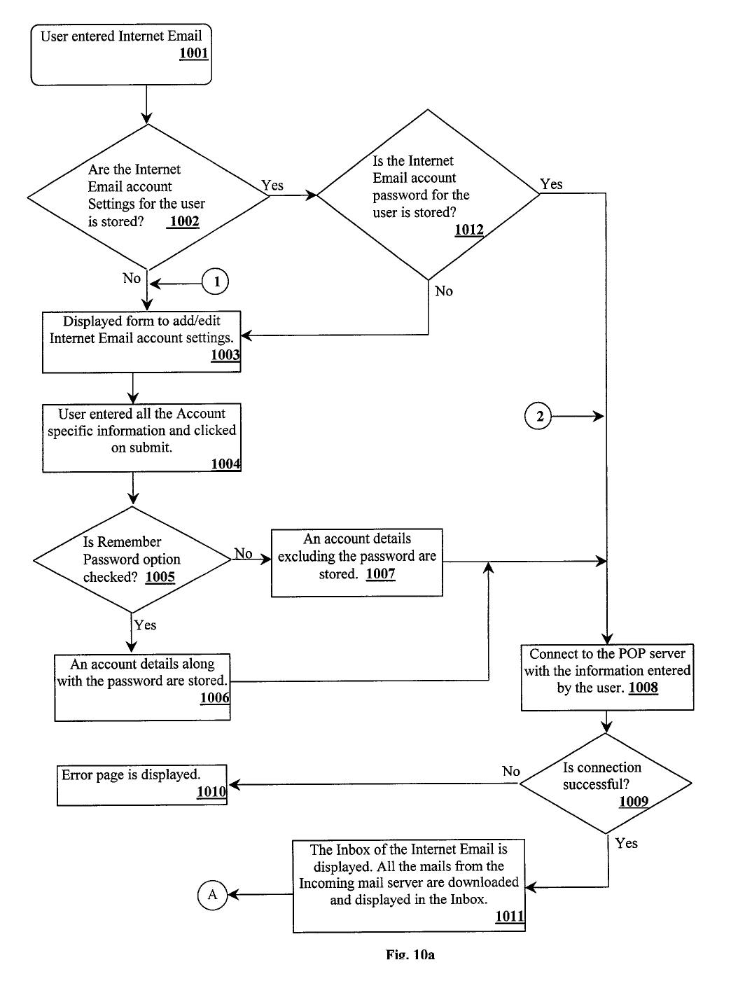

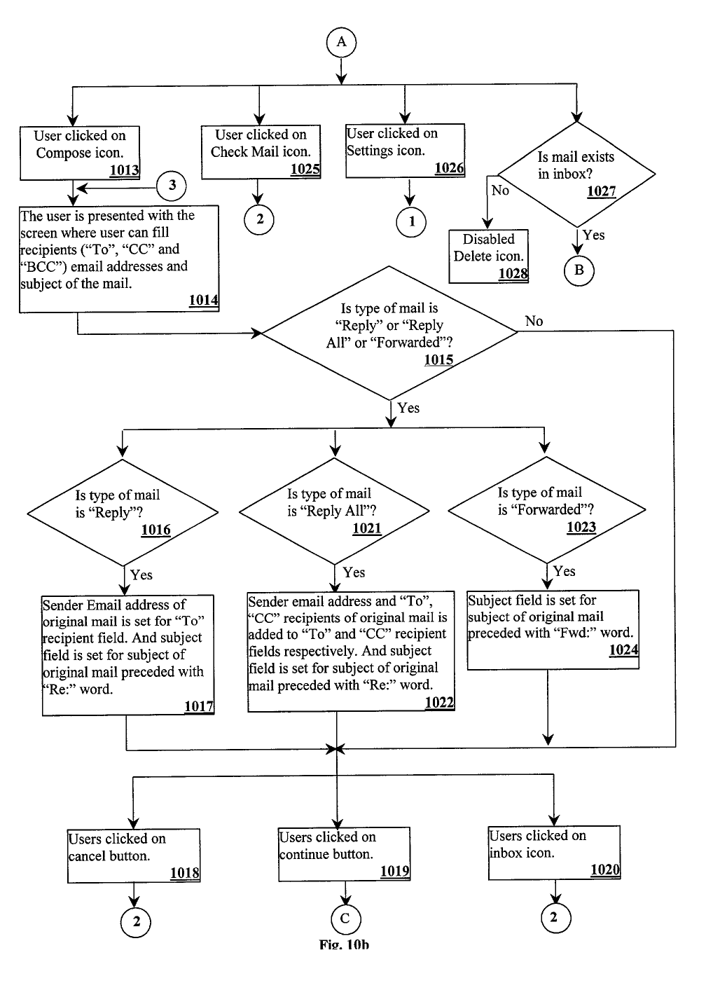

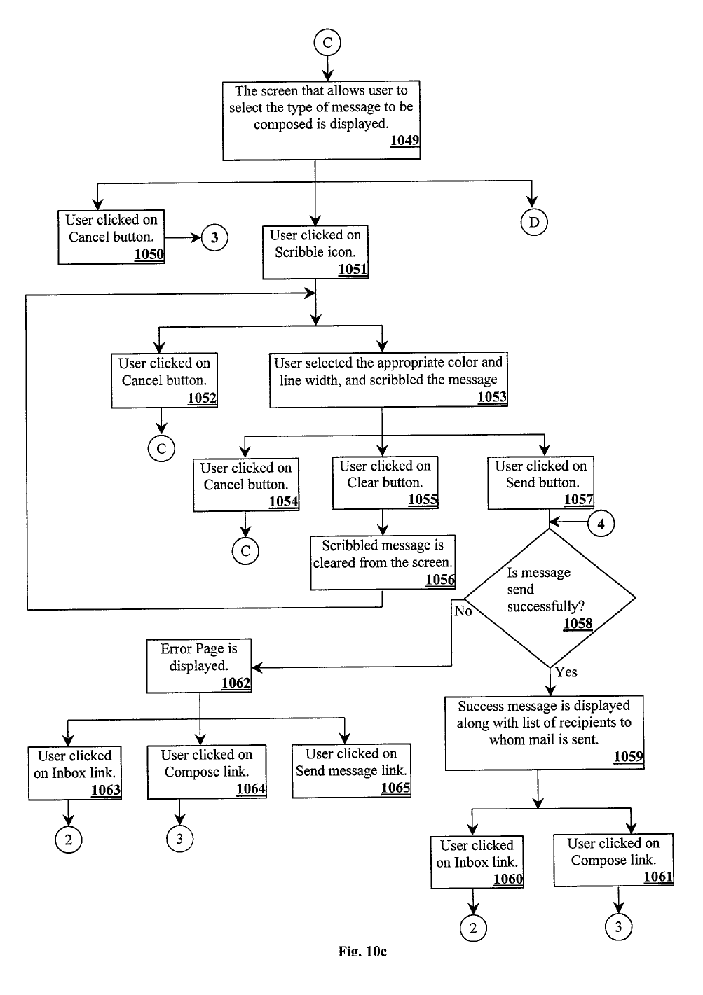

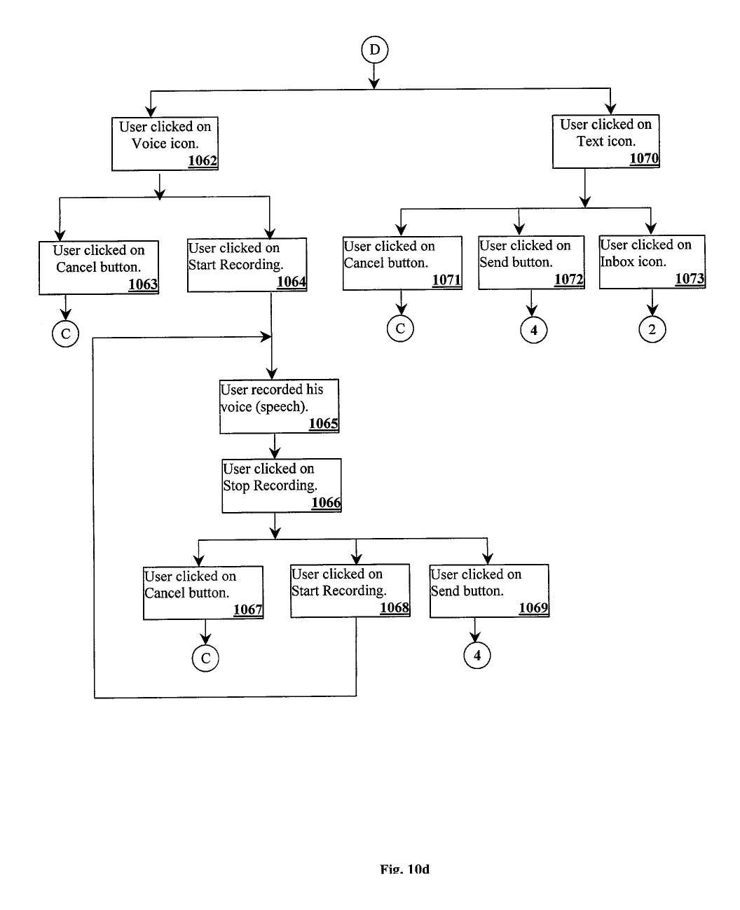

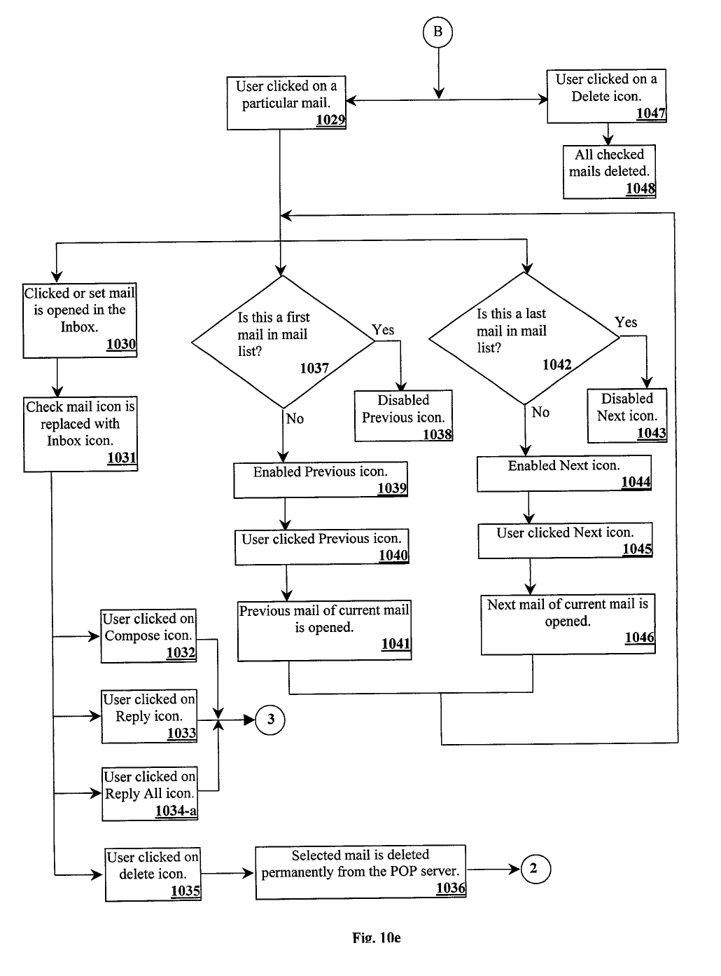

FIG. 10a is a flowchart diagram, which depicts, how the Internet email account settings for user 140 are stored in database 104x. When user 140 clicks Internet Email application 1001, Client 200 checks for the Internet Email account settings for the entered user 140 in database 104x. For user 104x, if account settings do not exists or stored 1002 in database 104x or user have not set the option TRUE to remember the Incoming mail server login password 1012. A form will be displayed to user 140x to add/edit Internet Email account information 1003 in database 104x. Clicking on ‘Submit’ button 1004, all entered information will be posted to database 104x. If user 140 has selected/checked the option “Remember password” 1005 then password along with other account related information will be saved 1006. Or if user 140 has not selected/checked the option “Remember password” 1005 then other account related information excluding password will be saved 1007.

If Internet Email account settings exist and password for POP3 server account password is not available 1012, then user 140 will be redirected to email account setting page to enter valid password. If POP3 server account password is available 1012, then Client 200 will try to connect to specified POP3 server 1008 with given username and password 1008. If successfully connected 1009, then all the mails will be downloaded from POP3 server and will be displayed in the Inbox 1011. If Client 200 failed to connect to POP3 server, then error page will be displayed 1010.

FIG. 10b is a block diagram, which depicts the functionality and icons enabled in Inbox page of Internet Email application 1000. If user clicked on ‘Compose’ icon 1013, a form/screen to accept ‘To’, ‘CC’ and ‘BCC’ recipients and subject of mail, will be displayed 1014 to the user 140. Client 200 checks, if the mail being composed is result of ‘Reply’, ‘Reply All’ or ‘Forwarded’ 1015. If the mail being composed, is result of ‘Reply’ 1016 then Sender email address will be added to ‘To’ recipient field and subject of the original mail preceded with ‘Re’ word will be added to subject field 1017. If the mail being composed, is result of ‘Reply All’ 1021 then Sender email address and ‘To’ recipients of the original mail will be added to ‘To’ recipient field also the users who has been ‘CC’ ed will be added to ‘CC’ recipient field. The subject of the original mail preceded with “Re” word will be added to subject field 1022. If the mail being composed is result of ‘Forward’ 1023 then subject of the original mail preceded with ‘Fwd’ word will be added to subject field 1024. On the compose mail screen, if user clicked on ‘Cancel’ button 1018 then previous page i.e. Inbox page will be displayed 1011. If user clicked on ‘Inbox’ icon 1020, then Inbox page will be displayed 1011. If user clicked on ‘Continue’ button 1019, then a page will be displayed, where user can select the message type in which it will be composed 1049. If user clicks on ‘Check Mail’ icon 1025, Client 200 will check for the mails on POP3 server and will download and displayed them in Inbox 1008. If user 140 clicks on ‘Settings’ icon 1026, a page to edit Internet email account settings will be displayed. If mails exist and successfully downloaded from POP3 mail server 1027 by Client 200, ‘Delete’ icon will be enabled else it will be disabled 1028.

FIG. 10c is a block diagram, which depicts how user 140 can compose the scribble mail/message. If user clicked on ‘Cancel’ button 1050 then previous page will be displayed 1014. If user clicked on ‘Scribble’ icon 1051 then a page/screen will be displayed where user scribble the message for mail. On the same page, if user clicked on ‘Cancel’ button 1052 then previous page will be displayed 1049. User can set the color and width of the line, and scribble the message 1053. If user clicked on ‘Cancel’ button 1054 then message will be cancelled and previous page will be displayed 1049. If user clicked on ‘Clear’ button 1055, scribble message will be erased from the screen 1056. If user clicked on ‘Send’ button 1057 then Client 200 will send the mail using stored SMTP server information for the user 140. If message is send successfully 1058 then page containing the success message and the list of all recipients will be displayed 1059. From here, user 140 can click on Inbox link 1060 and go to Inbox 1008 or user 140 can click on ‘Compose’ link 1061 and go on composing new mail 1014. If the message could not be sent then error page will be displayed 1062. From error page, user 140 can click on Inbox link 1063 and go to Inbox 1008 or user 140 can click on ‘Compose’ link 1064 and go on composing new mail 1014 or user 140 can retry to send the mail again 1065.

FIG. 10d is a block diagram, which depicts how user 140 can send Voice and Text messages. If user 140 clicked on ‘Voice’ icon 1062. The page will be displayed, on same page if user 140 clicked on ‘Cancel’ button 1063 then previous page will be displayed 1014. If user 140 clicked on ‘Start Recording’ button, voice recording will start 1064. User 140 can record his speech 1065. If the user 140 clicked on ‘Stop Recording’ voice recording will stop 1066. If the user clicked on ‘Cancel’ button 1067, user will be redirected to Compose page 1049. If the user 140 again clicked on ‘Start Recording’ 1068 voice recording will start and new speech will be recorded. If the user clicked on ‘Send’ button 1069 then Client 200 will send the mail 1058 using stored SMTP server information for the user 140. If user 140 clicks on ‘Text’ icon 1070, a page will be displayed where user can compose the text message. If user clicks on ‘Cancel’ button 1071 then previous page will be displayed 1014. If user 140 clicks on ‘Inbox’ icon 1073 then inbox page will be displayed 1008. If user clicks on ‘Send’ button 1072 then Client 200 will send the mail 1058 using stored SMTP server information for the user 140.

FIG. 10e is a block diagram, which explains the functionality enabled in Inbox 1008. Inbox page 1008 will display the list of mails downloaded from POP3 server. On clicking ‘Delete’ icon 1047 all the mails, which are selected in Inbox (by checking checkbox for respective mails 1048) will be deleted permanently from POP3 server and Inbox page 1008 will be refreshed. Clicking on particular mail 1029, a mail will open in the Inbox 1030. When mail will open in Inbox 1008, ‘Check mail’ icon will be replaced by ‘Inbox’ icon 1031 and ‘Reply’, ‘Reply All’ and ‘Forward’ icon will be enabled for opened mail. Clicking on ‘Compose’ icon 1032, ‘Reply’ icon 1033, ‘Reply All’ icon 1034-a or ‘Forward’ icon, a page 1049 will be displayed where user 140 can compose a new mail. Or if user clicks on ‘Delete’ icon 1035, opened mail will be deleted permanently 1036 from POP3 server and Inbox page 1008 will be displayed. If opened mail is the first mail in the downloaded mail list 1037, ‘Previous’ icon will be disabled 1038 else it will be enabled 1039 and if user 140 clicks on ‘Previous’ icon 1040, previous mail of opened mail will be displayed 1041. If opened mail is the last mail in the downloaded mail list 1042, ‘Next’ icon will be disabled 1043 else it will be enabled 1044 and if user 140 clicks on ‘Next’ icon 1045, next mail of opened mail will be displayed 1046.

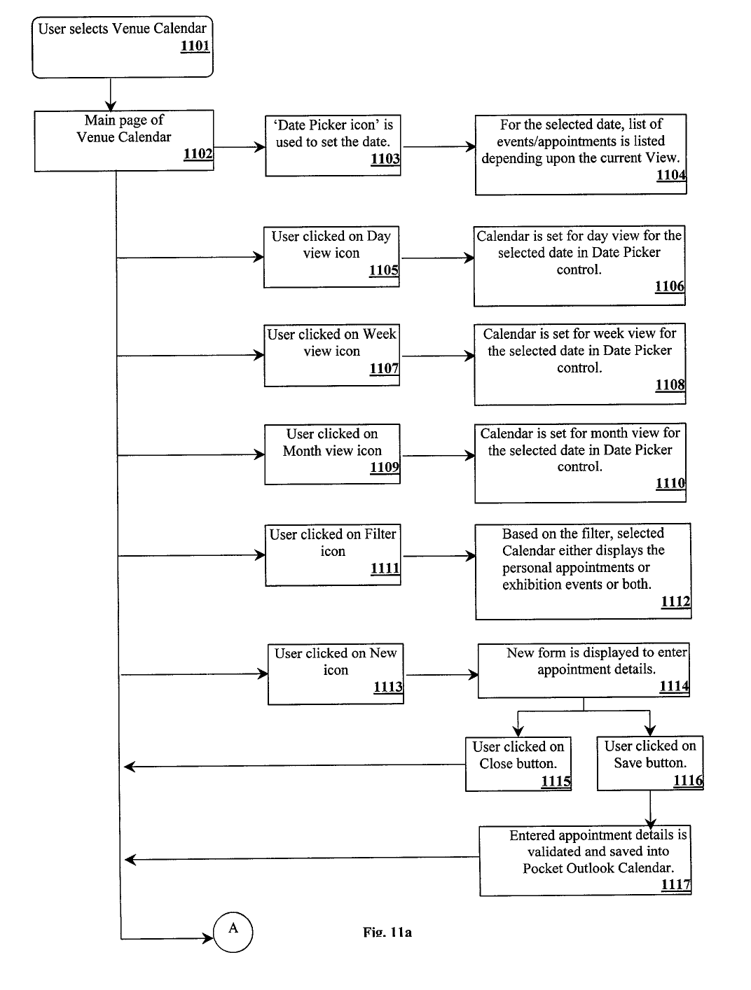

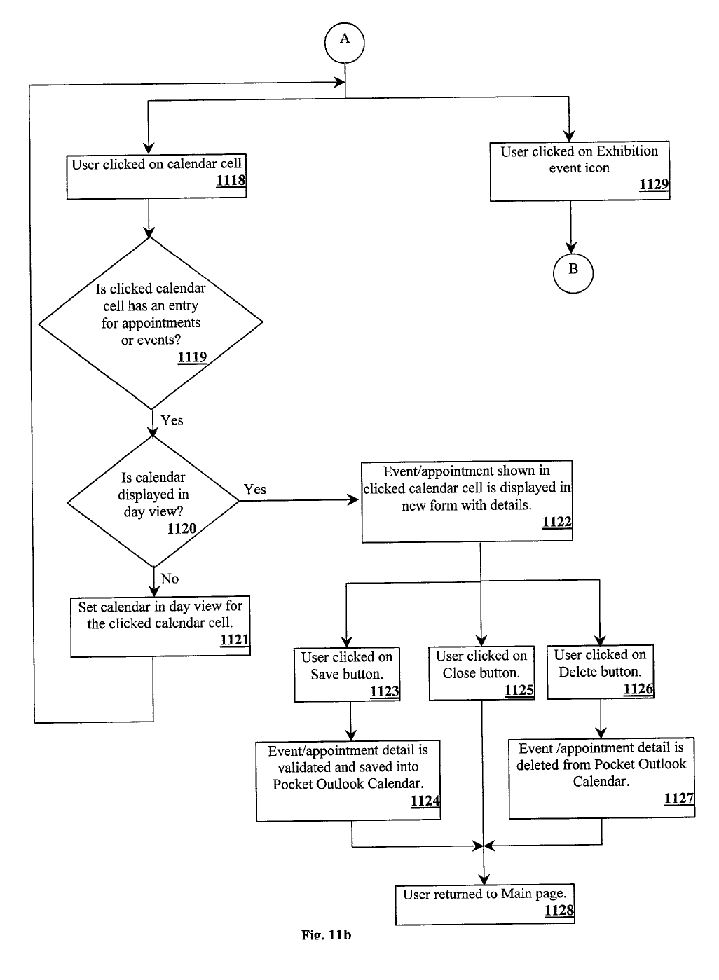

Venue Calendar application 1100 is launched by clicking Venue Calendar icon, and is shown in FIGS. 11a-11c. A User can exit or close the Venue Calendar application by clicking on Exit icon, which sends window message ‘WM_USER+13’ to the system application. When the system application receives ‘WM_USER+13’ window message, it clears/cleans the environment created for Venue Calendar application.

FIG. 11a is a block diagram, which depicts common functions enabled in the main page of Venue Calendar. When the user enters into Venue Calendar 1101, the Main page of Venue Calendar is displayed 1102. When Main page is displayed, the application automatically sends a window message ‘WM_USER+18’ to the parent application to hide the keyboard. Date picker control is provided 1103 which has the option to scroll the date month wise for easy selections, which allows the user to set the date for the calendar 1104. For the selected date Venue Calendar will display appointments and events. Appointments and events are stored into and retrieved from Pocket PC Outlook Database using POOM (Pocket PC Outlook Object Model). When date is changed using Date Picker control, all events and appointments are retrieved for selected date from Pocket PC Outlook database and displayed on Calendar. Calendar is displayed using grid control, when appointment or event is found; the text in the respective cell of grid control is displayed with blue bold color. Clicking on Day view icon 1105 displays the Calendar (grid control) in day view mode 1106. Similarly clicking on Week 1107 and Month 1109 view icons displays the Calendar in week 1108 and month 1110 view modes respectively.

The Filter icon is by default set to display all the events and appointments stored into Pocket PC Outlook database. Filter icon can be clicked (toggled) 1111 to display only exhibition events or personal appointments or both 1112. User can add new appointment using New icon 1113, which opens up the new form to accept appointment details from user 1114. When form is displayed, application automatically sends window message ‘WM_USER+18’ to parent application to show the keyboard. If user clicked on the “Close” button 1115, form gets closed; and, if user clicked “Save” button 1116, appointment detail is validated and saved into Pocket PC Outlook database using POOM 1117. When appointment detail is saved, Calendar is refreshed and displays the newly added appointment.

FIG. 11b is a flowchart diagram, which depicts how existing appointments or events will be displayed in edit or view mode. On clicking Calendar (grid) cell 1118, system checks if any appointment or event entry exists on clicked cell 1119. If entry for appointment/event is found and Calendar is displayed in week or month view mode (1120), Calendar view is changed to day view mode 1121. If Calendar is already in day view mode, it opens up the clicked event/appointment in new form to view or edit 1122. When form is displayed, application automatically sends the window message ‘WM_USER+18’ to parent application which shows the keyboard. If user clicked on ‘Save’ button 1123, appointment detail is validated and saved into Pocket PC Outlook database using POOM 1124 and Main page of Venue Calendar application is displayed 1128. If user clicked on ‘Close’ button 1125, user is returned to Main page 1128. If user clicked on ‘Delete’ button 1126, appointment detail is removed from Pocket PC Outlook database using POOM and Calendar is refreshed.

FIG. 11c is a flowchart diagram, which depicts how exhibitor events are added into and removed from Pocket PC Outlook Database. On clicking ‘Exhibition event’ icon 1129, event list of related exhibition is displayed 1130. When event list is loaded, system checks whether the current event exists in the Pocket PC Outlook Database. If event exists, it is displayed with ‘Add’ image, otherwise it will be displayed with ‘Remove’ image 1131. By default, event list will be displayed for first day of the exhibition. User can view event list for ‘x’ day i.e. 2^{nd}, 3^{rd} by selecting the option from given pull down list 1132. On selection of ‘x’ day from pull down list, event list for that day will be displayed 1133. If user clicked on the ‘Add’ image 1134, confirmation is asked to add clicked event into Pocket PC Outlook Database 1135. Upon confirmation, event will be added into Pocket PC Outlook Database 1136. If user clicked on ‘Close’ button 1137, user will be returned to Main page 1138. If user clicked on ‘Remove’ image 1139, confirmation is asked to remove clicked event from Pocket PC Outlook Database 1140. After confirmation, event will be removed from Pocket PC Outlook Database 1141. Whenever event is added into or removed from Pocket PC Outlook Database, event list of exhibition will be refreshed.

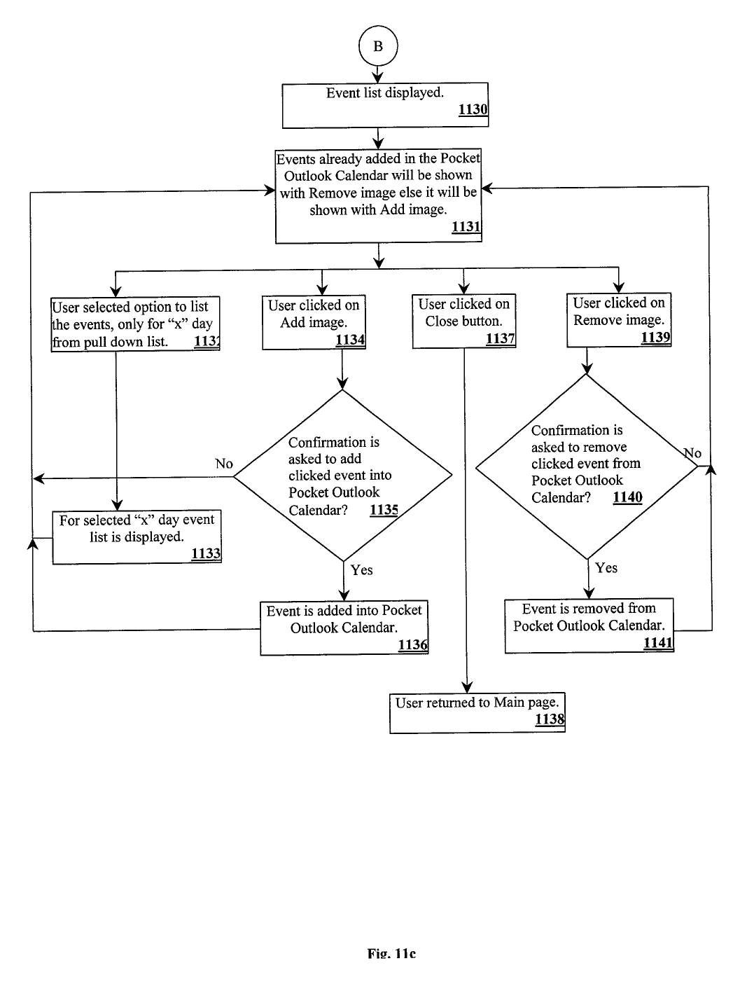

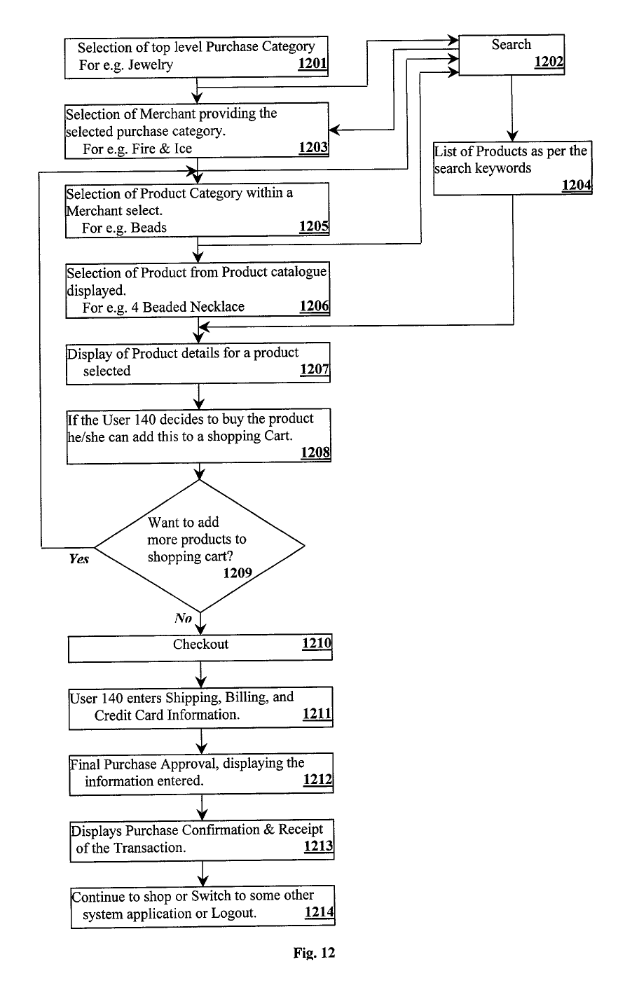

FIG. 12 is a block diagram, explaining the functionality of Venue Commerce. A User can display (1201) the top level ‘Purchase Category,’ e.g. Jewelry. The User can search (1202) the list of products as per the keywords. User selects (1203) ‘Purchase Category’ (Jewelry) and a list of Merchant providing the purchased Category is displayed. After the user selects (1205) the Merchant (Ice & Fire), ‘Product Catalogue’ (Beads) is displayed, and the user can select the product of his choose. Selection (1206) of product (4 Beaded Necklace) can then be done. Details of the product (1207) are displayed along with the Price and Discounted Price. User 140 decides to buy a product (1208), so he can add this to a Shopping Cart. User can buy the product (1209) by completing the transaction or can continue shopping. Displays the Shopping Cart (1210) with number of products, prices and quantity. User can change the quantity of a product. And can also see the total amount to be paid for the transaction. User 140 can also remove the added product from the shopping cart. User 140 enters (1211) Shipping, Billing, and Credit Card Information. Displays the information (1212) entered by the User 140 for the Final Approval. Displays the Purchase Order Conformation and the Receipt of the transaction (1213). User can continue shopping (1214) or Switch to some other system application or Logout.

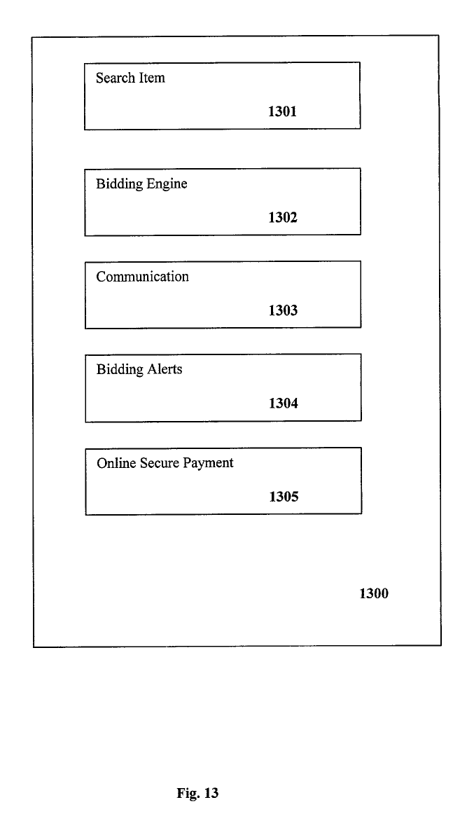

FIG. 13 is a block diagram, showing the functionality of Venue Auction 1300. Venue Auction is unique to the population of visitors at the same venue location. In other words, every venue could have its unique buyer and seller population with their bids on products registered only at that venue location.

The two types users involved in Venue Auction 1300 are Buyers and Sellers. The Seller comes to the website and registers for Venue Auction. After successfully registering, Seller is assigned unique username password. Now the Seller can login into his section and put items for bid. When putting items for bid, Seller is asked to input item name, category in which item is to displayed, brief description of item including its condition and quantity of the item up for bids along with time of start and end of auction. Seller also has an option to include a picture of the product of limited size.

Buyer who is already registered clicks on Venue Auction 1300 in the Client application 200 and is able to search items 1301 based upon category, partial name, items auction time or even on the pricing of the items which are available for auction. When Buyer submits a search, the Online Server 101a parses the database 104a for all the items belonging to that particular view. This is achieved by creating a real time view of the table. This information obtained from the database is then parsed through pre-defined HTML template. The resultant hit page is shown to the user with hits appearing as hyperlinks. The hyperlink is generated from the title of the item entered by the Seller. The page describing the product along with other relevant information displayed when the user clicks on the hit in the hit page.

A special Bidding Engine 1302 works behind the scenes. The bidding engine 1302 manages a new item posted by the Seller. The engine also keeps track of which Buyer has bid for which items as well as how many items are posted by each seller, which auctions are about to close, history of all bids.

Sellers and Buyers can also communicate 1303 with each other using Venue Messenger 600 and Venue Chat 500 module of the Client application 200, thereby enhancing the selling and buying experience for the Seller and Buyer at the local venue. Thus far the only mode of communication available on Internet auction sites is via email, which is a passive way of communication. Using Venue Auction 1300, Seller and Buyer can communicate with each other in real time using Venue Chat 500. Since buyer and seller are both at the same venue, a meeting can be arranged to possibly even meet in person. The mode of communication could either be text, scribble or voice. Using Venue Messenger 600 Seller/Buyer can leave text/scribble/voice message for each other.

Another Venue Auction 1300 feature includes real time Bidding Alerts 1304. Seller can set bidding alerts on various parameters including when an auction for the Seller's item closes, Buyer bids for the Seller's item, a Seller has overbid the price set by the Seller or any other system-related bidding alert. Buyer could receive alerts when Buyer has won the auction, another buyer has overbid for the same item, and the auction on one of the items has closed or is closing. The System Server 101a generates these alerts. These bidding alerts can be sent to an email address, SMS/Internet enabled cell phone or portable communication device running Client application 200.

Online Secure payment 1305 is as described. Once a Buyer has won an auction, the Buyer could pay for the item Online or on the Client application 200 using credit card. Authorize, net, for example, provides API's that enable Client Application 200 to accept secure payment on portable communication device. Once the Buyer fills in the credit card information with other relevant information, these parameters are then passed securely to the System Server 101a. Systems Server 101a passes these parameters to the Authorize.net gateway for validation and securing the amount of the item, which in turn is credited to the Sellers credit card. Similarly, Authorize.net provides secure online web page wherein Buyer could enter the credit card number and other details.

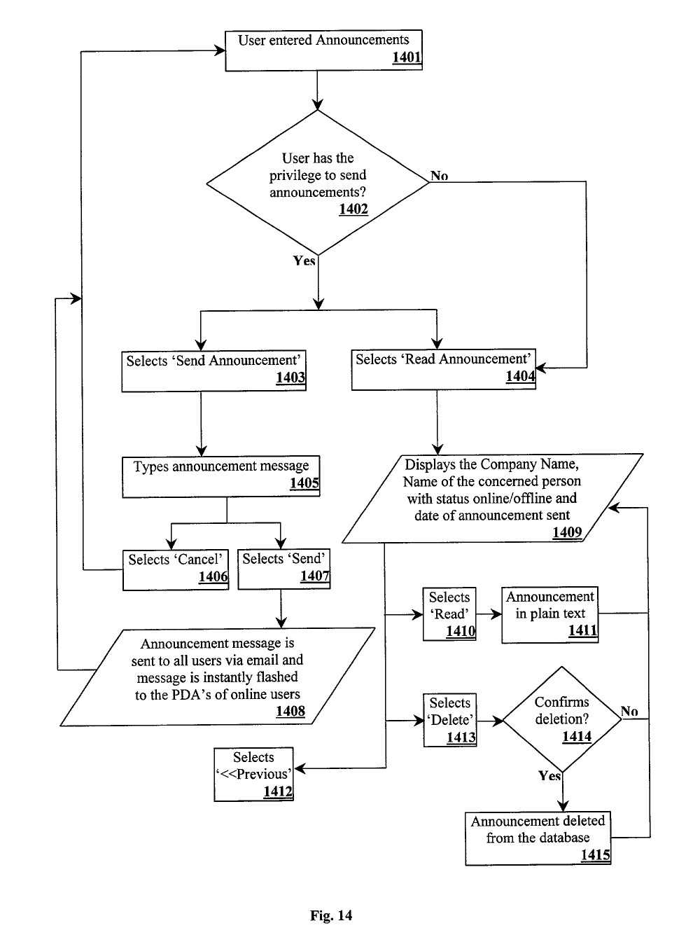

FIG. 14 demonstrates the Venue Announcements. After selecting Venue Announcements 1401, the system checks if the user has privilege to send out an announcement 1402. User 140 sees Main Menu consisting of Read Announcement 1404 and Send Announcement 1403 option. If User 140 taps on the Send Announcement 1403, a new window opens up which allows the user to enter the message he wants to send as an announcement. After the message is entered 1405 and User 140 taps on the send button 1407, the message is sent to the System Server 103x. System Server 103x then checks for all online Users 140 and flashes the messages instantly 1407 on the Device of the User 140 and sends email to all the users registered to the system and who are not online. Optionally, user can also select Cancel button 1406. If the user taps on the Read Announcement 1404, Client 140 displays a window 1409 which shows the list of announcement sent by all the User 140 till date. User 140 has an option of viewing 1407 all announcements one at a time and can delete 1407 the announcement if required. If User 140 taps on Read 1410, the plain text announcement is opened in a new window 1411 that can be closed once it has been read. User 140 can tap on Delete 1413 to delete an announcement after User 140 confirms the deletion 1414, which permanently deletes the announcement form the database 1415. User can click on Previous button 1412 to exit out of the Read module.

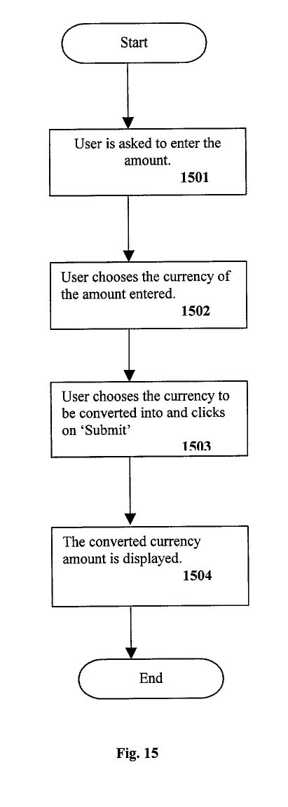

FIG. 15 describes the flow of Currency Converter 1500. When user clicks on Currency Converter 1500 in the Client application 200, the user is asked to input the amount to be converted 1501. The user is then asked to choose the currency 1502 of the amount just entered. In the next step, user chooses the currency in which the amount is to be converted 1503. These parameters are then passed to the Online Server 101a, which in turn gets the unit conversion ratio between the entered currencies. This conversion ratio is obtained real time from systems of reputed banks such as Citibank, Chase Manhattan or any such reputed financial institution. The unit conversion ratio is then applied to the amount entered by the user and amount in desired currency calculated. This amount in the desired currency is then displayed to the user 1504.

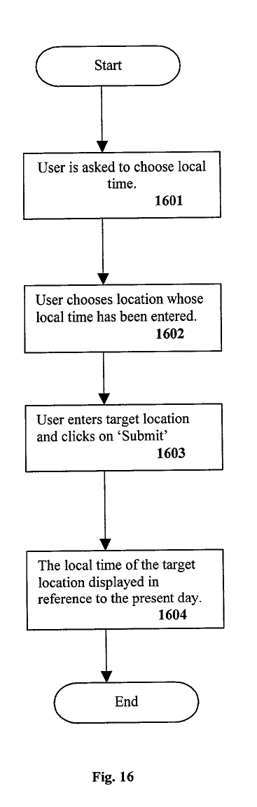

FIG. 16 describes the working of the clock. When user clicks on World Clock 1600 (FIG. 2a), the user is asked to input the time 1601 for which the converted time would be generated. The user is then asked to input the location 1602 of the time the user just entered in 1601. Now, the user enters the target location 1603 for the time is to be determined. These parameters are then passed on the Online Server 101. The System Server 103a obtains from the database 104a the world locations and their local times. Now the current location time is converted in terms of GMT. Now using this information the comparison is made with the target location GMT and local time is thus calculated using the formula and displayed 1604 along with the difference in day to the present day to the user on the portable communication device.

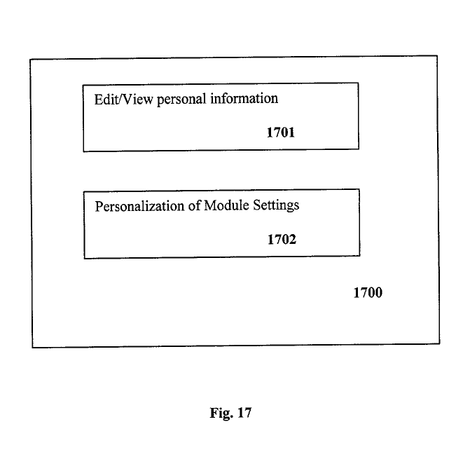

Venue Account 1700 (see FIG. 17) consists of two sub-modules. The first sub-module is Edit/View Personal Information 1701. In this module the user can view/change all the personal information the he had entered at the time of Sign-Up/Rent Process. This information is available on the Client application 200. Once user changes any information, it is sent to the System Server 103a. Systems Server 103a then updates the database 104a record for the user. Editable fields that a user can change are first name (to be anonymous), last name, email address, password, hint question and answer.

The second sub-module in Venue Account 1700 is personalization of module settings 1702. Personalized settings include the user capability to allow/block receiving of Announcement alerts, enabling or not of Venue Messenger 600 Broadcast messages, enabling or not Venue Chat 500 invitation, enabling or not Venue Game 900 invitation. Any one user can show/hide the Venue Match 400 profile to other users. If a user hides his profile, he is rendered “invisible” to the Venue Matching engine/system.

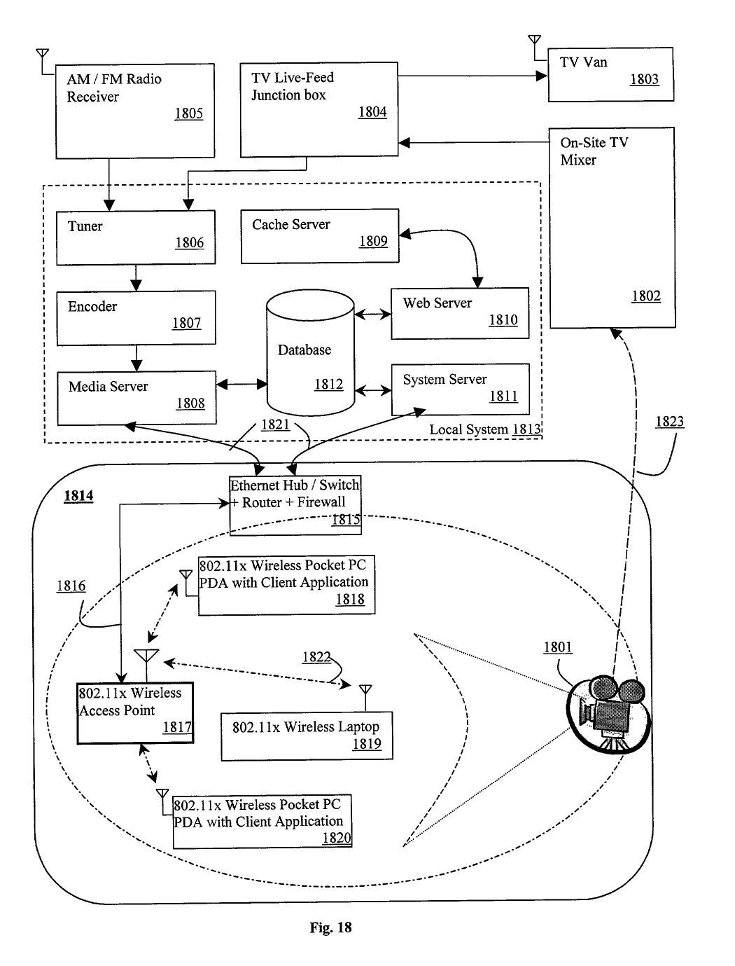

Venue Video (see FIG. 18) allows users at the Venue 1814 to have access to live radio-audio or audio/video 1804, 1805 streams on the Wireless Pocket PC PDA 1818, 1820 or Wireless Laptop 1819. The Radio-Audio feed 1804 is a normal receiver for AM or FM radio input. Example: A spectator 1818 can listen to the commentators on 1010 WINS when a basketball game is in progress at the arena 1814. Similarly at the Venue 1814 the spectator 1818 can see different TV camera angles of TV-Cameras 1801. Sports fans can therefore, in real-time listen to live radio traffic reports or view live TV coverage of the sports or concert event at the venue.

The functionality is implemented as follows: user 1818, 1820, 1819 all have the Client application 200 installed. The TV-Camera 1801 covers the event as it happens. This TV signal 1823 is sent to the On-Site TV Mixer 1802. Similarly many such TV-Cameras are setup at the venue. The On-Site Mixer 1802 now feeds the signal into the TV Live-Feed Junction box 1804. It is at this point that the Local System 1813 taps the final TV signal that typically otherwise is sent to the TV-Van 1803 for being broadcasted on the TV-Network. The drop is taken with help of normal BNC connectors. The BNC Connectors interconnect the Tuner 1806 and the TV Live-Feed Junction Box 1804. The Tuner 1806 can be as simple as a VCR/Tuner or a more professional Tuner system that would be capable to scan different bands (UHF, S-Bands for incoming TV/Cable Signals). The next thing to do is to convert the analog TV-Signal into a Digital Stream that can be streamed to a Pocket PC PDA via the wireless link 1822 from the wireless base station 1817. The wireless base station is wired to the Ethernet HUB/Switch/Router 1815. To make this happen one can use an encoder 1806 card connected to a Windows Media Server 1808. With the help of the Windows Media Encoder and the Windows Media Server 1808 provided by MICROSOFT, one can be able to fine-tune, optimize the digital output signal 1821 and set various properties (Bit Rate, Window Size, Duration, etc) or even record onto the hard-disk 1812 for replay or archiving purposes. The Media Server 1808 uses standard streaming technologies accepted on the Internet such as MMS over TCP/IP. One typically sees the Windows Media Server 1808 running in unicast-mode, but the system can be changed to have multi-casting features as well in the future. The end user 1818, 1820 has an embedded Windows Media Player Client provided by MICROSOFT. So like this, one can effectively use the Network Bandwidth provided by the wireless 802.11x networks. Typically, if a user has an excellent signal strength/signal quality then the user can get throughput of 11 MBps which is more than sufficient for Video/Audio streaming. The Local system 1813 is configured for optimal wireless streaming, keeping in mind the restriction of these mobile devices 1818, 1819.

Other blocks 1811 seen in the figure are required for authentication for the Client Module Application 200 and management of the streaming feeds to specific users. Cache Server 1809 is used in conjunction with the Web Server 1810.

FIG. 19 demonstrates the ‘PDA Settings’ Module. PDA Settings module provides information about the device, where Client 200 is installed. It provides five different types of settings/information i.e. ‘Volume Control’ 1902, ‘PDA Information’ 1905, ‘Backlight’ 1907, ‘Network Status’ 1909 and ‘Power’ 1911. ‘Volume Control’ 1902 shows the current volume level and allows User 140 to change the volume level 1903 as required. When clicked on Previous 1913, it closes the Volume Control 1904. Client 200 uses GetSystemPowerStatus API, which provides the status of the ‘Battery Power’ 1911. ‘PDA Information’ 1905 shows the Device specific information 1906, like Manufacturer's name, Device ID, Owner name etc. Client 200 uses Compaq API to extract the information and show the same in HTML format in HTML control. ‘Network Status’ 1909 provides the status of or traffic on the network 1910, like if the network traffic is high or low. Client 200 uses Ping utility to check the network. If ping takes more time to ping the System Server 103x, that means that the network traffic is high and vice versa. ‘Backlight Settings’ 1907 shows the current ‘Back light Settings’ 1907 of the Device and also allows User 140 to change the settings 1908 as required. It shows 6 levels of settings i.e. Automatic, Super bright, High bright, Medium bright, Low bright and Power save. User 140 is allowed to choose any one of these levels. Client 200 uses Compaq API to access as well as set the new settings of the ‘Backlight’ 1907. ‘Power’ 1911 displays battery power, both internal as well as external 1912.

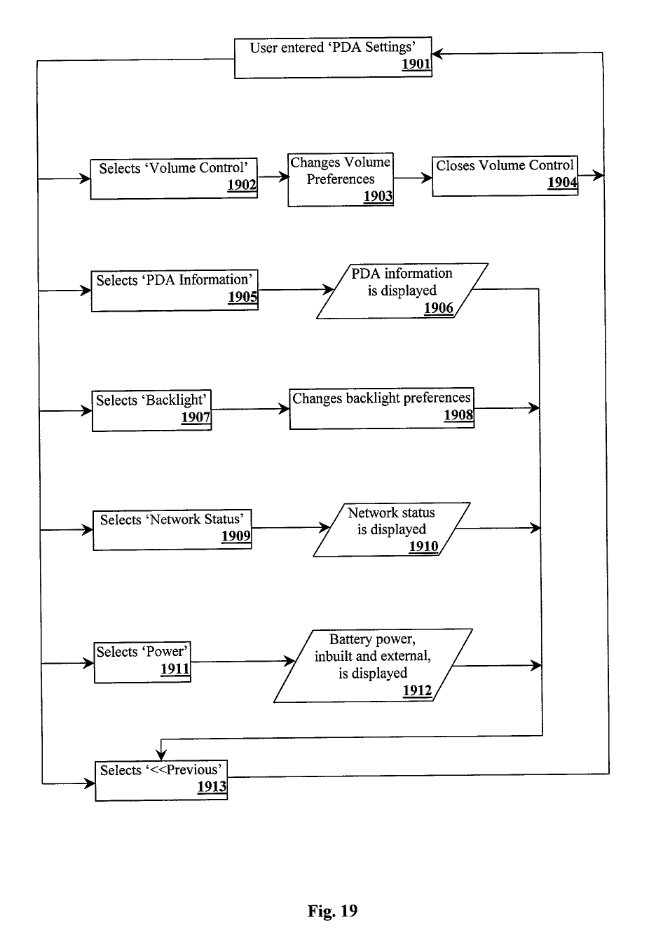

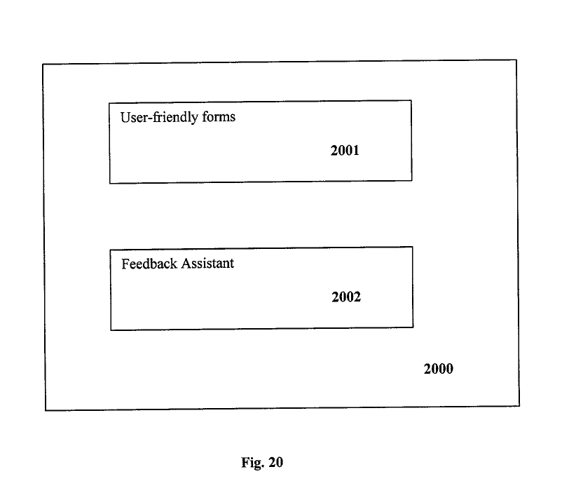

Venue Feedback 2000 (see FIG. 20) consists of user-friendly forms 2001 that capture the feedback from the user about the service offered to them at the venue, their suggestions and complaints. The feedback forms contains a set of pre-defined questions for the specific venues. Once the user clicks on ‘Finish’ button, the contents of the all the sub-forms are then validated for each field. If any field fails validation, for example use of ‘−’ or alphabets in “Age” field, then the user is prompted to enter correct value for the field and the screen shows the user the invalid field which is now highlighted for easy viewing. Once the form passes validation, the information is grouped together and sent to the Java Socket Server. Java Socket Server parses the information from the Feedback forms and runs the SQL command to insert the information into the database. This SQL command in turn calls the insert procedure for that particular table and runs it, thus saving the information in the database 104a. Once the Java Socket Server receives the success prompt, it emails the feedback information to the Venue-Site Admin using the ASP Mail component of the Systems Server 103a.

A Feedback Assistant 2002 is also available to users in this module that better informs the user about each field that user needs to fill. For portable communication devices such as PDA/Pocket PCs, the Feedback Assistant 2002 is developed in JavaScript/Jscript. Once the user clicks on a small “?” (Question mark) next to the field, a small JavaScript box appears besides the field without in any way hindering the view of the field. This JavaScript box contains a one-line explanation of the field as well as an example for the field along with possible values that cannot be entered in the field such as ‘.’, ‘=’ or any other value depending on the field.

The system functionality called Venue Builder 2100 gives the venue owner the capability to build their venue portal information based on some pre-defined templates. A new venue portal can be built in one of 3 ways: (1) Re-directing the venue portal icon within the server software to an existing WEB site URL address without any modifications as authorized by the venue owner or (2) Re-directing the existing Web site URL address of the venue owner to the wireless content transformation engine within the server software or (3) by using Venue Builder where venue owners can design their venue portal look-and-feel by selecting from pre-defined templates and adding text, graphics and other content.

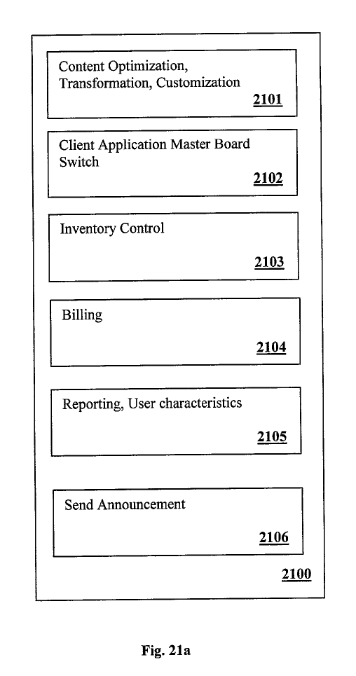

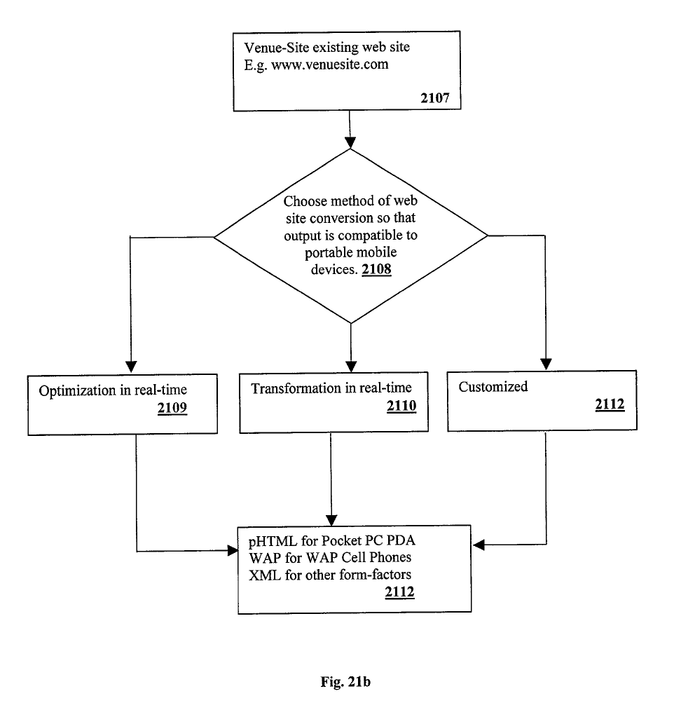

FIG. 21a is a block diagram of the various components of the Venue Builder 2100. FIG. 21b explains the three ways that the existing web site of a venue-site can be converted so that it can be viewed on a Pocket PC PDA or a WAP enabled Cell Phone.

Venue-Builder 2100 allows the Venue Administrator (point of contact person, or administrator who represents the Venue-Site/Location) to have control of various aspects of the system. The Venue-Builder allows the Venue-Admin to switch ON or OFF various software toggle switches that help customize different screens, behavior of the overall system on a venue-specific basis.

If a user submits a company web site 2107 hyperlink into a Pocket PC PDA browser or a WAP Browser, the web site pages will appear messy and almost impossible to navigate since most existing sites were built and optimized for desktop or Windows terminal viewing. A Desktop has various advantages over a Pocket PC PDA such as large screen, high-speed processor, high-color resolution, more memory space, etc. Venue Builder 2100 fixes this problem by allowing the Venue-Admin three choices 2108 for conversion of the company web site so that it is readable, clearer, meaningful for users when seen on a Pocket PC PDA browser or WAP browser on a Cell phone.

The three choices are Content Optimization in real-time 2109, Transformation in real-time 2110 (after a page by page analysis and heuristic rules are established for web page by page rendering) and manual customization 2111 of the web site. For Content Optimization in real-time 2109 the CISCO Content Optimization Engine is used. With its best heuristics algorithm it converts the web site automatically so that it is viewable 2112 on a Pocket PC PDA or Mobile Browser. Example: if the web site CNN.com is opened inside the Pocket PC Internet Explorer without Content Optimization, then it will appear distorted (the web site is unreadable, information is scattered due to the minimal screen size, horizontal scrollbar is enabled, it becomes difficult for the user to navigate). Now, if the same web site CNN.com is seen keeping the Content Optimization engine 2109 in between CNN.com and the Pocket PC Internet Explorer, then the engine optimizes the Content so that it is re-arranged in a vertical fashion. This is implemented when the optimization engine actually parses the HTML of the web site on the fly and then spits out a version 2112 that has got all the data in a vertical orientation. Still, since this is a best heuristics program and there is no human-intervention, it is not perfect and many a times the data does not appear properly. This is where the second choice called Content Transformation 2110 can be used by the Venue-Admin. For Content Transformation 2110 one can use the CISCO Content Transformation Engine or the IBM Transcoding Publisher or similar transformation engines. The difference here is that the Venue-Admin can create skeletal references to the structure of the web site. So with this human intervention the engine spits out pages 2112 that are perfect. Example: The same web site CNN.com can be transformed onto the Pocket PC Browser such that only the Headline News hyperlinks and the CNN News LOGO appear. All other data/html tags are just deleted or bypassed. This helps throughput, so that on a wireless device, the page loading time on the client device will improve drastically. The third and final option is that the Venue-Admin can build the content pages manually 2111. For this the system allows a tool similar to MICROSOFT FrontPage or MACROMEDIA DREAMWEAVER, the difference being that this is for a Pocket PC/WAP Cell phone whereas former are currently available only for the Desktop/laptop environment.

Venue Builder has a Client Application Master Board 2102. It allows the Venue-Admin to add/edit/delete information that appears in various client modules such as the Events inside Venue Calendar, the default rooms inside Public Chat, the hyperlink used for the Venue Portal, different colors in the final user interface, disable a specific module, etc.

Venue Builder has a basic Inventory module 2103, billing module 2104 that allows maintaining inventory and online credit card payment to subscribers at the venue. Extra costs to users for software and renting of devices (Pocket PC PDAs, Wireless LAN equipment such as a PC Card Expansion Jacket, PC Card, CF Card Expansion Jacket, CF Card).

Venue Builder has a Reporting module 2105 that gives various Reports. Example: Detailed user movement inside the Client Modules. How many users clicked on the discount coupon that was offered in the Venue Portal Section? When is the time of the day that more users are using Internet Email module? How the system does the data mining is that it stores all interactions between the Online Server/Local Server and the Client Application. This data is stored in an XML file or an RDBMS ODBC compliant database.

Venue Builder has a communications module called “Send announcement” 2106. This feature allows the Venue-Admin to send out multi-modal (text, scribble, voice) announcements to users at the venue in real-time. Example: At a City Tourist Attraction before a rock-band performs on the stage all users get a message that the show is just about to start in 20 minutes and the first 50 people to reach the stage will get a free T-Shirt.

Venue Builder allows this real-time communications environment because it is closely tied to the System Server that is responsible to send and archive messages of the Venue Messenger module. See FIG. 6 for more details about Venue Messenger. Also see FIG. 14 to get more details on how the users receive these announcements.

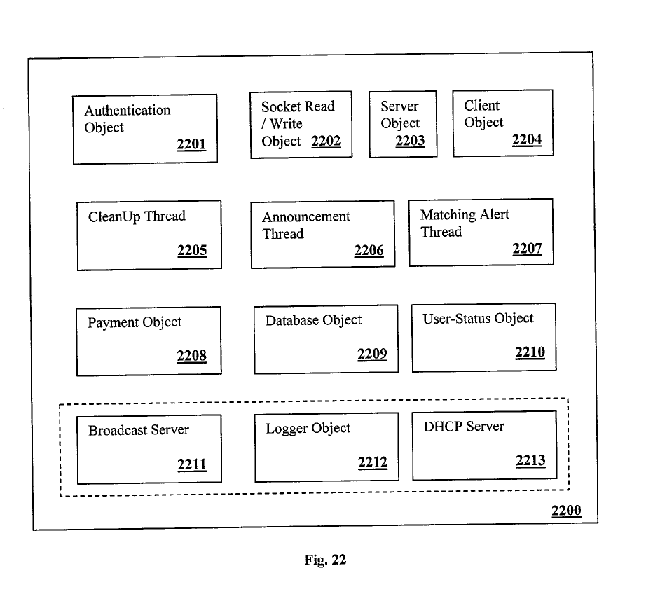

FIG. 22 illustrates all the sub-components of the Server System 2200. The Server System 2200 is the heart of the whole architecture and maintains all messaging between the Client devices (Pocket PC PDA or BREW enabled Cell Phones or J2ME enabled Cell Phone). The Server System 2200 contains all the Business Logic components that determine the behavior of all the client application modules. The application protocol is explained in detail later.

The Authentication Object 2201 is responsible for authenticating clients (Pocket PC-PDA, BREW Enabled Cell Phones, Desktop/Laptops).

The Socket Read/Write Object 2202 is one of the most important parts of the System Server 2200. It is responsible for parsing all messages coming from the client and then running appropriate action against that message. In other words it contains most of the business logic. The Server Object 2203 is a TCPIP Socket Server that is listening on a predefined port (default 8001). The Socket Object is responsible for accepting incoming socket connections. The Server Socket object uses Non-Blocking sockets that increase the number of client sockets per server socket channel. This methodology is more efficient and requires comparatively less memory and processor cycles. This whole technology is based on PUSH algorithm, connection-oriented, state-full and hence is very efficient when compared to the normal POLL algorithm of a web-browser HTTP based connection-less, states-less socket.

The Client Object 2204 is responsible for coordinating all client related messages. Example: SYSNEW this is a message that comes from the client socket, now the Client Object 2204 using the Database Object 2209 and the User-Status Object 2210 checks if any online users have the same Name/Alias.

The CleanUp Thread 2205 in-conjunction with the User-Status Object 2210 maintains the Online/Offline status for all users logged into the System. There are two ways in which the user status changes, a) The user officially logs-out and b) the user just powers off the device or loses the connection to the Server due to bad wireless connection. In the latter case the status is always up-to-date. The second part is achieved as the Client Object maintains a FLAG for each user. After a fixed period of time an online Client updates the Flag to “1”. Now, after a synchronized interval the User-Status Object updates the Flag to “0”. If the flag is not automatically set to “1” by the online client, what it means is that the user is not online altogether. So in this way all users who have not logged out explicitly are also offline. The User-Status Object 2210 is also referenced by Client Object 2204 and Socket Read/Write Thread 2202 to check status for various modules such as Venue Messenger, Venue Chat, Venue Games, etc.

The Announcement Thread 2206 checks the queue of announcements to be sent out and the delivery method. The queue list and information about personalized settings of the user is obtained from the Database using the Database Object 2209. The different delivery modes are Email, SMS and Venue Messenger text message (on-logon pop-up). The Email is sent out using the native Email Engine. (Example: Java Mail object available from SUN). The SMS message is sent to SMS enabled Cell Phones using a SMS ISP such as SIMPLEWIRE. The System is inter-connected to the SMS ISP using a Java SDK.

The Matching Alert Thread 2207 checks the queue of alerts to be sent out and the delivery method. The queue list and information about personalized settings of the user is obtained from the Database using the Database Object 2209. The different delivery modes are Email, SMS and Venue Match Messenger text message, Scribble or Voice Message (on-logon pop-up). The Email is sent out using the native Email Engine. (Example: Java Mail object available from SUN). The SMS message is sent to SMS enabled Cell Phones using a SMS ISP such as SIMPLEWIRE. The System is inter-connected to the SMS ISP using a Java SDK. The Venue Match Messenger messages are sent out using the Venue Messenger module explained in FIG. 6.

The Payment Object 2208 is responsible for Secure SSL enabled Online Credit Card transactions over the Internet. The Payment Object 2208 understands the payment protocol from a Payment Gateway (such as AUTHORIZE.NET).

The Broadcast Engine 2211 and the DHCP Server 2213 both are functions that are specific to the Local Server. This is a case when the System Server is not run from the Internet, but is running on the Intranet of the Wireless LAN enabled Venue. The Broadcast Engine 2211 acts as a beacon and broadcasts the “Venue Name” (Example: “South Street Seaport”) or “Location (ZIP CODE=10019)” to each and every Pocket PC-PDA coming onto the TCP/IP network. The advantage of doing this is that the user now does not have to choose the Venue-Site from the drop-down list on the login-page, but the user's device is automatically made aware of the users location physically. The DHCP Server 2213 is responsible to assign an IP Address and related parameters so that the device can access the Internet via the Wireless LAN at the Venue.

The Logger Object 2212 is optional service that can be run inside the System Server 2200. It can be set in three modes ALL, SEVERE, INFO. Depending upon the mode it will log all events/messages/errors between clients and the System Server. The Logging is recorded either in a XML file or an ODBC Compliant database for data-mining or user-tracing purposes.

The Messaging protocol used by the Socket Server (2202, 2203) is designed such that only 11 characters can be passed as Message Header. The Message header is further broken into two parts. First part for User Identification with three characters identifying type of message for example: “TXTROBINSON” wherein first three characters “TXT” represents the type of message (INK or WAV) and next 8 characters “ROBINSON” is the actual Name/Alias to whom message is sent. Now in Chat box Client 200 ignores the first three characters i.e. “TXT” and displays the remaining 8 characters i.e. “ROBINSON”. Hence message displayed inside the Venue Chat Box is “Robinson says” followed by the actual text/voice/scribble message.

The reason to keep 11 characters as Message Header's first part is the maximum limit for Login ID and Name/Alias is only 8 characters and it was decided that Message Header type will be 3 characters long i.e. TXT, INK, WAV and SYS etc.

Communication between client and message: Each and every message from Client Application to Server and Server to Client Application is sent in following three parts:

1. Message Type: This is 11 bytes long (in other words it can have only 11 characters). For example: “TXTJASPREET”. Blank spaces is included if it is less than 11 characters For example “TXTANUP”.

2. Message Size: This is 8 bytes long and includes the actual size of the message For example: “24”

3. Message includes the actual message of length specified in the second part of message. For example: “This is a sample message”

If in all the three message parts (in technical term packets) the length is specified i.e. First Server has to receive only 11 bytes (First Part) from the client and then 8 bytes (Second Part) and then number of bytes as specified in the second part of the messages (Third Part), Server also sends messages to client in same way. By doing this it is made certain that no data will be lost and technically it is very helpful because here Server knows how much data it has to receive from the client and client knows how much data he has to receive from the Server. Specially while receiving INK and WAV data (in binary format), no chance of data corruption.

List of commands/messages that are from the protocol

Message from client to server is represent by C:S

Message from server to client is represent by S:C

SYSSIGNUP(C:S S:C)—This command is sent by the Client Application 200 to the System Server 103x for handling the client's registration. The System Server 200 passes the data to Database Server 104x and on successful registration responds with either a SUCCESS or FAILURE message.

SYSLOGIN (C:S S:C)—This command is sent by the Client Application 200 to the System Server 103x for authentication. The System Server 103x after retrieving and matching the password with the Database Server 104x responds with either a SUCCESS or FAILURE message

SYSEXIT (C:S)—This command is sent by the Client Application 200 to the System Server 103x when the User 140x clicks on the “log off” button. Also in one case, the command is sent from the CleanUp Object to the Server Object.

SYSPASSWORD(C:S S:C)—This command is sent by the Client application 200 to the System Server 103x when the User 140x clicks on the “Forgot Password” button. The client application 200 forms the query to be executed on the database server 104x and the System Server 103x executes the query on the database server 104x and returns the result to the client application 200.

SYSVENUEACC(C:S S:C)—This command is sent by the Client application 200 to the System Server 103x when the user taps on the “MyVenueAccount” icon on the main menu page. The System Server 103x uses the procedure “MyVenueAccountProc” and returns the specified user's preferences back to the client application 200.

SYSNEW(C:S S:C)—This command is sent by the Client application 200 to the System Server 103x when the User 140x enters his selected chat nick name and clicks on “Next” button. To execute this command, System Server 103x first checks if that selected name is already been taken by another user in the system. If yes, the System Server 103x sends error message to the client application 200 by sending “0” in response, otherwise it sends complete room list with the number of users in each room using the stored procedure “RoomsListProc”.

SYSCREATE(C:S S:C)—This command is sent by the Client Application 200 to the System Server 103x when the User 140x taps on the “Create Room” option button. To execute this command, System Server 103x first checks if that selected room name is already been taken in the system through the SQL stored procedure “CreateRoomProc”. If the procedure result is FAILURE then System Server 103x sends error message (SYSERROR) to the Client application 200 by sending appropriate message in response, otherwise if the procedure result is SUCCESS, it sends complete room list to all the online users.

SYSENTER(C:S S:C)—This command is sent by the Client Application 200 to the System Server 103x when the User 140x selects any particular room and clicks on “Enter Room” button. To execute this command, System Server 103x first makes the entry of user id into the room into which he has entered and sends complete room list to all the online users and sends a Success command to the user who has entered into the room.

SYSUSERLIST(C:S S:C)—This command is sent by the Client Application 200 to the System Server 103x when the User 140x clicks on the “Private Chat” icon after entering a particular room. To execute this command the System Server 103x uses the SQL stored procedure “RoomUserListProc” and then returns the complete user list for the specified room to the Client Application 200.

SYSPUBLIC(C:S—This command is sent by the Client Application 200 to the System Server 103x when the user clicks on the “Public Chat” icon after entering a room. System Server changes the specified user id's mode to Public and Broadcasts specified user's entry into the specified room to all the other users in the same room.

SYSROOMEXIT(C:S)—This command is sent by the Client Application to the System Server when the user clicks on “Exit Room” button. The System Server first removes the specified user id against the specified room id and sends the broadcast to the user's exit message to all the online users in the specified room. The System Server also sent the room list to all the online users.

SYSEXITMODE(C:S S:C)—This command is sent by the Client Application to the System Server when user chooses to exit from the chat session. To execute this command, for Public Chat Exit, System Server first updates the exiter's mode from PUBLIC to ONLINE mode and sends the user list to all the online users. For Private Chat, System Server first checks that the other user in the chat room has not exited yet. If not, then only exit message is sent to the other user in the chat room else nothing. But in both the cases exiter's chat mode changes from PRIVATE to ONLINE.

SYSVMINSERT(C:S)—This command is sent by the Client Application 200 to the System Server 103x updating or inserting any data into the database 104x through the already formatted SQL query.

SYSPMP(C:S S:C)—This command is sent by the Client Application 200 to the System Server 103x to initiate the private chat process. First System Server 103x checks to see if the User 140a and the User 140b are in the same room. If “YES,” then the invitation is sent to the User 140x and the status of both the chatting users is set to “BUSY” and the user list is sent to the online users indicating that the above mentioned (i.e. User 140a and User 140b) are busy in the specific room on the room user list page. If “NO”(i.e. User 140a and User 140b not in the same room), then the command is SYSPMPNO and message is sent back to the User 140a that the chat cannot be started as the User 140b has already left the room. If the User 140b status is checked to be Offline, then that offline status is indicated to the User 140a. Thereafter the User's 140a status is changed from “BUSY” and the User 140b is logged out of the system. The room user list is again sent to the User 140a indicating that his status as free and the User 140b being offline.

SYSVMPMP(C:S S:C)—This command is sent by the Client Application 200 to the System Server 103x to initiate the private chat process through the Venue Match module. For the remaining explanation for this command refer to command SYSPMP.

SYSPMPYES(C:S S:C)—This command is sent by the Client application 200 to the System Serve 103x to accept the chat invitation. In response System Serve 103x verifies for the user 140a and User 140b online/chat status from the database 104x. If user 140a and User 140b both are Online, System Server 103x sends a welcome message to the both the users followed by another message command SYSPMPCLOSE which indicates to both User 140a and User 140b that the chat session has started.

SYSVMPMPYES(C:S S:C)—This command is sent by the Client Application 200 to the System Server 103x to accept the chat invitation through the Venue Match module. For the remaining explanation for this command refer to command SYSPMPYES.

SYSPMPNO(C:S S:C)—This command is sent by the Client application 200 to the System Server 103x to reject the chat invitation. In response System Server 103x verifies that the user 140x has not cancelled the chat invitation. If user 140a has not cancelled the chat invitation, System Server 103x sends FAILURE to the User 140x through another message command SYSPMPCLOSE which indicates that User 140b has cancelled the chat invitation.

SYSVMPMPNO(C:S S:C)—This command is sent by the Client Application 200 to the System Server 103x to reject the chat invitation through the Venue Match module. For the remaining explanation for this command refer to command SYSPMPNO.

SYSPMPCLOSE(C:S)—This command is sent by the Client Application 200 to the System Server 103x to cancel the chat invitation which is initiated by the User 140a itself.

SYSPATH(C:S S:C)—This command is sent by the Client Application 200 to the System Server 103x requesting the path of the various venue services. The System Server 103x reads all the paths from the file and sends the paths back to the Client Application 200.

SYSMATCH(C:S S:C)—This command is sent by the Client Application 200 to the System Server 103x for checking if the User 104x has a Social Profile or a Business Profile or both. The System Server 103x uses the SQL procedure “HandleMatchProc” from the database 104x and returns the type of profile and the specified search criteria back to the User 140x.

SYSPROFILE(C:S S:C)—This command is sent by the Client Application 200 to the System Server 103x. To add a new profile or edit an existing profile into the system as well as to send Match alerts. The System server 103x inserts the profile into the database 104x and the match engine is started which adds the matched ids against the User 140x. An Email and an SMS is sent to all the newly matched id s against the User 140x newly created profile.

SYSVMPRO(C:S S:C)—This command is sent by the Client Application 200 to the System Server 103x to edit User 140x's profile when the User 140x taps on the “Edit Profile” button. The System Server inserts the edited profile into the database 104x and returns Success if the profile is inserted successfully else Failure to the client application 200.

SYSVMSELECT(C:S S:C)—This command is sent by the Client Application 200 to the System Server 103x to view User 140x's profile when the User 140x taps on the “View Profile” button. The System Server queries into the database 104x and returns Success if the profile is retrieved successfully or Failure to the client application 200 if the profile is not retrieved.

SYSVMSEARCH(C:S S:C)—This command is sent by the Client Application 200 to the System Server 103x when the User 140x taps on the “Continue” button after entering his criteria. The System Server queries the database 104x and returns the command “SYSVMSEARCH” to the client application 200 for the matched ids found against the User 140x's profile.

SYSCRIDELETE(C:S)—This command is sent by the Client Application 200 to the System Server 103x to delete User 140x's profile when the User 140x taps on the “Delete Criteria” button. The System Server deletes the selected User 140x's criteria from the database 104x.

SYSADDMATCH(C:S S:C)—This command is sent by the Client Application 200 to the System Server 103x when User 140a selects User 140b to add to his matched list. The System Server adds the matched profile of the User 140b against the User 140a into the database 104x and returns Success if the match is added successfully or Failure to the client application 200 if the match is not added.

SYSRMVMATCH(C:S S:C)—This command is sent by the Client Application 200 to the System Server 103x when User 140a selects User 140b to remove from his matched list by using “RemoveMyMatch” option. The System Server removes the matched profile of the User 140b against the User 140a from the database 104x and returns Success if the match is removed successfully or Failure to the client application 200 is not removed.

SYSMYMATCH(C:S S:C)—This command is sent by the Client Application 200 to the System Server 103x when User 140a selects “MyMatches” option. The System Server queries into the database 104x and returns Success if the matches are retrieved successfully or Failure to the client application 200 if not retrieved. The matches returned are either manually searched matches or Venue Match Engine generated matches depending on the mode passed by the Client Application 200.

SYSMSNGER(C:S S:C) This command is sent by the Client Application 200 to the System Server 103x The System Server 103x returns the number of new Match/Messenger messages back to the client application 200.

SYSMSNCOMP(C:S S:C)—This command is sent by the Client Application 200 to the System Server 103x when User 140a enters into “Venue Messenger” and clicks on “Send” option. The System Server returns the user list comprising of Online and Offline users from the database 104x and returns Success user list is retrieved successfully else Failure to the client application 200.

SYSMSVIEW(C:S S:C)—This command is sent by the Client Application 200 to the System Server 103x when User 140a enters into “Venue Messenger” and clicks on “Read” option. The System Server returns the list of messages from the database 104x for all the users who have sent messages to User 140a.

SYSMSREAD(C:S S:C)—This command is sent by the Client Application 200 to the System Server 103x when User 140a clicks on message in the message list and clicks on “Read” option. The System Server sends the specified file to be read in bytes to the Client Application 200 and updates the status of the file to “Read” in the database 104x.

SYSSENDALL(C:S S:C)—This command is sent by the Client Application 200 to the System Server 103x when User 140a enters into “Venue Messenger” and clicks on “Broadcast” option. The System Server 103x broadcasts the message to all the users (Online and Offline) if the mode from the client application 200 is All or broadcasts the message to only Online users (if mode is Online) who receive a pop up message immediately or only Offline users (if mode is Offline) for whom the message is stored in the database 104x and returns the message to be sent to the opposite user 144ob back to the Client application 200.

SYSMSDELETE(C:S S:C)—This command is sent by the Client Application 200 to the System Server 103x when User 140a clicks on message in the message list and clicks on “Delete” option. The System Server deletes the specified file from the database 104x for the mode (Match, Messenger or Announcement) passed by the client application 200 and returns Success if file is successfully deleted to the Client Application 200.

SYSMSDELETE(C:S S:C)—This command is sent by the Client Application 200 to the System Server 103x to delete the selected message with mode i.e. Match, Messenger or Announcement and System Server 103x sends back the new list of Match, Messenger or Announcement message depending on the mode to the Client 200

MSW______ && MVW______ (C:S S:C)—This command is sent by the Client Application 200 to the System Server 103x to send the Voice Message to the other Users 140. System Server makes a file on the local drive and saves the file name in the database and also it sends the message instantly to the online User 140 with File ID.

MNK______ && MSI______ (C:S S:C)—This command is sent by the Client Application 200 to the System Server 103x to send the Scribble Message to the other Users 140. System Server makes a file on the local drive and saves the file name in the database and also it sends the message instantly to the online User 140 with File ID.

MSTXT______ && MSMSNSENDT (C:S S:C)—This command is sent by the Client Application 200 to the System Server 103x to send the TEXT Message to the other Users 140. System Server saves the data in the database and also it sends the message instantly to the online User 140.

TXTGENERAL#(C:S)—This command is sent by the Client Application 200 to the System Server 103x to Send the text chat message to be broadcast to all the users in same chat room in case of public chat. In response System Server 103x selects the all users in that room from the database 104x and broadcast the chat message to all the Client Application 200 by sending command TXTROBINSON which indicates that chat message sent by User 140 i.e. the sender.

INKGENERAL#(C:S) This command is sent by the Client Application 200 to the System Server 103x to send the scribble chat message to be broadcast to all the users in same chat room in case of public chat. In response System Server 103x makes the ink file on local hard drive then selects the all users in that room from the database 104x, and broadcast the file id to all the Client Application 200 by sending command INKROBINSON that indicates that chat message sent by User 140 i.e the sender.

WAVGENERAL#(C:S)—This command is sent by the Client Application 200 to the System Server 103x to send the voice chat message to be broadcast to all the users in same chat room in case of public chat. In response System Server 103x makes the wave file (Windows Sound file with file extension .wav) on local hard drive then selects the all users in that room from the database 104x, and broadcast the file id to all the Client Application 200 by sending command INKROBINSON that indicates that chat message sent by User 140 i.e. the sender.

SYSREQUEST(C:S)—This command is sent by the Client Application 200 to the System Server 103x to get the message data in bytes. The System Server 103x reads the request file from the local hard drive and sends file data in bytes to client 200 through command SYSINKREPLY in case if requested file extension is ink OR SYSWAVREPLY in case if requested file extension is .wav (Windows Sound file with extension .wav).

SYSCREDIT(C:S S:C)—This command is sent by the Client Application 200 to the System Server 103x to authenticate Credit Card transaction for User 140x. System Server 103x creates SSL connection with Payment Gateway to carry out the transaction and send back the result to Client Application 200.

SYSTICUL(C:S S:C)—This command is sent by the Client Application 200 to the System Server 103x for getting the users list of users who has set their Tic-Tac-Toe game invitation preferences to ‘YES’. The System Server 103x get the users list from the database 104x and send it back to client 200 through command SYSTICUL.

SYSTICPMP(C:S S:C)—This command is sent by the Client Application 200 to the System Server 103x to initiate the Tic-Tac-Toe game session. For the remaining explanation for this command refer to command SYSPMP.

SYSTICYES(C:S S:C)—This command is sent by the Client Application 200 to the System Server 103x to accept the Tic-Tac-Toe game invitation. For the remaining explanation for this command refer to command SYSPMPYES.

SYSVMPMPNO(C:S S:C)—This command is sent by the Client Application 200 to the System Server 103x to reject the Tic-Tac-Toe game invitation. For the remaining explanation for this command refer to command SYSPMPNO.

SYSTICEXIT(C:S S:C)—This command sent by the Client Application 200 to the System Server 103x to send User's 140a exit message to User 140b. System Server 103x checks that User 140b has not exited yet. If not, then only exit message is sent to the User 140b else nothing. But in both the cases User 140x chat mode changes from PRIVATE to ONLINE.

SYSTICMOVE(C:S S:C)—This command sent by the Client Application 200 to the System Server 103x. System Server 103x checks that Tic-Tac-Toe game session is valid. If yes, then System Server 103x sends the game move details to both User 140a and User 140b.

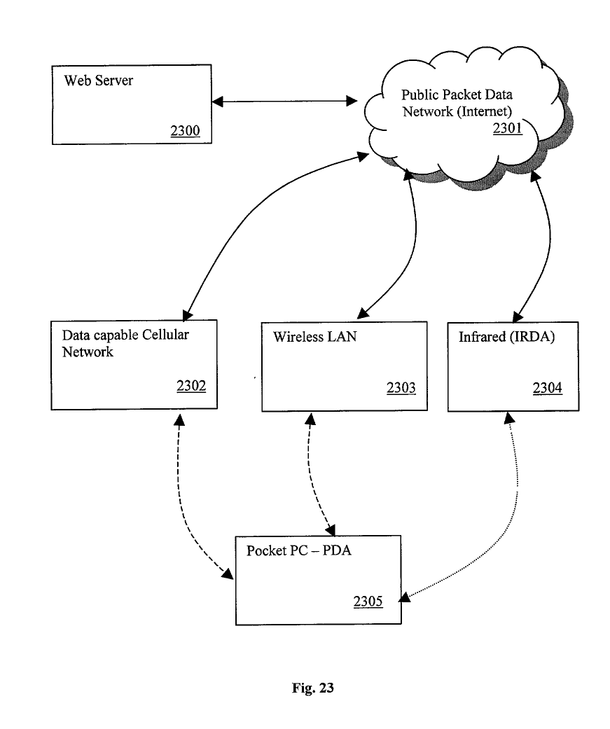

FIG. 23 illustrates how the user installs the client software piece easily and wirelessly without any cables. This is known as Web-to-device direct installation and there is no synching cable or synching software required. The process is seamless as with-in 2-3 clicks the user will download and install the client software. The purpose is to get the installable software onto the device as fast as possible and the user should be able to install without any help. For Cell Phones it is a pure thin-client (a WAP Browser), hence the user does not have to download any client-software.

The complete client runtime (consisting of executable, configuration file, DLLs, ActiveX controls used and supporting files such as images/sound files, etc.) is combined into one single compressed file. The compressed output format is .CAB. This CAB file is created using the MICROSOFT command line utility or using commercial deployment software from INSTALLSHEILD. This CAB file is hosted from a web server on the Internet.

The protocol used for delivery to transfer the CAB file onto the device is TCP/IP HTTP. The user is asked to visit a predefined hyperlink on the Internet 2301. This web site has server-side scripting (.asp) pages running on a web/application server 2300, so that the program automatically detects that the device is, for example, a Pocket PC PDA 2305 using HTTP header detail HTTP_USER_AGENT or Browser Object using Jscript/JavaScript. The user is now shown a download page. The user clicks on the “download now” button and thereafter on a dialog confirmation the CAB file gets downloaded from the web directly to the device. Once downloaded, it automatically unzips all the files onto the device 2305. The CAB file also registers all required DLLs into the Windows CE Registry. The Pocket PC-PDA can hence be either on a Data capable cellular network 2302 or a Wireless LAN 2303. Once the installation is successfully complete the CAB file is automatically deleted from the device to efficiently manage the memory.

Most of the users Pocket PC-PDAs do not have the wireless equipment to connect to the Internet, but each PDA does include an IR (infra-red) port by default. Such users can also install a limited version of the client software (with offline features such as Venue Portal, Venue Navigator, Venue Calendar, etc). As seen in the FIG. 23 the Infrared Beaming Box 2304 can be used for downloading a thinner/lighter version of the client software from the Web Server 2300 onto the Pocket PC-PDA via the Internet 2301. Manufacturers such as CLARINET provide special beam points that allow Ethernet-over-IR. This enables faster downloads on the IRDA port than normal IRDA connectivity speeds.

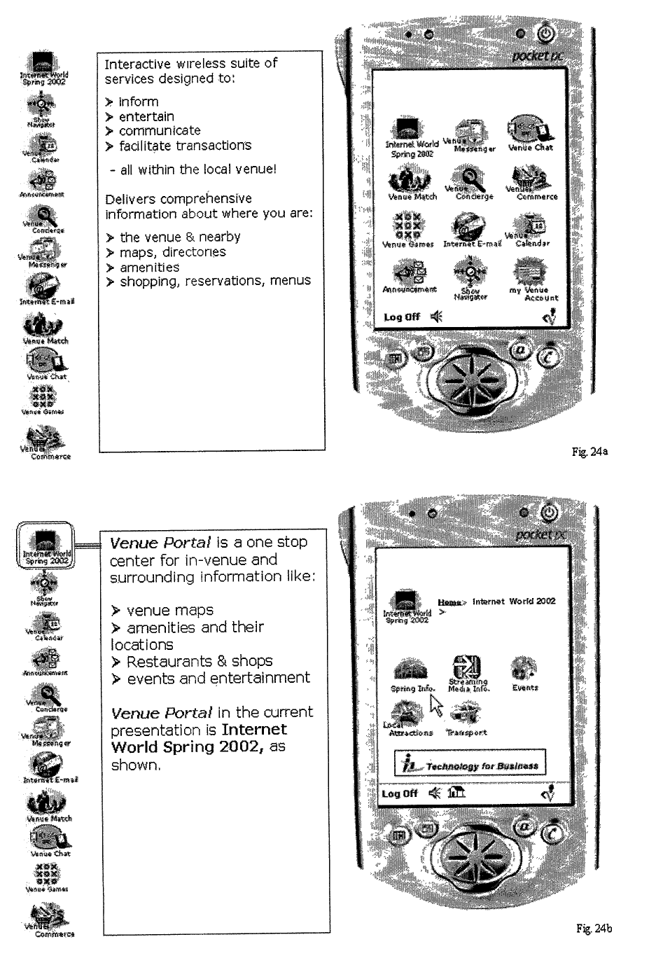

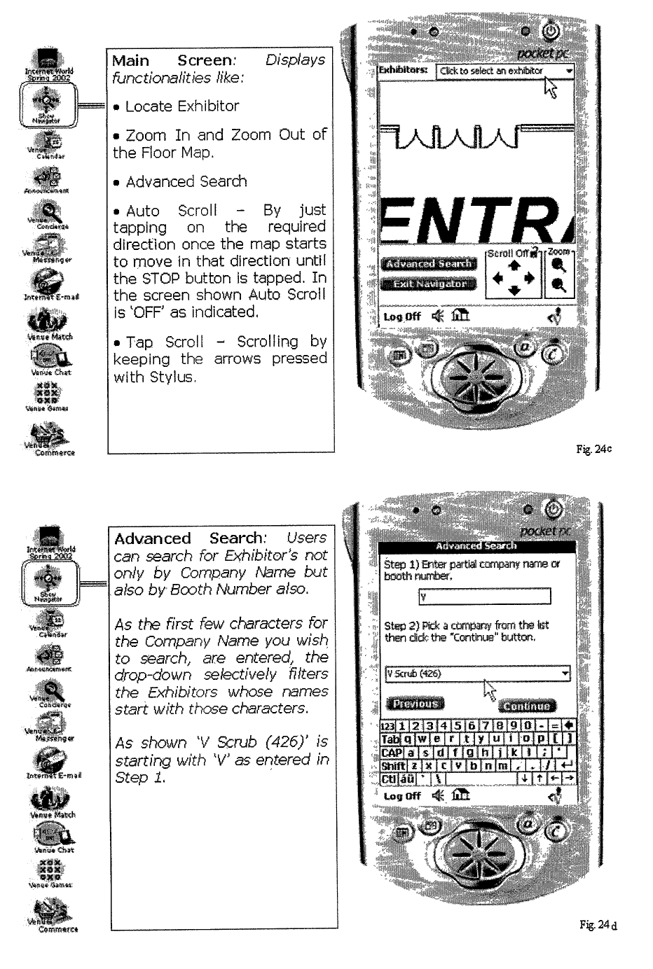

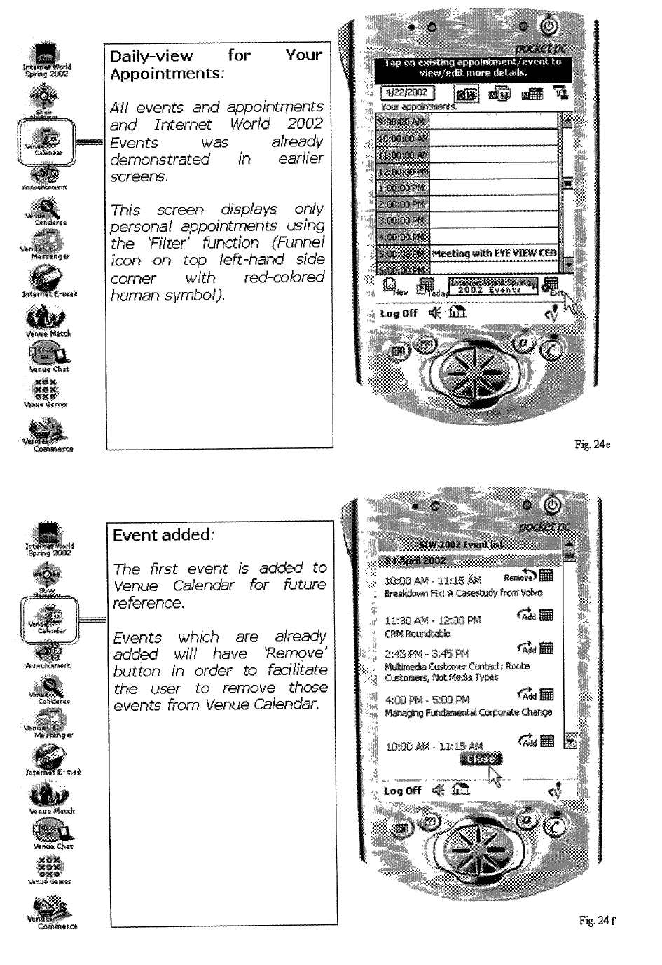

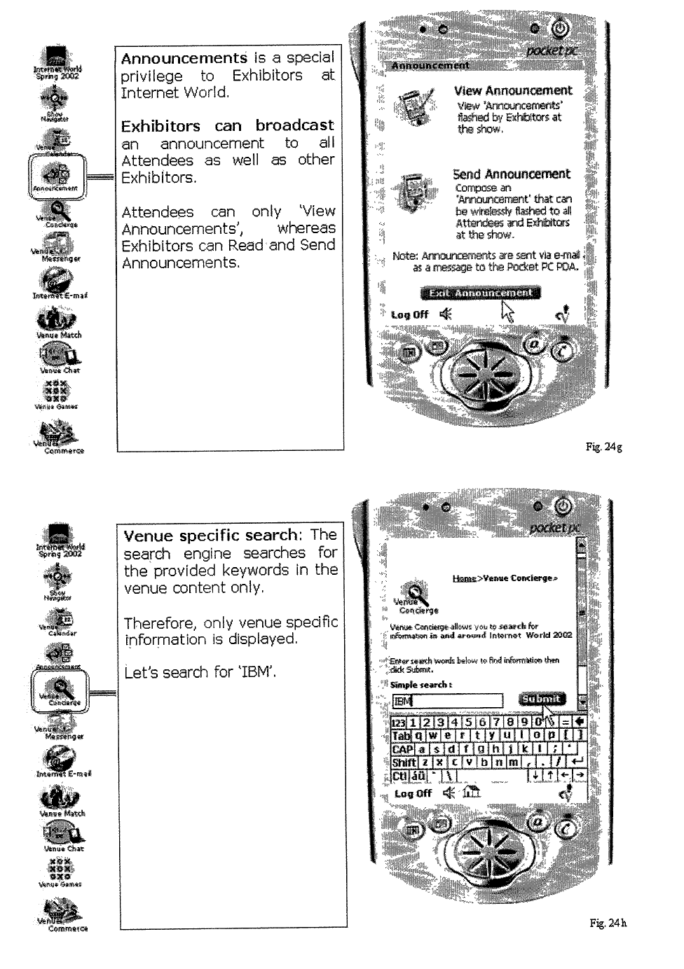

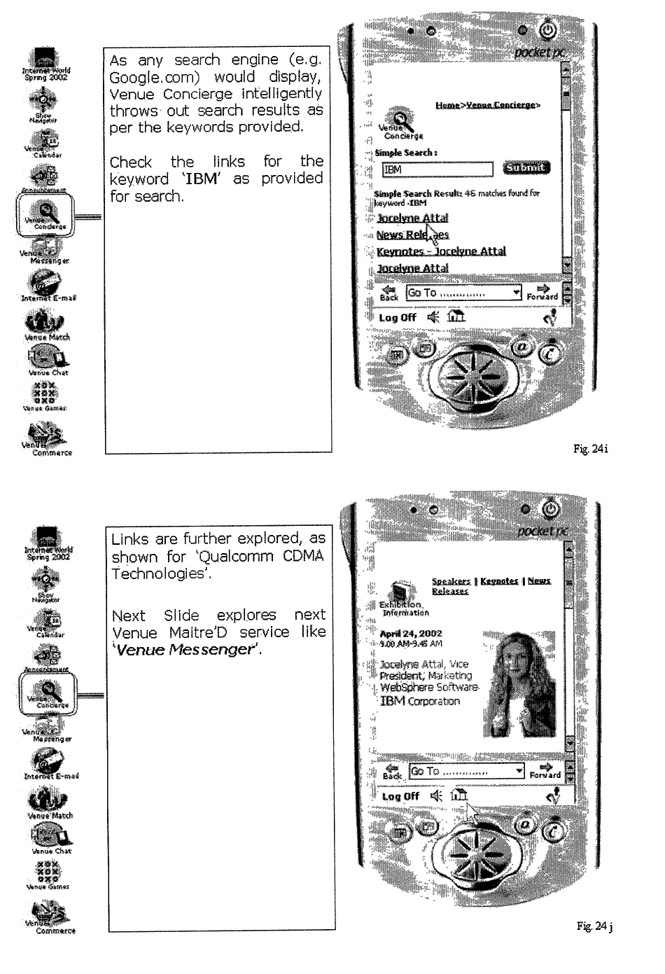

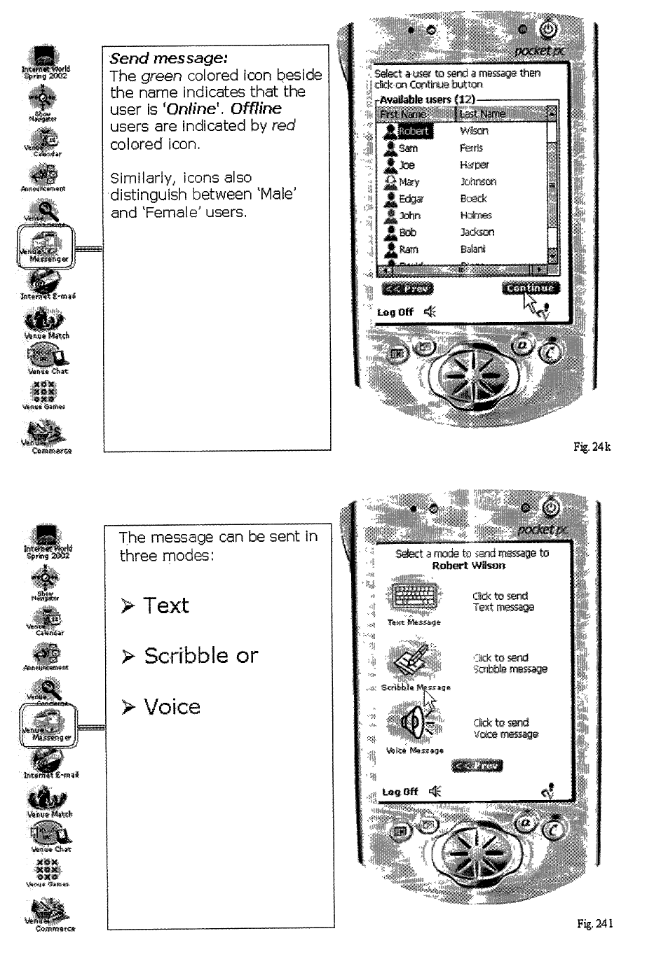

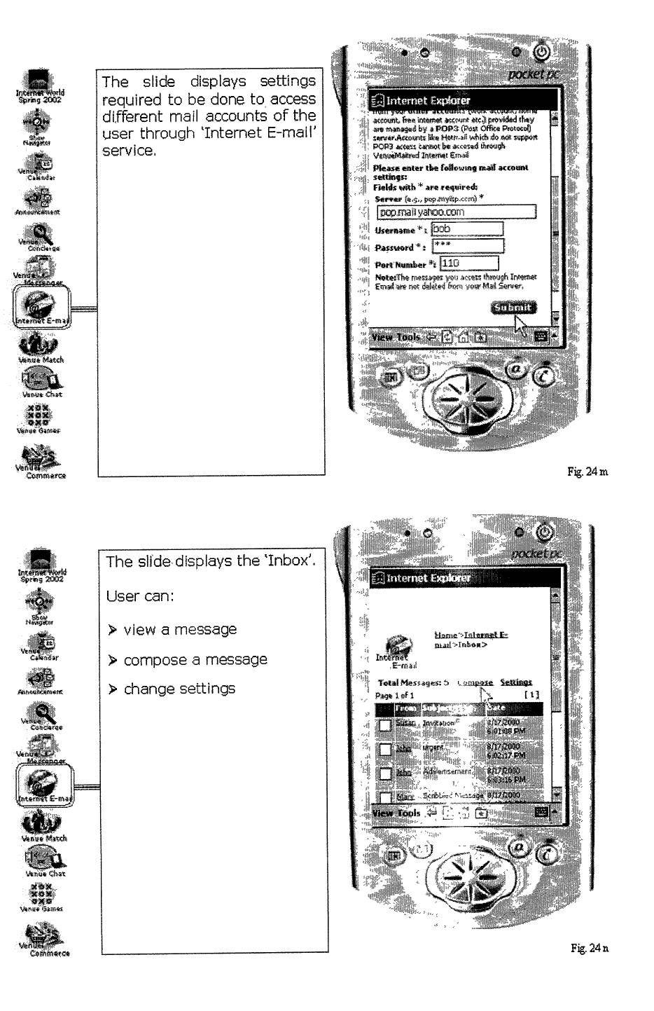

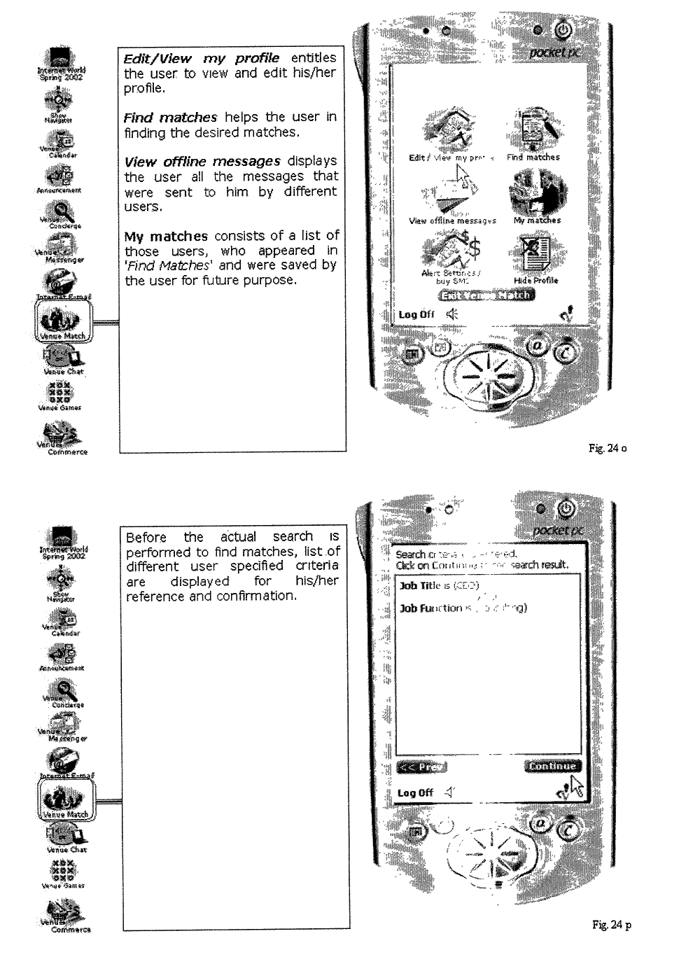

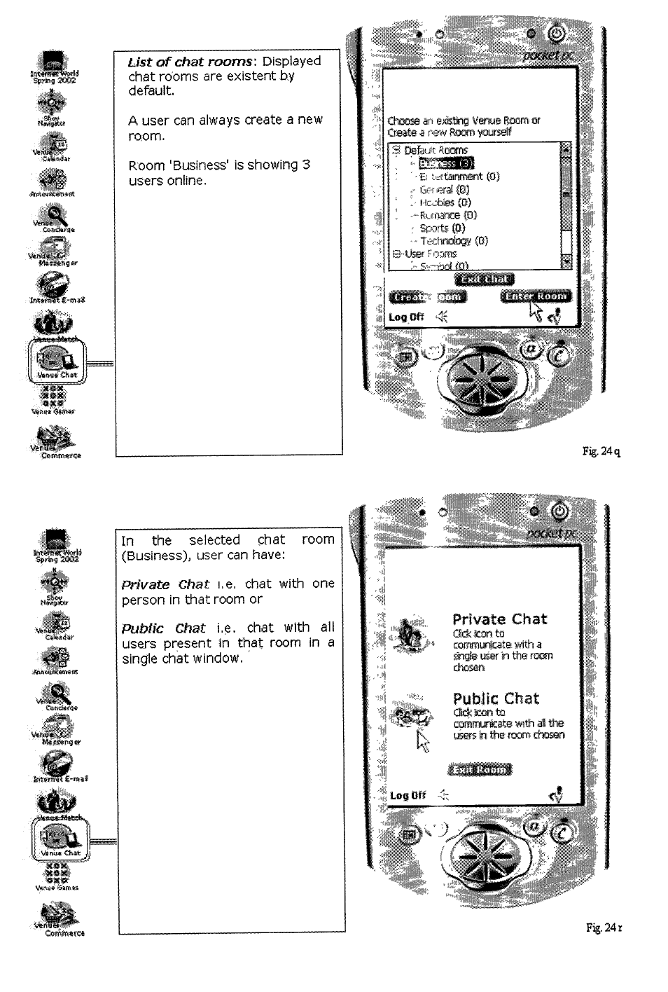

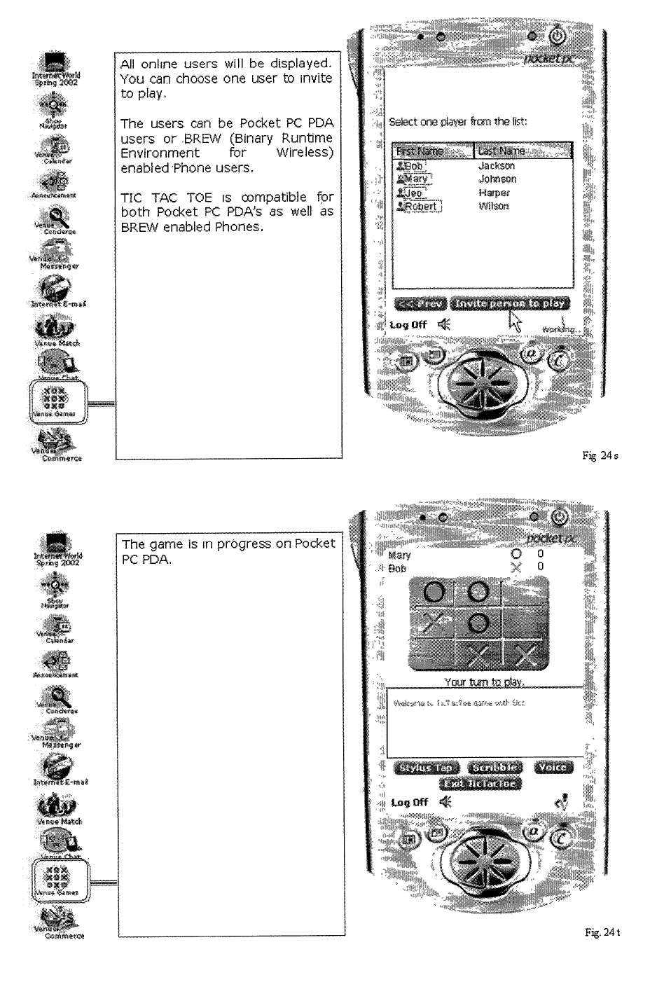

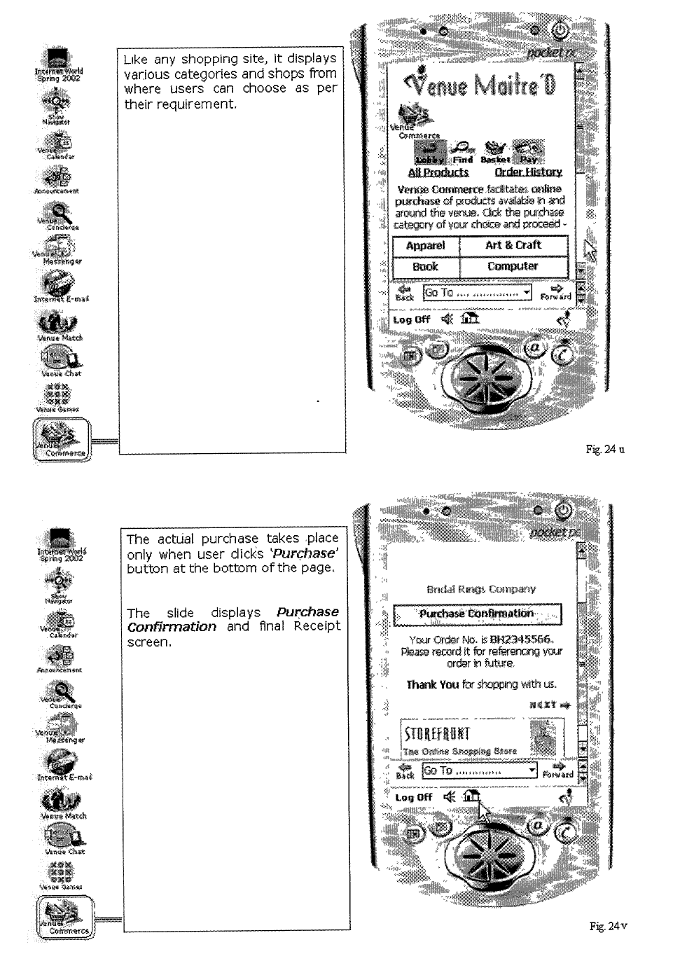

Reference is now made to FIGS. 24a-24v. Taken together these are a collection of the screen views from selected screens that appear on the wireless portable communication device.

In FIG. 24a the main menu screen for a user is illustrated, and the various functions that are available are shown next to appropriate icons. Subsequent screens depict other functionalities for other applications and services. FIG. 24b shows Venue Portal, FIGS. 24c-d show Venue Navigator, FIGS. 24e-f depict Venue Calendar, FIG. 24g shows Announcement message capability, FIGS. 24h-j shows Venue Concierge, FIGS. 24k-i shows Venue Messenger, FIGS. 24m-n shows Internet E-Mail, FIGS. 24o-p show Venue Match, FIGS. 24q-r show Venue Chat, and FIGS. 24s-t show Venue Games and FIGS. 24u-v show Venue Commerce.

The invention is described in detail with reference to a particular embodiment, but it should be understood that various other modifications can be effected and still be within the spirit and scope of the invention.

I claim:

1. A system for effecting venue specific wireless communication to define a virtual community, comprising:
a. a host server storing venue-specific information, applications and services pertinent to designated venues; and
b. a portable, wireless communication device for use by a designated registered user in said virtual community, wherein there is wireless communication between said communication device and said host server for said designated registered user for a designated venue to access said venue-specific information, applications and services stored on said host server for said venue on said communication device.

2. A system according to claim 1, further comprising means for permitting interactive wireless communication between registered users at the same venue.

3. A system according to claim 1, further comprising means for said designated user to search said host server to identify other registered users at said venue.

4. A system according to claim 2, further comprising means for said designated user to search said host server to identify other registered users at said venue.

5. A system according to claim 1, further comprising means to effect wireless, electronic commerce transactions between said designated registered user and commercial establishments located at said venue.

6. A system according to claim 2, further comprising means to effect wireless, electronic commerce transactions between said designated registered user and commercial establishments located at said venue.

7. A system according to claim 3, further comprising means to effect wireless, electronic commerce transactions between said designated registered user and commercial establishments located at said venue.

8. A system according to claim 4, further comprising means to effect wireless, electronic commerce transactions between said designated registered user and commercial establishments located at said venue.

9. A method for effecting venue specific wireless communication, comprising the steps of:
a. establishing a host server storing venue-specific information, applications and services pertinent to designated venues;
b. registering users who are authorized to access said host server;
c. initializing a portable, wireless communication device for use by a designated registered user;
d. establishing wireless communication between said communication device and said host server for a designated venue;
e. providing access to said venue-specific information, applications and services stored on said host server on said communication device by said designated registered user; and
f. creating a virtual community of registered users in a specific venue, wherein all of said registered users in said specific venue have access to said venue-specific information, applications and services stored on said host server for that specific venue.

10. A method according to claim 9, further comprising establishing interactive wireless communication between registered users at the same venue.

11. A method according to claim 9, further comprising said registered user searching said host server to identify other registered users at said venue.

12. A method according to claim 10, further comprising said registered user searching said host server to identify other registered users at said venue.

13. A method according to claim 9, further comprising establishing wireless communications between said registered user and commercial establishments located at said venue to effect wireless, electronic commerce transactions.

14. A method according to claim 10, further comprising establishing wireless communications between said registered user and commercial establishments located at said venue to effect wireless, electronic commerce transactions.

15. A method according to claim 11, further comprising establishing wireless communications between said registered user and commercial establishments located at said venue to effect wireless, electronic commerce transactions.

16. A method according to claim 12, further comprising establishing wireless communications between said registered user and commercial establishments located at said venue to effect wireless, electronic commerce transactions.

17. A method according to claim 9, further comprising establishing wireless communication between all registered users for a venue and a host for said venue.

18. A method according to claim 17, further comprising said host for said venue concurrently broadcasting information to all registered users at said venue.

19. A method according to claim 17, further comprising said host for said venue conducting wireless auctions among said registered users at said venue.

20. A wireless communication method between wireless, portable communication devices and a server generating and storing files, information, applications and services that are venue specific, comprising the steps of:
a. selecting specific venues and creating and storing separate sets of files for venue specific information, applications and services for each selected venue in said server;
b. initializing said wireless, portable communication devices for communication with said server;
c. establishing communication between said wireless, portable communication devices and said server for a designated venue;
d. determining the venue specific information, applications and services in said server that are pertinent to said designated venue;
e. creating a communication link between said wireless, portable communication devices and said server to permit users of said wireless, portable communication devices to access and utilize the venue specific information, applications and services stored in said server for said designated venue; and
f. creating a virtual community of users of said wireless, portable communication devices in a specific venue, wherein all of said users in said specific venue have access to said venue-specific information, applications and services stored on said host server for that specific venue.

21. A method according to claim 20, further comprising establishing interactive wireless communication between users at the same venue.

22. A method according to claim 20, further comprising said user searching said host server to identify other users at said venue.

23. A method according to claim 21, further comprising said user searching said host server to identify other users at said venue.

24. A method according to claim 20, further comprising establishing wireless communications between said user and commercial establishments located at said venue to effect wireless, electronic commerce transactions.

25. A method according to claim 21, further comprising establishing wireless communications between said user and commercial establishments located at said venue to effect wireless, electronic commerce transactions.

26. A method according to claim 22, further comprising establishing wireless communications between said user and commercial establishments located at said venue to effect wireless, electronic commerce transactions.

27. A method according to claim 23, further comprising establishing wireless communications between said user and commercial establishments located at said venue to effect wireless, electronic commerce transactions.

28. A method according to claim 20, further comprising establishing wireless communication between all users for a venue and a host for said venue.

29. A method according to claim 28, further comprising said host for said venue concurrently broadcasting information to all users at said venue.

30. A method according to claim 28, further comprising said host for said venue conducting wireless auctions among said users at said venue.

31. A method according to claim 21, further comprising the steps of:
a. a first user activating a mode for communicating with another user at the same venue;
b. creating a list of other users in the same venue;
c. said first user selecting a second user from said list;
d. contacting said second user to determine if he is available for interactive communication with said first user; and,
e. establishing interactive communication in real time between said first and second users; and
f. deactivating the interactive communication between said first and second users after they have completed their communication.

32. A method according to claim 10, further comprising the steps of:
a. a first registered user activating a mode for communicating with another registered user at the same venue;
b. creating a list of other registered users at the same venue;
c. said first registered user selecting a second registered user from said list;
d. contacting said second registered user to determine if he is available for interactive communication with said first registered user;
e. establishing interactive communication in real time between said first and second registered users; and
f. deactivating the interactive communication between said first and second registered users after they have completed their communication.

33. A method according to claim 20, further comprising the steps of:
a. selecting a user at said venue for receiving a message;
b. creating said message for said user;
c. sending said message to said user; and
d. acknowledging confirmation that said message was sent to said user.

34. A method according to claim 9, further comprising the steps of:
a. selecting a registered user at said venue for receiving a message;
b. creating said message for said registered user;
c. sending said message to said registered user; and
d. acknowledging confirmation that said message was sent to said registered user.

35. A method according to claim 22, wherein the step of said user searching said host server to identify other users at said venue comprises
a. creating a profile for said user;
b. defining search criteria to define other users to be identified at said venue;
c. searching said files of said host server to identify other users at said venue whose profile matches said search criteria;
d. notifying said user that other users matching the search criteria have been identified;
e. said user reviewing profiles of other users who were identified in said search; and
f. said user contacting other users who were identified in said search.

36. A method according to claim 11, wherein the step of said registered user searching said host server to identify other registered users at said venue comprises:
a. creating a profile for said registered user;
b. defining search criteria to define other registered users to be identified at said venue;
c. searching said files of said host server to identify other registered users at said venue whose profile matches said search criteria;
d. notifying said registered user that registered users matching the search criteria have been identified;
e. said registered user reviewing profiles of registered users who were identified in said search; and
f. said registered user contacting users who were identified in said search.
